(19) United States
(12) Patent Application Publication
(10) Pub. No.: US 2023/0158692 A1
(43) Pub. Date: May 25, 2023

(54) DISCRETE CONTINUUM ROBOTIC STRUCTURES

(71) Applicant: Massachusetts Institute of Technology, Cambridge, MA (US)

(72) Inventors: Alfonso Parra Rubio, Cambridge, MA (US); Neil Gershenfeld, Cambridge, MA (US)

(73) Assignee: Massachusetts Institute of Technology, Cambridge, MA (US)

(21) Appl. No.: 18/054,027

(22) Filed: Nov. 9, 2022

Related U.S. Application Data
(60) Provisional application No. 63/263,776, filed on Nov. 9, 2021.

(51) Int. Cl. B25J 19/00

(52) U.S. Cl. CPC B25J 19/00

(57) ABSTRACT

An outer skin of a metamaterial is provided that includes a tessellation of folded structures. This outer skin integrates the mechanical needs of movable structures with one process, which better replicates nature's engineering strategies. The tessellation of folded structures may be discretely assembled and may include an offset arrangement of corrugations. In certain embodiments, the metamaterial may be a portion of a continuum robotic structure.

### CROSS-REFERENCE TO RELATED APPLICATION

This application claims the benefit of priority of U.S. provisional application No. 63/263,776, filed Nov. 9, 2021, the contents of which are herein incorporated by reference.

### BACKGROUND OF THE INVENTION

The present invention relates to continuum structures and, more particularly, to discrete continuum structures based, in part, on engineering strategies found in nature.

“Nature does nothing uselessly. If one way be better than another, that you may be sure is nature's way.” Aristotle's statement still resonates after thousands of years in modern academic directions as nature is a constant source of inspiration for modern engineering research trends and solutions.

Modern engineering challenges require material properties that uniform materials have difficulty providing and complex systems integration. The two main pillars the present disclosure found in nature's success are its system integration strategies and its ability to generate biological materials with custom mechanical properties.

System Integration

On the one hand, nature integrates systems in a way that humans cannot replicate with classic mechanical approaches [4]. Multicellular organisms are a perfect integration of structural, sensing and actuation systems, such as a unique part composed of nerves, bones, muscles and skin. Almost any kind of smart structure developed by humans shares the same system requirements: structural, sensing and actuation devices. But the classical way of integrating them is to design them all separately and pay the price of a complex integration with high cost in time and price.

As an example, focusing on solutions for transportation, mimicking the way under-water multicellular organisms travel with wavelike body motions drastically increases the efficiency of any human-made solution [47]. Many fish resonate with their flexible bodies and extract energy from their own vortices, converting thrust out of their own drag [3]. The first successful human attempt to replicate this effect resulted in the famous MIT Sea Grant robot RoboTuna [48], as shown in FIG. 1A, that succeeded in the premise but was composed of more than 3000 unique parts delicately assembled with very high cost, time and labor penalties.

Another successful example is the replication of the motion of agile quadrupeds. The MIT cheetah [5], as shown in FIG. 1C, is the result of years of multiple people research. The costs of the smaller version under 10 kg of payload is under 10K$. Its industrial version, Boston Dynamic Spot, as shown in FIG. 1B, able to handle a payload of 14 kg, is the result of almost 35 years of industry research and its price was 74K$ [1].

In the 1990s, soft robotics appeared as an alternative to the classic mechanical approach. The key component was combinations of compliant and stiff materials to mimic nature-like structural movements. Examples of this novel engineering and design perspective are soft manipulators for underwater delicate sampling [13], an inflatable large-scale soft robot that moves by growing in a certain direction [20], and an entirely soft autonomous robot [49]. Soft robotics have also shown modular soft structures [33]. Continuum robotics also shares the modular mindset with an array of discrete joints with infinite degrees of freedom (DOF) [7] but relying less on elastomeric materials and more on elastic deformation of their truss members [35]. Although this discipline born to provide grippers with almost unlimited accessibility for medical usage and are only conceived as beam robots, the design strategy is very interesting for the present disclosure because of its tendon actuation analysis.

Even though these new ways to embed structure and systems point towards a new direction that is more nature based, both fields still face issues while scaling materials, manufacturing processes or actuating their models. [28]

Materials

On the other hand, nature uses geometry to improve and customize material's mechanical properties. Intricate cellular structures appear in body zones where light weight and high stiffness are needed [40], as for example in bird's beaks and bones. Those architected materials are driven by their geometrical composition rather than material composition. One of the first sources of inspiration was how nature generates at low scales cellular solids, composing very light materials with a high stiffness value, as inner bones. This inspired researchers to make state of the art foams; it is very difficult to distinguish a microscopy of human vertebrae and polyether foams, as shown in FIGS. 2A and 2B, respectively. This research field popularized complex truss structures and even allowed architected materials to behave in ways that cannot be found in nature.

Metamaterials have shown negative Poisson's ratios [2], chirality [32], custom electromagnetic behavior [25], highest value of relative density-stiffness [11], and nonpositive thermal expansion [2].

The appearance of Digital Manufacturing enabled the masses to manufacture those complex geometries [16]. Architected materials greatly benefited from this new building strategy. It allowed to start thinking about the possibility of encoding information into the material. Lattices with heterogeneous custom properties to control deformations were developed [27] or lattices printed with multiple materials to control its Poisson's ratio as desired [10]. But from a monolithic perspective, even with digital fabrication, a structure can be as big as the mean of manufacture allows and it will contain a global stochastic error that will increase as the mean of manufacture and the structure increases in size.

As shown in FIGS. 3A and 3B, Center for Bits and Atoms (CBA) alumni Kenneth Cheung [11] demonstrated how Digital Cellular Solids can be discretely assembled, like LEGO™ building blocks, with no mechanical behavior penalties, offering world-record performance on Young's modulus versus relative density. Thanks to its drastically low relative density and that discrete assembled lattices can be theoretically arbitrarily large, it was also shown that these solids can be scaled up between the linear and quadratic regime [19]. What is still a challenge is the accessibility to mass manufacture its unit cell because the cost of molds for intricate shapes can be on the order of 10k$.

A step towards accessibility and simplicity of the unit cell was given by Benjamin Jenett and other contributors (including the inventor of the presently described and claimed invention). In Discretely Assembled Mechanical Materials [21] a new decomposition of the cubic octahedron lattice was offered, as exemplified in FIG. 4, reducing the costs of molds and parts drastically. This new faceted approach enabled the introduction of different geometries per facets, to generate heterogeneous combinations of facets that make unique cubic octahedrons to assemble. This is where the present invention takes the pending work and analyzes what can be done with this construction kit.

Folding strategies are another research trend to improve materials performance. 2D processes are much faster and flexible than 3D processes. Folding showed a capacity to generate metamaterials with custom stiffness [8], tailored electromagnetic properties [22], and custom thermal expansion [6]. Folding has drawn interest in fields that other cellular solids found difficult as in volume filling applications with mechanical properties. Honeycomb fillings [39], Tachi-Miura fillings [8] and free-form fillings [46] are some of the examples. Some challenges these strategies share is that they are not optimal to manufacture or assemble as, in their target planes, instead of facets, they rely on hinges.

As can be seen, there is a need for discrete continuum structures based, in part, on engineering strategies found in nature. All the above-mentioned technologies serve as a base to build upon and generate arbitrarily shaped nature-like continuum-morphing structures able to scale up to regimes that soft robotics or continuum robotics find challenging.

### SUMMARY OF THE INVENTION

When overcoming environmental constraints, nature shows the capacity to generate hybrid hard-soft morphing continuum structures at very low cost at almost any scale. Human attempts to replicate nature-like systems to overcome modern engineered solutions, based on classical rigid mechanics, commonly lead to hyper-redundant and complicated designs. Novel trends like soft robotics or continuum robotics are showing new successful directions but mostly at small sizes. It is still a challenge to achieve accessible and cost-efficient scalable nature-like solutions.

The earliest research towards digital materials focused on proving reversibility of their assembly, their low relative densities vs. ultra-high stiffness ratios and scalability properties. Now architected metamaterials can be found with many kinds of exotic physical properties. The present disclosure focuses on digital materials with custom mechanical properties. Recent work showed the capacity to generate controlled mechanical anisotropies as embedded compliancy, chirality, and auxeticity. That enables generating continuum macroscopic foams with controlled deformation that could preserve some properties and help bring simplicity to overcome tasks that, with classic rigid-joint mechanical systems, would require a very complex system.

Equally important, many of the modern engineering solutions that would require digital materials are very dependent on their outer shape. Literature shows less acclaim for providing an accurate shape to these digital materials. Some of the strategies proposed have been based on hierarchical strategies or reducing the overall size of the building blocks but these findings conflict with the many of the claimed premises. The present disclosure proposes a folded solution that will integrate onto the continuum structure and provide a desired shape that is structurally efficient while respecting its intrinsic degrees of freedom.

As a whole, and in accordance with the present invention, this disclosure explores if heterogeneous digital materials can provide all the mechanical needs of a movable structure integrated. The present disclosure describes the try to mimic nature's engineering strategies by joining the kinematical and shape-form needs into a single material system composed of a discrete building block core and a folded outer-mold-line layer. As examples, the present disclosure described the recreation of a water snake and a morphing wing inspired by birds camber morphing.

The instant application describes the integration of the mechanical needs of movable structures in a single process, taking advantage of the proven properties of heterogeneous digital materials and folded structures. This is a way to mimic nature's strategies by blending in the same architected material a kinematic system composed of:
a discrete cellular solid with desirable and continuum-mechanical deformation with embedded actuation—a folded core as transition from the inner structure to the outer mold line preserving mechanical and kinematical requirements.

The work developed by Benjamin Jenett et al. in Discretely Assembled Mechanical Metamaterials [21] is used and those proposed geometries are used as the unit cell to design large continuum robotic structures with custom deformations. Actuation and skin interfaces are added to generate a compact and integrated final product.

By doing that, the present disclosure proposes discrete lattice robotic structures, an expansion in dimensions with the same premise as continuum robotics but much more focused on the material system as a whole.

The Detailed Description section below starts by showing actuated lattices. Different controlled deformations that can be generated with different members of the family are explained. Later, the disclosure turns to focus only on two members, compliant and stiff, to analytically characterize them and predict their range of motions and load response. Further on, the need for a skin interface is explained and the process taken to develop a novel pattern modification is shown. The mathematical relations needed to automate the generation of the folded cell and its unfolded state are explained. Some manufacturing techniques used to build large folded cores are also shown. Finally, examples of this approach are shown. The design, manufacturing, control and testing of a water snake and a camber morphing wing are shown, both robot lengths on the order of meters.

These and other features, aspects and advantages of the present invention will become better understood with reference to the following drawings, description, and claims.

### BRIEF DESCRIPTION OF THE DRAWINGS

The following figures are included to illustrate certain aspects of the present disclosure and should not be viewed as exclusive embodiments. The subject matter disclosed is capable of considerable modifications, alterations, combinations, and equivalents in form and function, without departing from the scope of this disclosure.

FIG. 1A is a view of MIT Sea Grant robot RoboTuna;

FIG. 1B is a view of Boston Dynamics Spot;

FIG. 1C is a view of MIT Cheetah;

FIG. 2A is a microscopic view of polyether foam, taken from [14];

FIG. 2B is a microscopic view of spine bone SEM, taken from [14];

FIGS. 3A.I, 3A.II, 3A.III, 3A.IV, 3A.V, 3A.VI, 3A.VII, 3A.VIII, and 3A.IX are views of various Kenneth C. Cheung Digital Cellular Solids. Reconfigurable Composites Materials. MIT;

FIG. 3B is a bar graph of beam performance index for various aerospace materials (Kenneth C. Cheung, MIT);

FIGS. 4A, 4B, 4C, and 4D are front views of a family of voxels proposed by Benjamin Jenett et al. at [21] (from left to right: stiff, compliant, auxetic, compliant);

FIGS. 5A-5B illustrate Sam Calisch folding patterns for honeycomb with arbitrary cross section;

FIGS. 5C-5F illustrate curved crease foldcores with impact absorption geometrical elements;

FIG. 6A is a view of local torsion of a structure;

FIG. 6B is a view of distributed torsion of the structure;

FIG. 6C is a view of local bend of the structure;

FIG. 6D is a view of distributed bend of the structure;

FIG. 6E is a view of combinations of degrees of freedom (DOF) enabled to generate structures with specific motion as a walker robot;

FIG. 6F is a view of a walker robot prototype;

FIG. 7 is a view of a quadruped voxel robot;

FIG. 8 is a workflow to estimate beam curvature and tendon tension given a certain strain (general inputs and general outputs indicated as INPUT and OUTPUT, respectively);

FIG. 9A is a tendon load case for a cantilever beam of three voxels;

FIG. 9B is a load decomposition for analysis purposes;

FIG. 10 is a diagrammatic view showing a vector S that travels from x=0 to x=L to determine x(s) and y(s);

FIG. 11A is a diagrammatic view of a cantilever tendon-actuated beam;

FIG. 11B is a diagrammatic view of a differential tendon;

FIG. 11C is a diagrammatic view of a full-body diagram (FBD) of the beam;

FIG. 11D is a diagrammatic view of a FBD of the tendon;

FIG. 12 is a view of parametric geometry generation;

FIG. 13 is a view of a pulling test performed inside the Rhino-Grasshopper-Python environment;

FIG. 14 is a view of OpenCV-Python artificial vision analyzer to determine radius of centroids given a determined tendon tension;

FIG. 15A is a view of tooling used to test beams to find tension-curvature correlations;

FIG. 15B is a view of Raspberry Pi® 4 mounted in the wall with the camera module used to track motion;

FIG. 15C is a view of an instrument layout;

FIGS. 16A, 16B, 16C, 16D, 16E, 16F, 16G, 16H, and 16I illustrate simulation versus Instron testing;

FIG. 17A is a view of a Kirigami core of an embodiment of the present invention;

FIG. 17B is a view of footprint coordination of the embodiment of FIG. 17A;

FIG. 17C is an elevation view of the embodiment of FIG. 17A, with algorithm of the present invention taking, as inputs, Target 1 and Target 2 and generating the folded core and its unfolded state, ready to manufacture;

FIG. 18 is a view of a stiff voxel (actual voxels have 75 mm pitch);

FIG. 19A is a view of a volumetric fill of a discrete lattice;

FIG. 19B is a view of hierarchical filling;

FIG. 20 is a process view of steps followed to modify the Miura-ori into the kirigami modification;

FIG. 21 is a view of two boundary surfaces that generate a target volume;

FIG. 22 is a diagrammatic view of a corrugation offset method of the present invention, with name variables for the unit cell;

FIG. 23 is a view of different folded states of the unit cell in the three unique curvature scenarios (neutral, positive, negative slope);

FIGS. 24A and 24B together are a table of equations derived to compute geometric locations of vertices;

FIG. 25 is a view of the zero slope folded state depicting zero slope unit cell nomenclature with angle definitions and vertex names;

FIG. 26 is a view of the positive slope folded state depicting positive slope unit cell nomenclature with angle definitions and vertex names;

FIG. 27 is a view of the negative slope folded state depicting negative slope unit cell nomenclature with angle definitions and vertex names;

FIG. 28 is a view of a folded core of the present invention, showing the same target and same corrugation but a different Miura facet zone, with an extra hinge enabling the fold to stretch along the pattern;

FIGS. 29A, 29B, and 29C are views of FEM with a same load in the Z axis, with 29A showing a naked beam, 29B showing an extra-hinged Miura on top, and 29C showing a classic modified Miura on top;

FIG. 30 is a view of completely stiff versus local bending due to half inverted exagone core;

FIG. 31A is a perspective view and 31B is a detail view of discrete origami;

FIGS. 32A-32C are views of discrete origami positioned on a metamaterial;

FIGS. 33A, 33B, and 33C are perspective views of carbon-fiber-reinforced polymers (CFRP);

FIGS. 34A, 34B, 34C, and 34D illustrate views of metal folding of a trailing edge;

FIG. 35A is an exploded-view of a section of an aquatic discrete cellular soft robot system architecture (scale 75 mm);

FIG. 35B is an isometric view of the robot highlighting main parts thereof (scale 75 mm);

FIG. 35C is a cross section drawing thereof, taken along plane A-A of FIG. 35B;

FIG. 35D is a view of texture of the skin fabric;

FIG. 35E is a view of a prototyped robot with and without skin;

FIG. 36A is a view of continuum curvature sections in series replicating target splines of the swimming robot;

FIG. 36B is a graphical view of servo actuation phases over time;

FIG. 36C is a view of matching simulation with actuation in a quasi static state;

FIG. 36D is a view of dynamic matching;

FIG. 37 is a view of a tow tank experiment setup;

FIG. 38A is a view of a prototype of the robot-carriage assembly system, ready to go to the water;

FIG. 38B is an exploded view of the current design (in this figure, 8020 1530 aluminum beam 121. First voxel 122 of the robot. ¼″ waterjet aluminum plate 123. PLA 3d printed leading edge 124. Lower fitting 125. ¼″ waterjet aluminum plate. ATI Gamma Sensor IP68 126. Upper fitting 127. ¼″ waterjet aluminum plate);

FIGS. 39A-39C are views of the result of the hydrodynamic experiment of the robot being towed at U-0.1 m/s;

FIG. 40A is a FACC active morphing example;

FIG. 40B is a DLR leading edge morphing example;

FIGS. 40C-40D are NASA-CBA digital morphing wing examples;

FIGS. 41A, 41B, 41C, 41D, 41E, 41F, 41G, and 41H are views of Eppler and Naca candidates to design a hydrofoil;

FIG. 42A is an exploded isometric view of a wing section of a digital morphing wing system architecture (scale 75 mm);

FIG. 42B is an isometric view of the full assembly (scale 75 mm);

FIGS. 42C-42D are views of the digital morphing wing system architecture prototype;

FIG. 43A is an exploded isometric view of a wing section of the digital morphing wing system architecture (scale 75 mm);

FIG. 43B is an isometric view of the full assembly of the components shown in FIG. 43A (scale 75 mm);

FIGS. 44A and 44B are centroid-based characterizations of morphing;

FIG. 45 is a depiction of geometry solutions for the centroid-based method;

FIG. 46A is a view of a voxel torsion box;

FIG. 46B is a view of the voxel torsion box, adding inverted hexagon;

FIG. 46C is a view of the voxel torsion box, adding glass fiber skin;

FIG. 46D is a view of the voxel torsion box, showing a positive slope origami cell;

FIG. 46E is a view of the complete assembly before testing;

FIG. 47 includes views of frames of the actuators morphing the wing;

FIG. 48 is a view of a simulation, specifically Oasys GSA axial stresses for ⅓ of the wing section;

FIG. 49A is a view of the wing in the water at θ=10 deg.;

FIG. 49B is a view of various components used in the tow tank;

FIG. 50 is a plot view of Cd and Cl values versus Angle of Attack;

FIGS. 51A, 51B, 51C, and 51D include four plots of Cd and Cl values versus Tail Angles for every Angle of Attack (in every plot, the long-short-long dashed horizontal line 510 corresponds the cl value of the rigid version and the long-short-short-long dashed horizontal line 511 represents the cd of the rigid wing; and

FIG. 52 is a contour map for L/D values given an AoA and a Tail Angle, with the lines 520 setting the zones for L/D higher than 3 and 5.

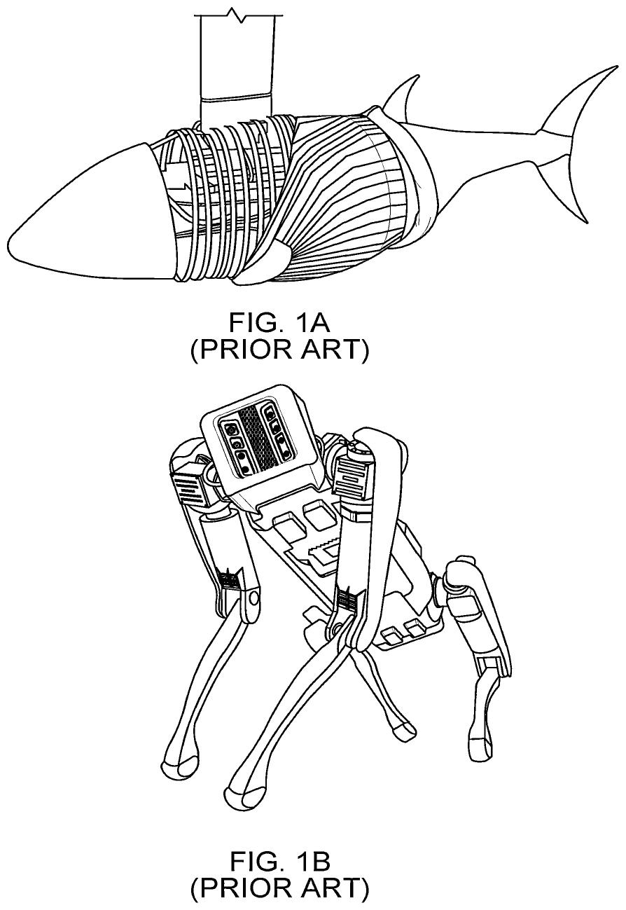

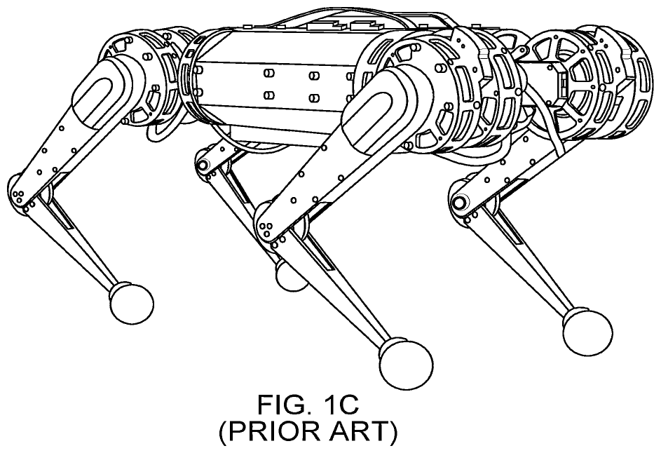

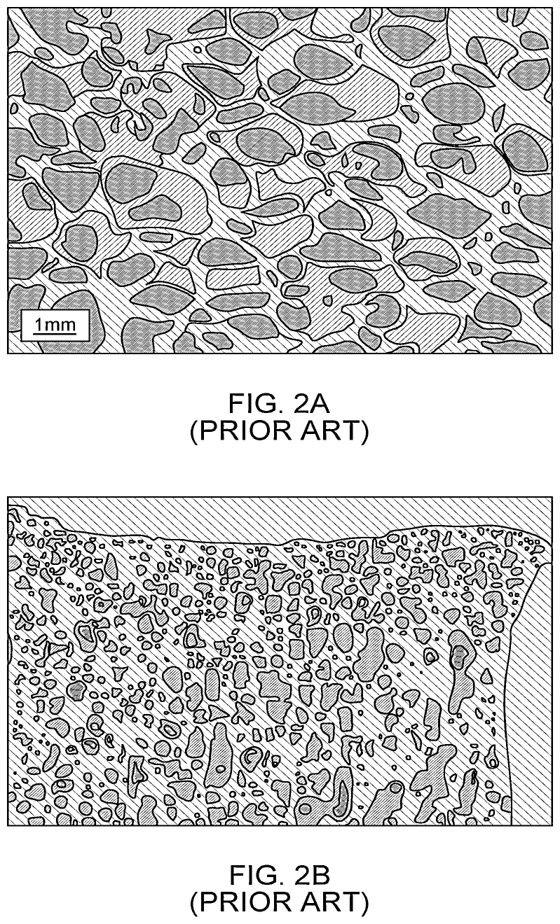

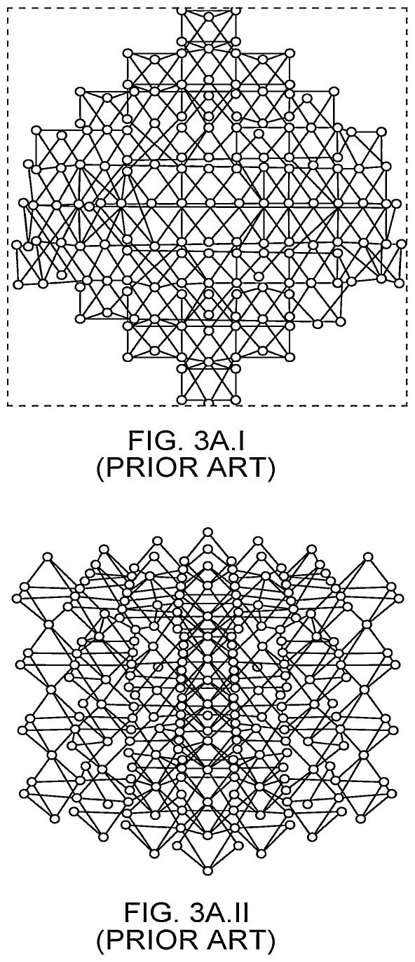

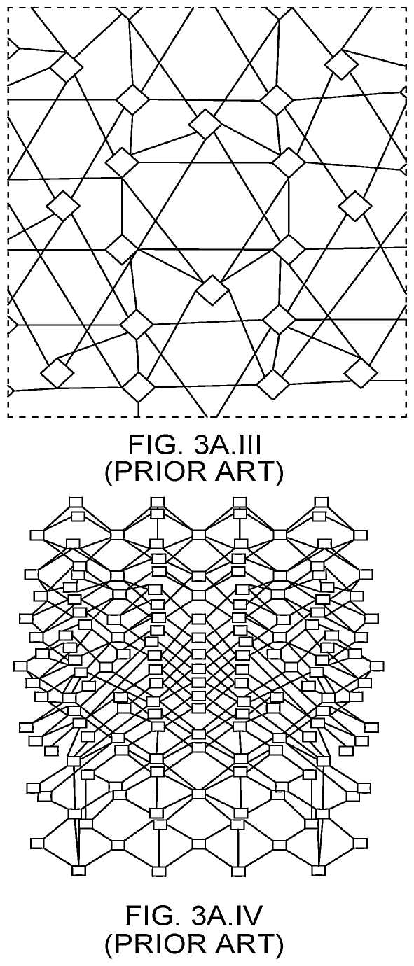

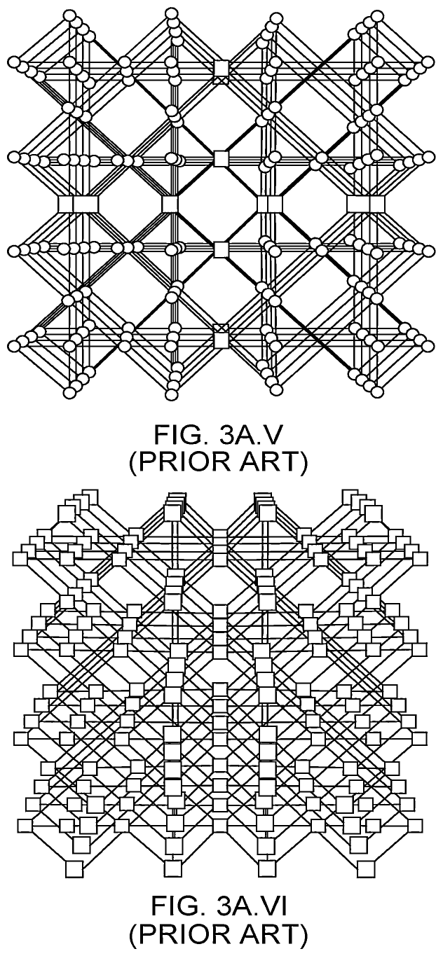

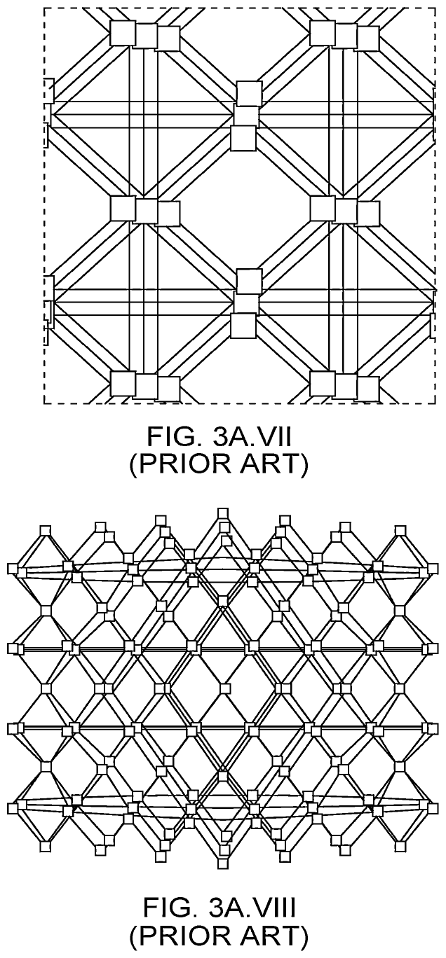

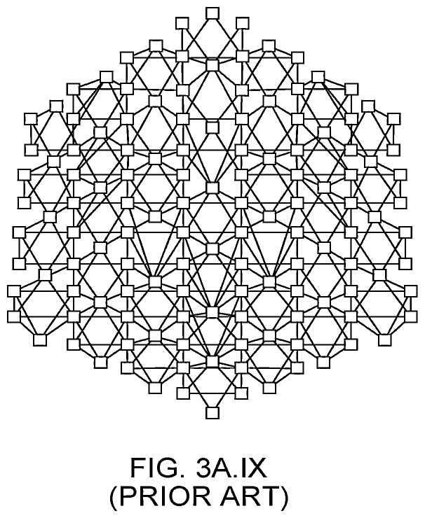

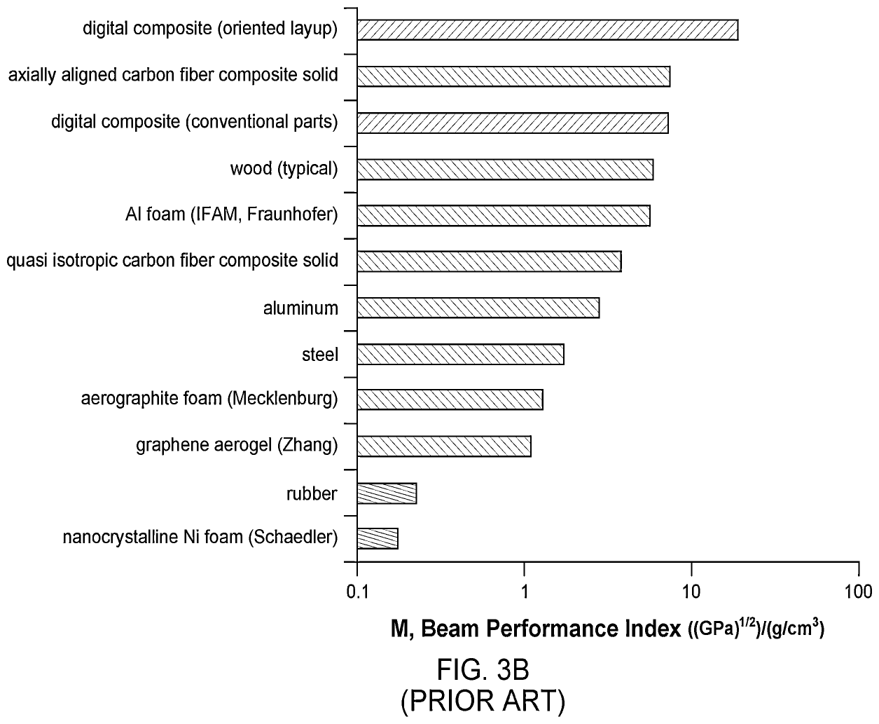

### DETAILED DESCRIPTION OF THE INVENTION

The subject disclosure is described with reference to the drawings, wherein like reference numerals are used to refer to like elements throughout. In the following description, for purposes of explanation, numerous specific details are set forth in order to provide a thorough understanding of the present disclosure such that one skilled in the art will be enabled to make and use the present invention. It may be evident, however, that the present disclosure may be practiced without some of these specific details. For the purpose of clarity, technical material that is known in the technical fields related to the present invention has not been described in detail so that the present invention is not unnecessarily obscured.

### 1. Lattice and Actuation

In this section, the possible anisotropic combinations that the construction kit can create with only two single voxel facets, a stiff and a compliant one, are explored. From a macroscopic point of view, elastomeric foams under loads can live in a linear elastic regime while their sub-structural elements (cells, beams or any sort of unit cell) don't behave necessarily linearly [14]. Knowing this feature is essential to simulate accurately the described structures. Soft bodies' actuation strategies radically differ from classical rigid-body mechanisms as they mostly rely on their linear-elastic deformation to determine their mechanical state [29]. That means that the analytical models to predict ranges of motion directly imply calculating the deformed state from the original geometry. On the other hand, classic rigid systems' ranges of movement can be geometrically calculated.

Shown here is the workflow developed to determine the shape of the deformation and the inner axial tendon tension of n by n beams based on tendon/push-rod actuation. This workflow does not introduce external loads yet. The present disclosure has used the commercial software Oasys GSA to calculate those cases.

This section presents first the different degrees of freedom (DOF) that different combinations of faces can create. Then, the two different alternatives proposed to analyze the behavior of those beams under tendon-actuation strategies are shown. Later, empirical parallel tests using Instron machines developed by the inventor in order to quantitatively validate those models are shown. To sum up, the simulation tool is played with to get a feeling of the behavior of this discretely assembled lattice when changing its mechanical properties and its geometrical characteristics.

1.1 Mechanical Anisotropies that Result in Controlled Motion

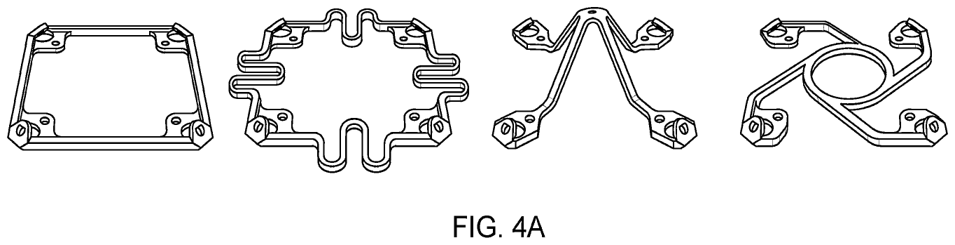

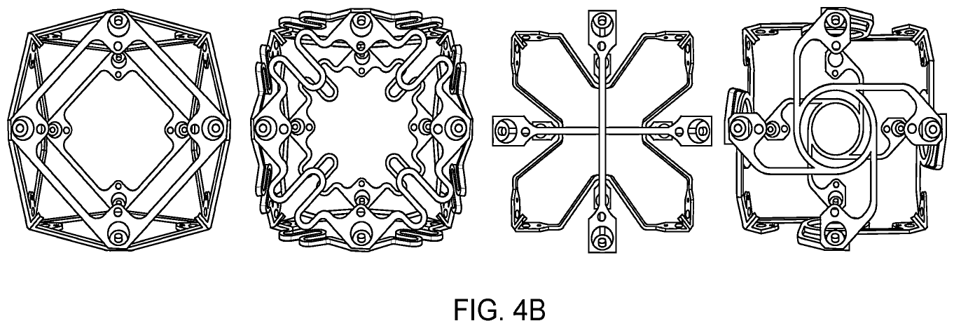

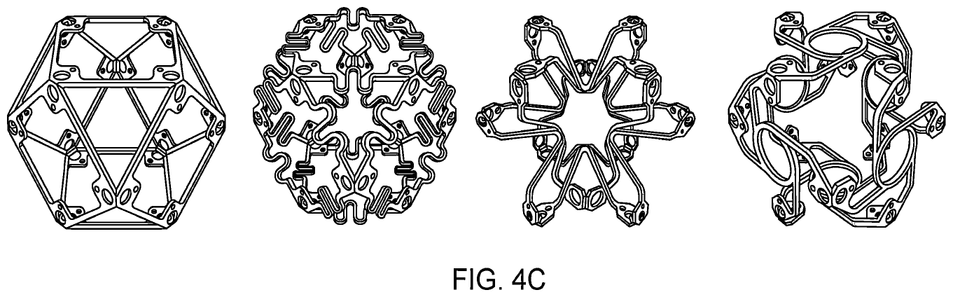

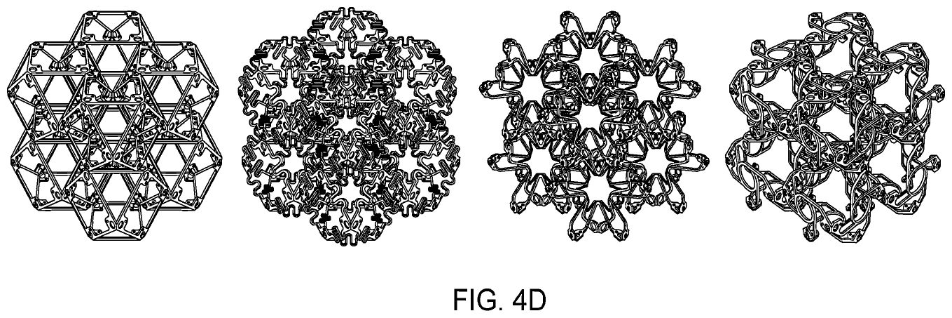

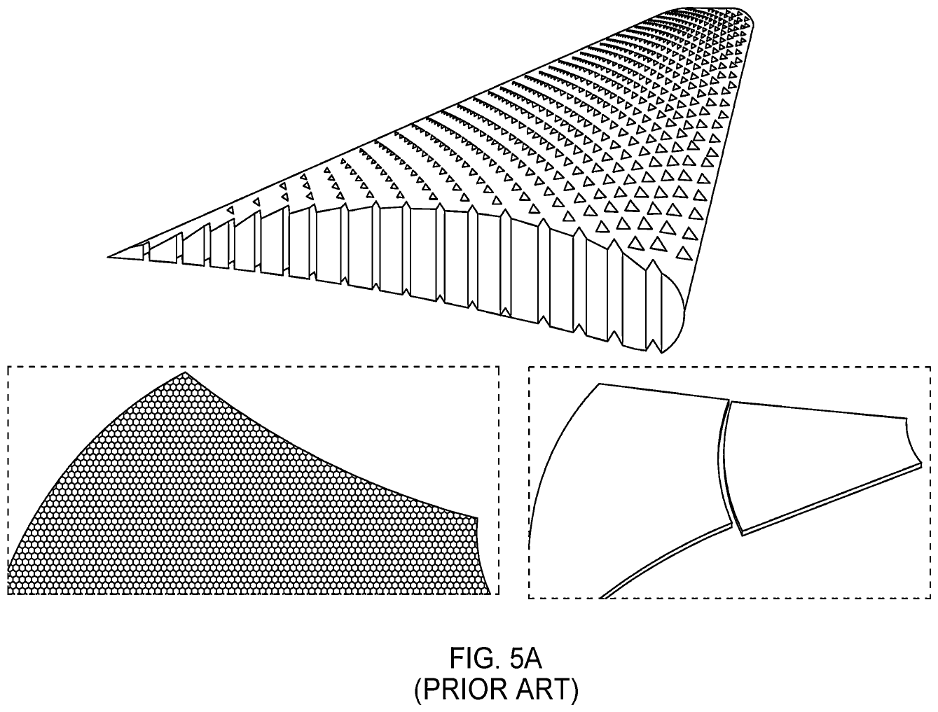

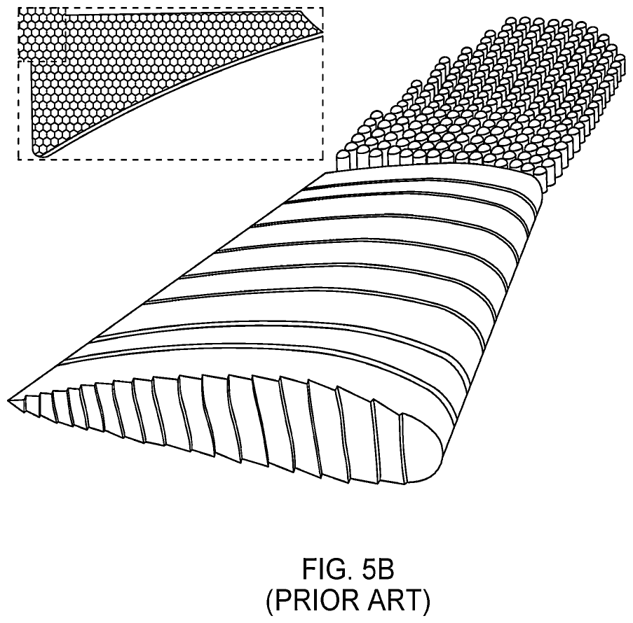

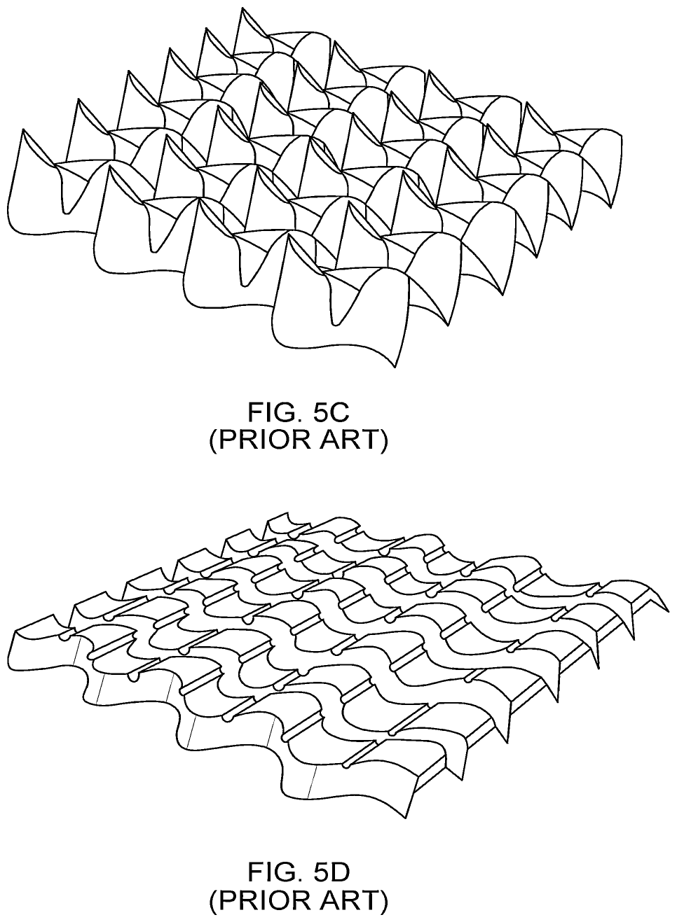

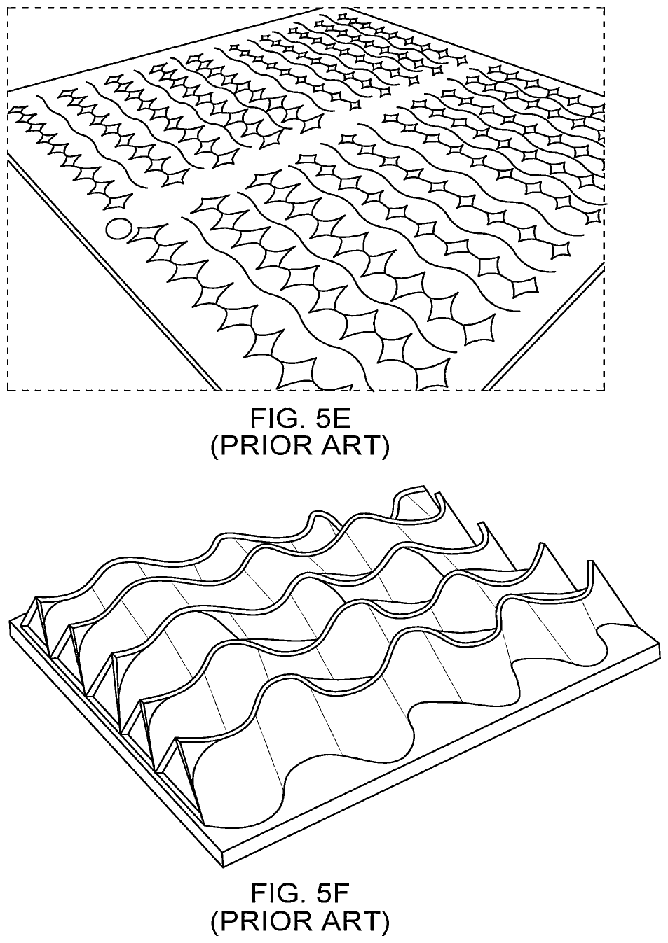

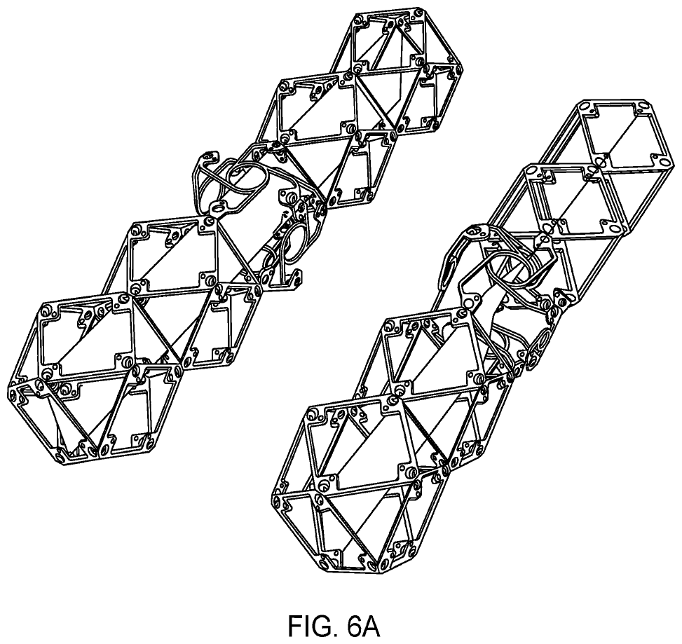

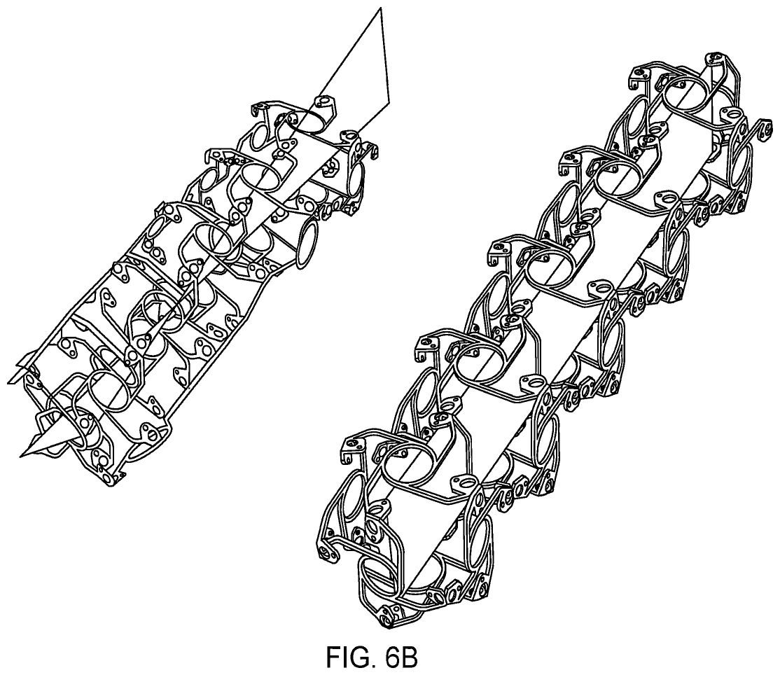

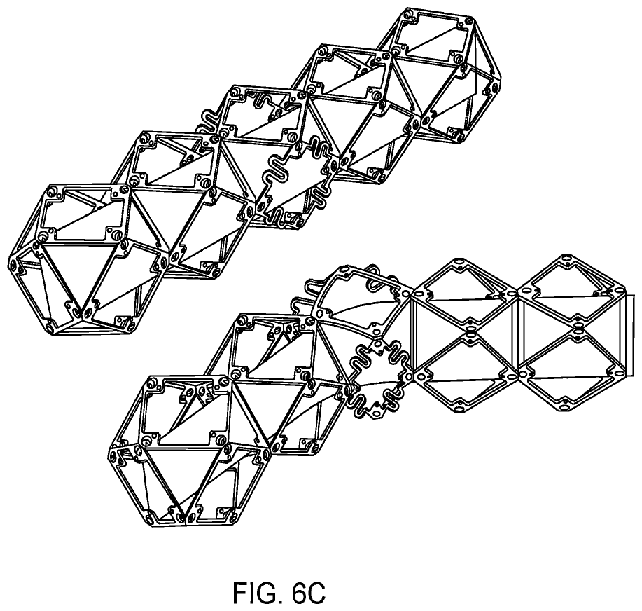

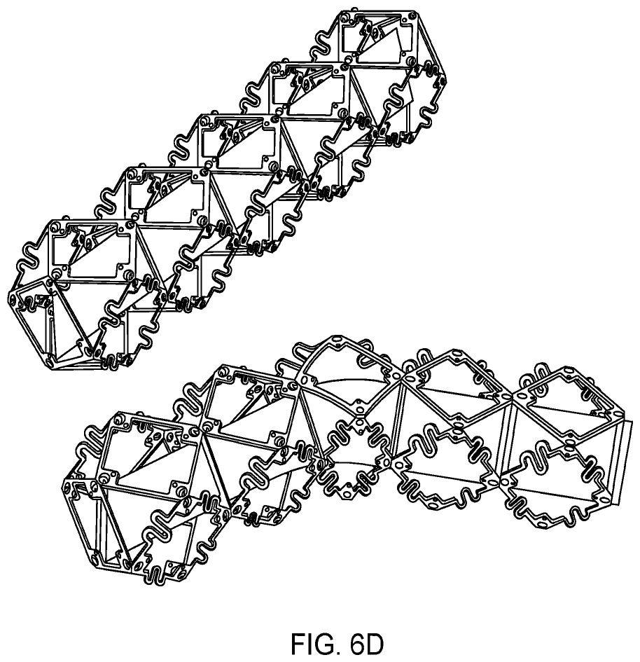

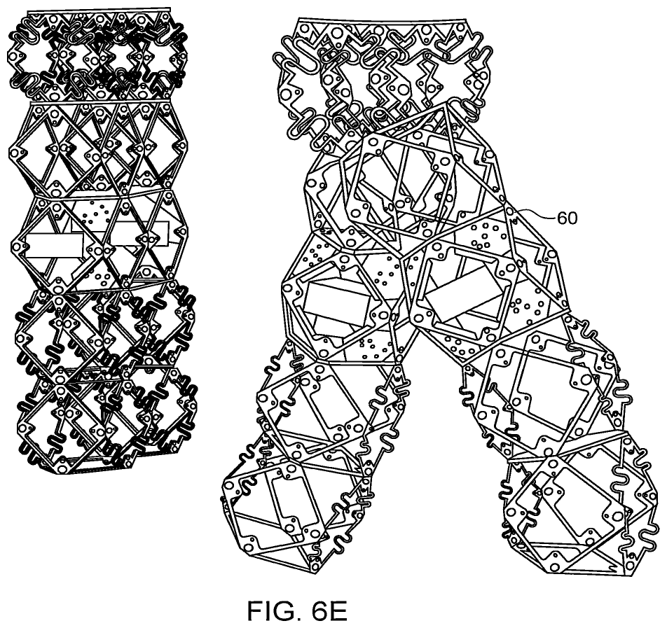

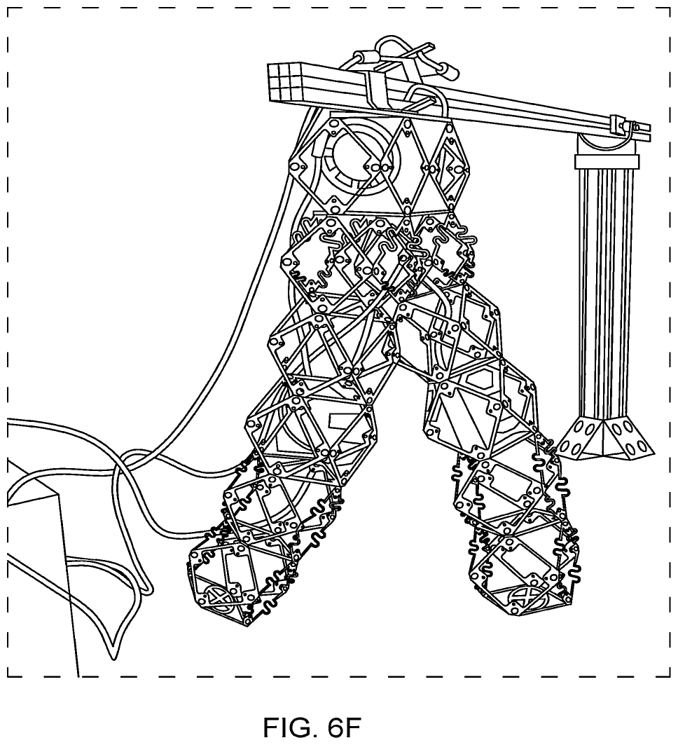

The construction kit developed for the discretely assembled mechanical metamaterials is composed of a stiff, a compliant, a chiral and an auxetic member [21]. All members of the family are shown in FIGS. 4A-4D. The unit cell for this discrete lattice has the shape of a cubic octahedron. This same cubic octahedron can be decomposed into 6 square-based facets. All faces share the same boundary conditions for assemblability purposes, and thus, they are interchangeable. Different combinations on a single cell can generate over the macroscopic structure axial rotations, anisotropic bending and negative Poisson's ratio deformations. Those effects can be generated locally or globally along the structure, and combinations of both will result in intricate custom movements as FIGS. 6A-6F show.

For the sake of a detailed analysis, the present disclosure has found great interest in designing and mechanically analyzing combinations for only two facets, the stiff and the compliant.

Benjamin Jenett et al. showed a detailed validation of the mechanical properties of every family member [21]. The reason to choose only these two members is because of their different elastic modulus over the same geometry, as that of the stiff one can be 10 times larger than that of the compliant, have a huge interest to make controlled mechanical anysotropies of cells, generating desired paths for deformation to happen. As an example, with these two unique parts, walking legs 60 were rapidly developed as FIGS. 6E and 6F show. This is exactly the point which motivated interest in generating larger continuum robotics.

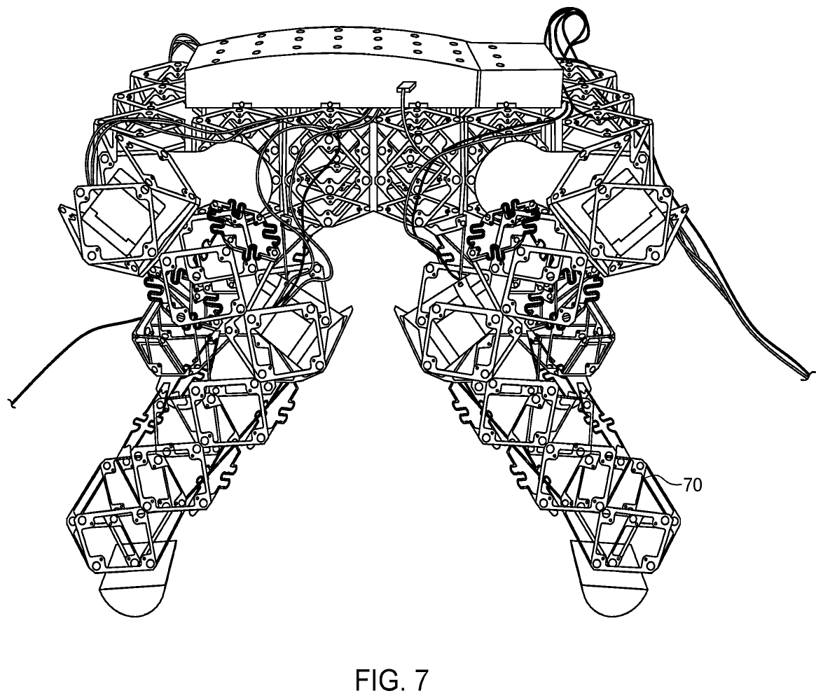

This capacity of having controlled motion was shown by voxel robotic water structures such as the hydrosnake and morphing wing that will be deeply explained below in Section 3 but also by terrestrial robots such as the walker and the puppy 70 shown in FIG. 7.

1.2 Analytical Model of Tendon Actuated Mechanical Metamaterials

1.2.1 From Trusses to Cellular Structures

When working with cellular materials and trying to mechanically characterize them, literature tends to simplify the analysis by layers of abstraction. This approach shown by Gibson, Lorna J. and Ashby [14] describes the global properties of cellular mate-rials, as for example foams, by focusing on the global macroscopic behavior, ignoring the subscale phenomena that generate these global effects. These macroscopic properties tend to have the surname specific and are distinguished from classic properties with an apostrophe.

Notwithstanding, in the engineering-design face of this foams, it is crucial to focus on the subscale effects to be used as fuse serial phenomena that will ensure that the global behavior of the material will always satisfy the failure over some desired zones (compressive buckling, tensile fracture or fatigue). As an example, Jenett et al. [21] designed this construction kit with structurally invisible joints, which guarantees that the failure zone will be in the smaller area of the facets' beams.

And now, in accordance with the present invention, actuation to that foam as an inner force is induced. Tendon-driven actuation analysis of compliant mechanisms is a known field from the perspective of Continuum Robotics. Since continuum robotics claims infinite DOF, discrete tendon actuation is able to use just a finite set of them [36]. In the present disclosure, in order to determine an analytical model, just a single tendon pulling from the base to the highest part of the beam is assumed. Thus, expanding this tool for arbitrarily located hinges once this method is based will be a simple task.

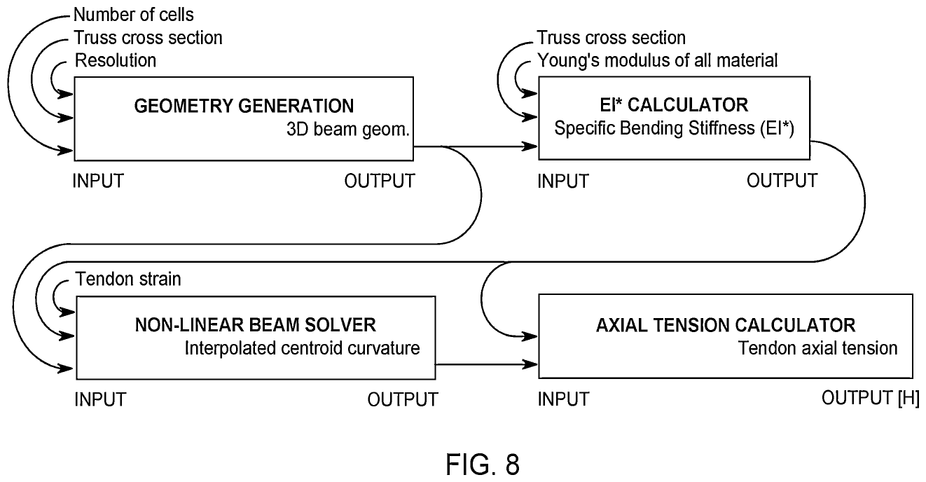

Using Grasshopper [31], and in accordance with the present invention, this disclosure describes a developed workflow (FIG. 8) to determine curvature of the beam and tendon tension given a certain strain on it. This method enables a better shape determination of the designed mechanisms. In addition, it allows an analysis of possible actuators that would satisfy the load condition and the buckling load of any member of the truss.

1.2.2 Centroid-Based Deformed Models

The 3D spline that generates the center of mass of all cross sections of a beam is called the centroid. It is commonly used in continuum robotics as a reference to simplify calculations of robots as it ideally has infinite stiffness compared to the rest of the model. This allows for computation of the centroid linear elastic model and to geometrically determine the rest of the outer mold line of the robot [36] [24] [9].

In the instant case, the centroid of the designs doesn't necessarily have a higher elasticity modulus that would enable assumption that there are no axial deformations over it. This is why there is a need to develop a hybrid model in which the deflection of the beam and the axial elongation/compression of the beam can be computed based on its specific mechanical properties.

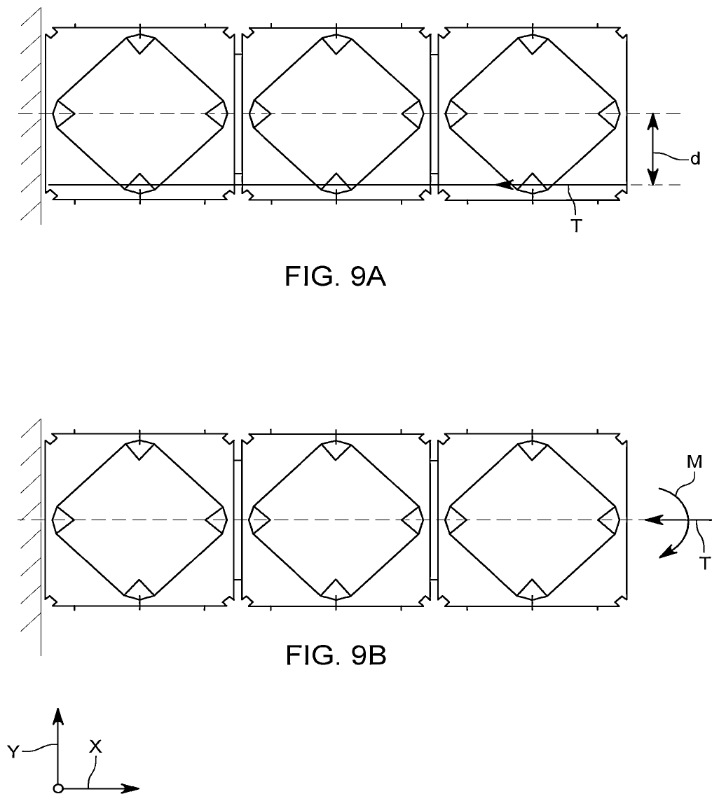

First attempts to determine a method were to decompose the tendon forces into a compressive load and a continuum momentum along the span of the beam, corresponding with the x axis as can be seen in FIGS. 9A-9B.

Euler-Bernuoulli Method with Centroid Deformation.

It was decided to abstract the beam as a continuum foam with a specific value of bending stiffness (EI*) and a specific Young's modulus (E*). For the y deflection (y(s) commonly referred to as δ), the beam was simplified as a Euler-Bernoulli beam. The derivation of the specific load case we are following goes as:

$$\frac{{\partial }^{2} y}{\partial {x}^{2}} = - \frac{M ( x )}{{EI}^{*}}$$

As seen in FIGS. 9A-9B, the tendon load T can be decomposed as a compressive load with value T applied to the centroid and a constant moment along the x direction. Calling d the distance between the applied Tendon load and the centroid, the following is gotten:

$$M ( x ) = T * d = {M}_{0} \\ \frac{{\partial }^{2} y}{\partial {x}^{2}} = - \frac{{M}_{0}}{{EI}^{*}} \to \frac{dy}{dx} = - \frac{{M}_{0}}{{EI}^{*}} x + C 1 \\ y = - \frac{{M}_{0}}{2 {EI}^{*}} {x}^{2} + C 1 x + C 2$$

Applying boundary conditions, C₁=C₂=0

$$y = - \frac{{M}_{0}}{2 {EI}^{*}} {x}^{2} , \frac{dy}{dx} = θ = - \frac{{M}_{0}}{{EI}^{*}} x$$

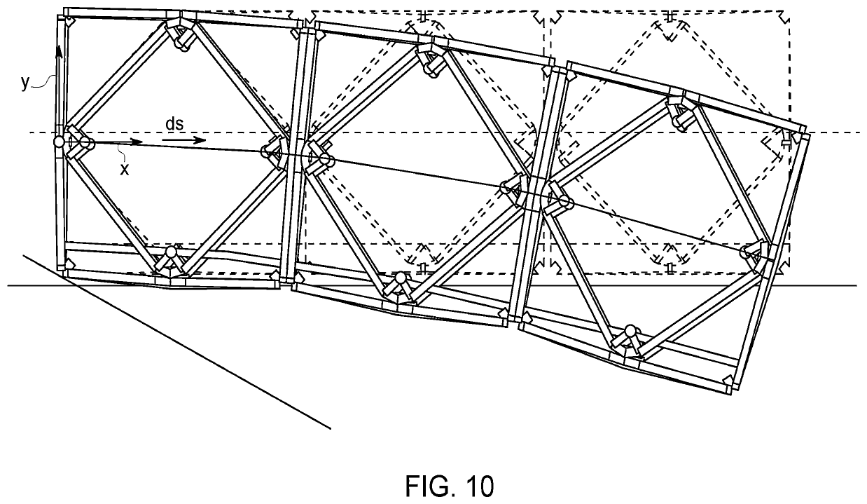

Making reference to FIG. 10, in order to compute the x and y value of the centroid taking into account its compressibility, the described behavior is analyzed traveling over a vector s that goes from 0 to L along it. The values of the centroid compressibility are calculated directly using Young's modulus relation.

$$0 \leq s \leq L \\ x ( s ) = s - \frac{Ts}{{AE}^{*}} \\ y ( s ) = - \frac{{M}_{0} {s}^{2}}{2 {EI}^{*}}$$

This method was not fully compelling as it assumes full linearity and is force driven rather than strain driven.

### Non-Linear FEM Solver

Two major needs were detected that the previous method was unable to satisfy. First was to increase the accuracy of the previous method for large deformations. This is achieved by instead of simplifying the beam as a monolithic volume, treating it as a truss structure inside a non-linear FEM beam solver. Second, a method was needed which was strain driven rather than tension driven. Tensile-driven methods require motors able to report torque values but strain-driven controls increase the accessibility to simpler actuators capable of controlling turns.

David B. Camarillo et al. showed in Mechanics Modeling of Tendon-Driven Continuum Manipulators [36] a linear method to relate beam configurations and n tendon displacements. Assuming in this heterogeneous beam that the neutral surface lies in the symmetric plane, we can use this method to work with the assumption that, in the absence of external loads, a tendon actuated beam forms constant curvature on its neutral surface [18][23][17][38], and that curvature is directly related with the moment arm and the bending stiffness of the element. The basic equations are followed here that led to this conclusion as it is relevant for this proposed method. The image shows how the 3 groups of forces that drive the free-body diagram are F_{eq}, corresponding to the integration of the contact force of the tendon along the beam, F_{T} as the tendon termination force and F_{R} as the cantilever reaction forces. Each of them generates a corresponding moment around the centroid, as shown in FIG. 9B.

$${F}_{eq} = {\int }_{0}^{{ϕ}_{b}} w ( s ) ds \\ w ( s ) = \frac{{dF}_{w}}{ds} = T {κ}_{T} \\ w ( s ) = {{R}_{a}^{e} [ - T {κ}_{t} , 0 ]}^{T}$$

Being R^{e}ₐ the Euler rotation referenced to the base to any described an orientation

$${R}_{a}^{e} = [ \begin{matrix}cos ϕ & - sin ϕ \\ sin ϕ & cos ϕ\end{matrix} ] \\ \frac{{\partial }^{2} y}{\partial {x}^{2}} = - \frac{M ( x )}{{EI}^{*}}$$

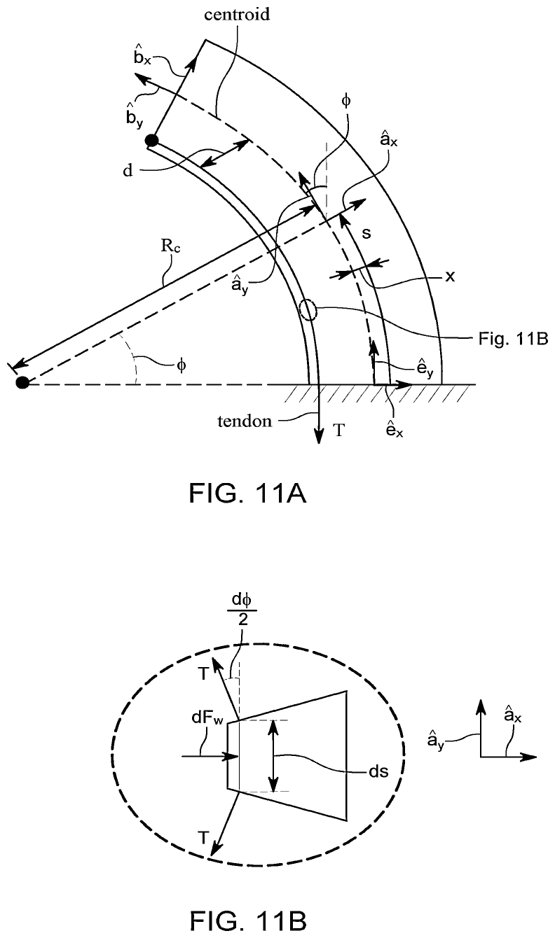

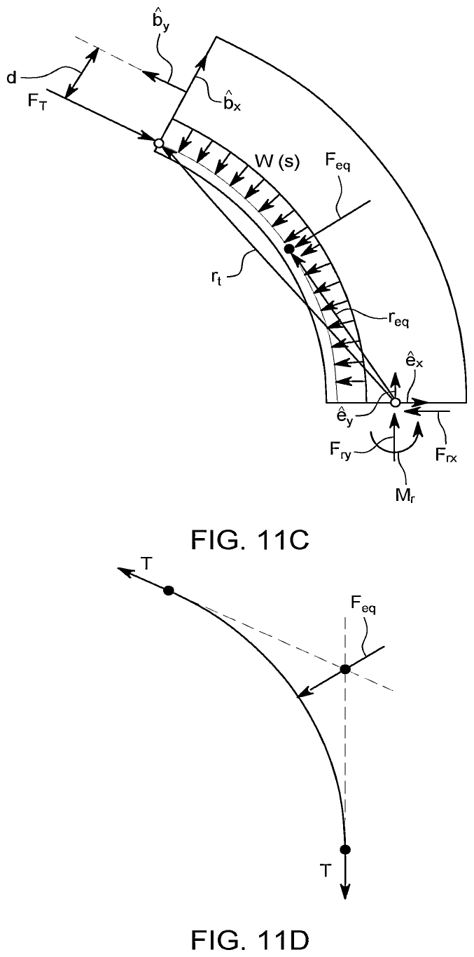

Making reference to FIGS. 11A-11D, Camarillo et al. shows how by ΣF=0 and ΣM=0 it can be concluded that the value κ, κ=1/R_{C} is directly dependent of the bending stiffness value and the tendon tension.

As ΣF=0, 0=F_{eq}+F_{T}+F_{R}:

$${F}_{r} = {[ 0 , T ]}^{T} \\ {M}_{r} = - Td \\ {M}_{r} = {EI}^{*} κ \\ κ = \frac{1}{{R}_{c}} = \frac{d}{{EI}^{*}} T$$

These results allow the equation to be entered with the specific bending stiffness of the beam and the value of the curvature, and will tell the tendon load, solving the difficulties that the Euler method gave us. To feed this equation, a simplified geometry of the trusses is computed, a strain to the tendon is applied, a non-linear solver is used to estimate the deformation of the beam tracking the centroid, interpolating a circle over the centroid points, and analytically calculate the tension.

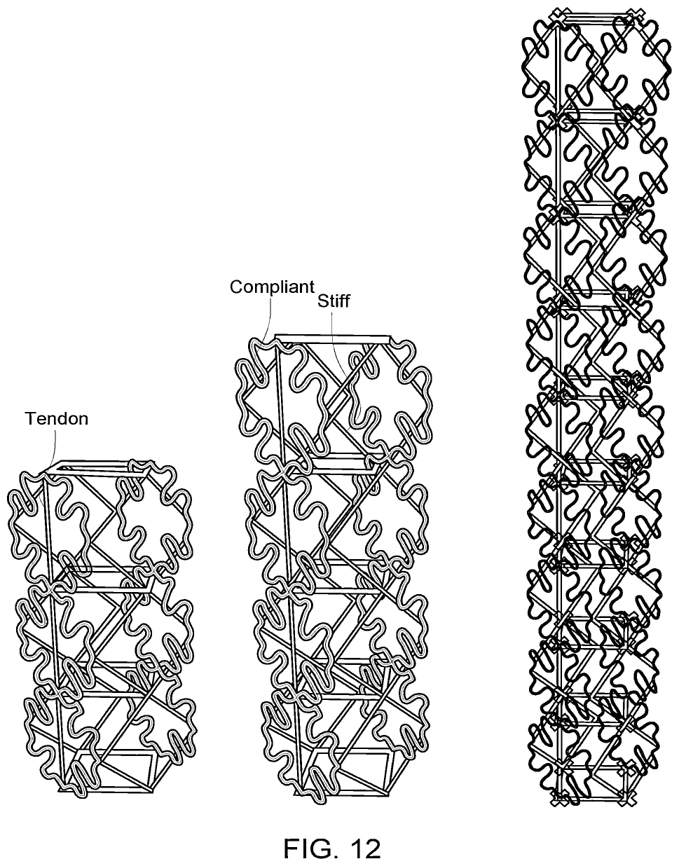

In addition, an environment was created using Rhino-Grasshopper-Python that follows the described workflow. First, a script generates a simplified version of the cubic octahedron heterogeneous voxel. These geometries are sorted by the different materials that will be used. Thus, it differentiates between compliant, stiff and tendon (see FIG. 12).

Once the geometry is generated and sorted by materials and functions, a Karamba3D [34] nonlinear solver is used.

First, a grasshopper tool is developed to calculate the specific bending stiffness of the generated beam geometry. A 3-point bending test is virtually ran following ASTMD4476 standard and, using beam theory for simple supported beam length l with a load P in its geometrical center, with a deflection δ, the Specific Bending Stiffness (Nm²) can be derived:

$${EI}^{*} = \frac{{PL}^{3}}{48 δ}$$

Second, a model strain is generated that is driven by using as load case a strain in the tendon. This strategy is geometrically compelling as the value of the tendon that will shorten can be determined easily and converted into rotations once the motor shaft to be used is known. All axial results of the beam elements will be valid except for the tendon. That is why this method is used just to calculate the inner stress of individual voxel beams and their deformation. The obtained values of the axial loading from the tendon do not correspond with reality as, in a real case actuation, the strain of the tendon will be much smaller.

Once the dynamic relaxation method converges, a Python script searches the geometric location of the centroid and interpolates a best fit circle. That will be used as R_{C} in the equations described above.

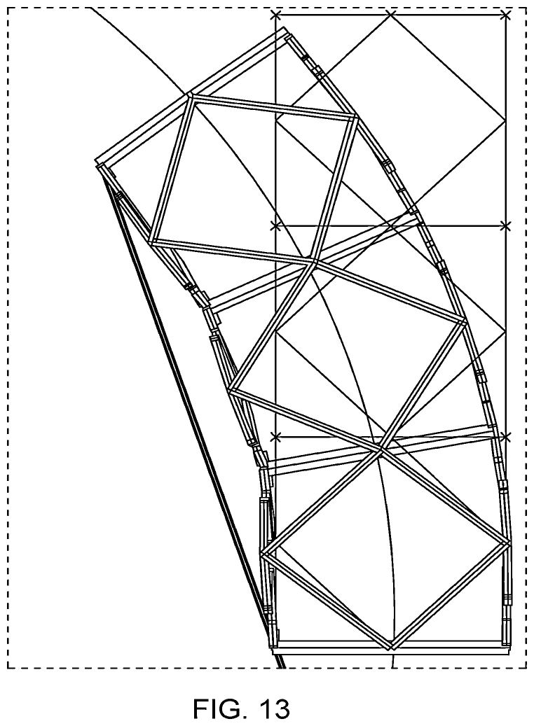

Using the computed value of bending stiffness, which will be a characteristic of the beam that depends on the geometry and materials, and the resultant curvature from pulling the tendon (see FIG. 13), the value of tension that the tendon will be subjected to can be computed.

1.2.3 Empirical Validation

In order to validate the model, a custom tooling was built that replicates the virtual tests developed and mounted them over an Instron 4411 and an Instron 5985. The goal was to read axial tensile loads while tracking as accurately as possible the beam deformation and to determine the bending stiffness of a certain configuration.

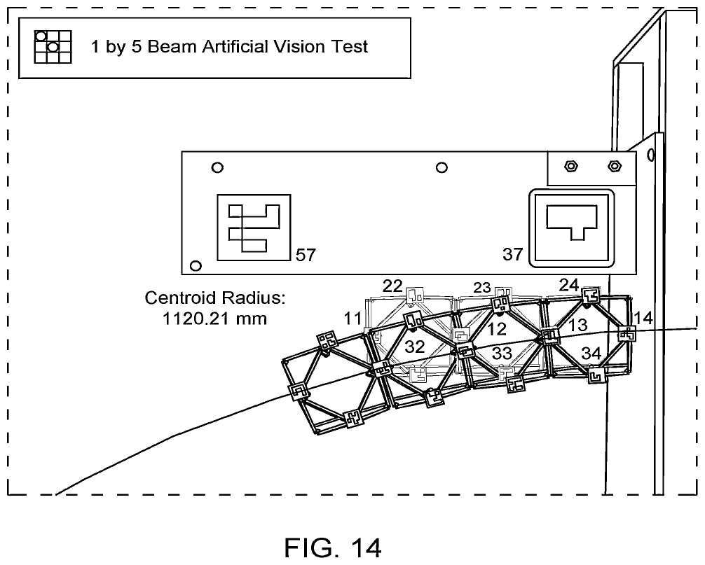

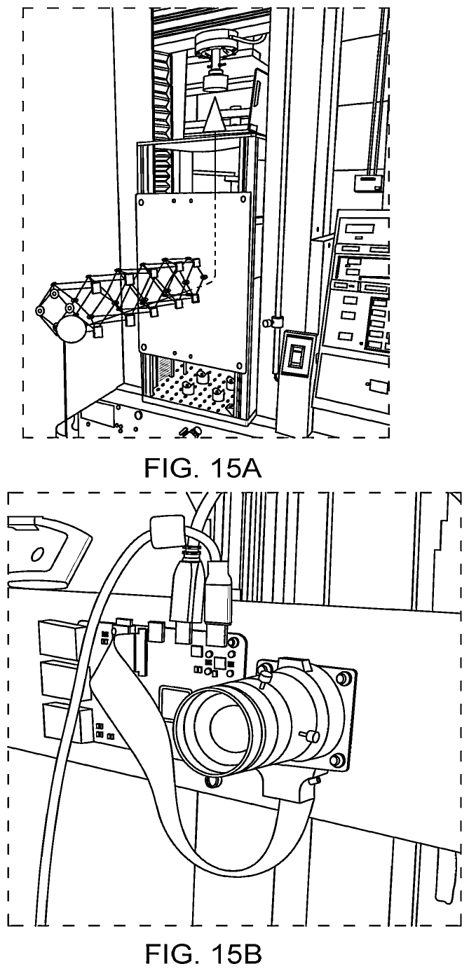

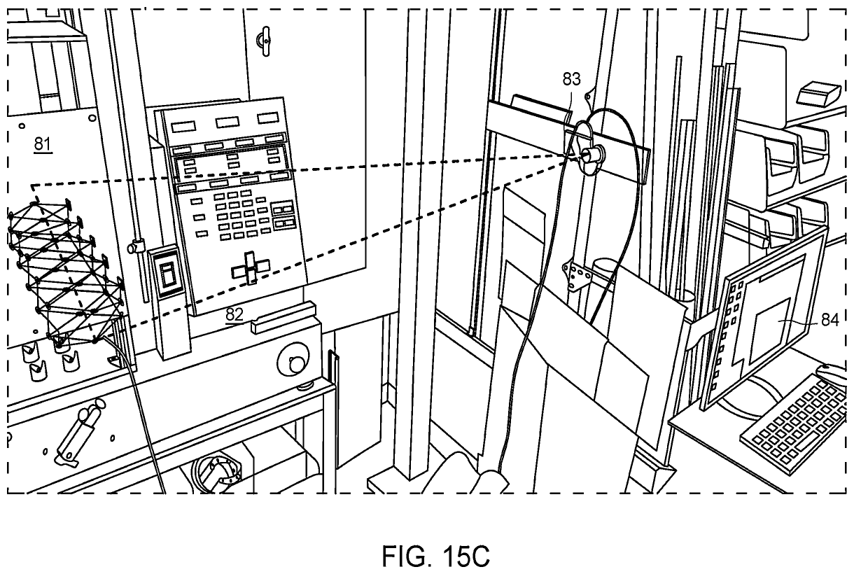

Validations of tension and curvature need two different systems. First, hardware serves as a cantilever base in which also the Tendon will be routed to the Instron. In addition, this hardware tooling, made out of extruded aluminum, orientates the beam to the camera orthogonally. Second, a computer vision frame is built on a Raspberry Pi® 4 using the camera module, a fixed lens and written in Python using OpenCV (see FIG. 14). The Raspberry is mounted on a wall at 1.7 meters of the target beam. The full system can be seen in FIGS. 15A-15C. Referring to FIG. 15C, the reference numbers shown in that figure depict: 81—Cantilever tooling, 82—Instron 4411 with tooling mounted, 83—Vision System, and 84—Control station.

Later, a computer vision system was developed to track Aruco targets located in beams using OpenCV. This method helps to validate shape deformations of the centroid by detecting specific targets, correcting the angular deformation and interpolating a circle that fits the best the central targets. Tests were run in the Instron in which the strain velocity goes to zero every 5 mm. At that instant the raspberry takes a picture to later match exactly tendon tension with images taken.

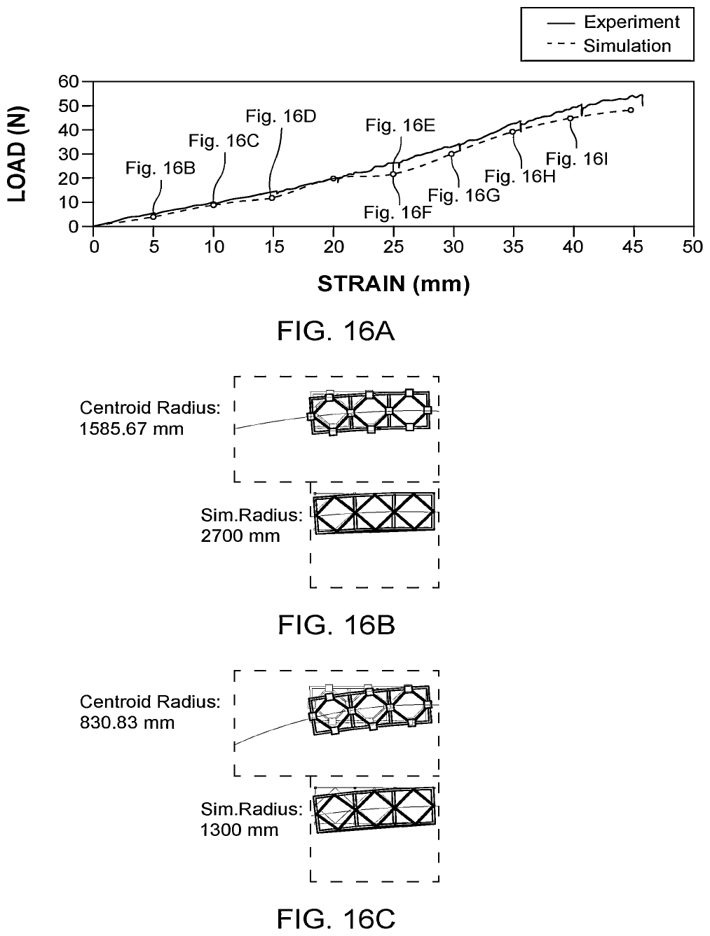

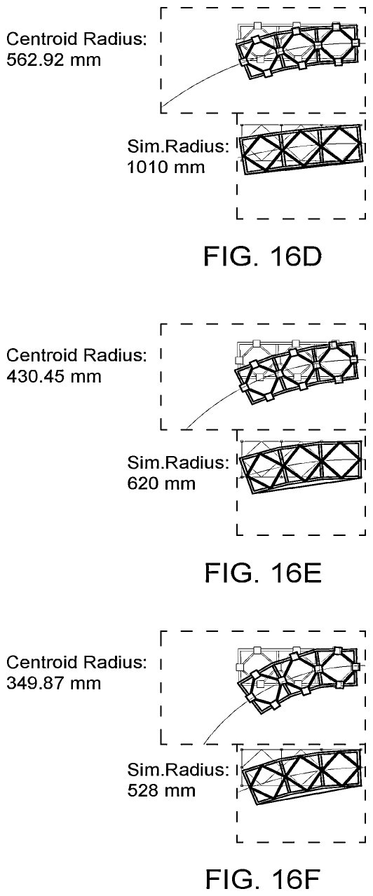

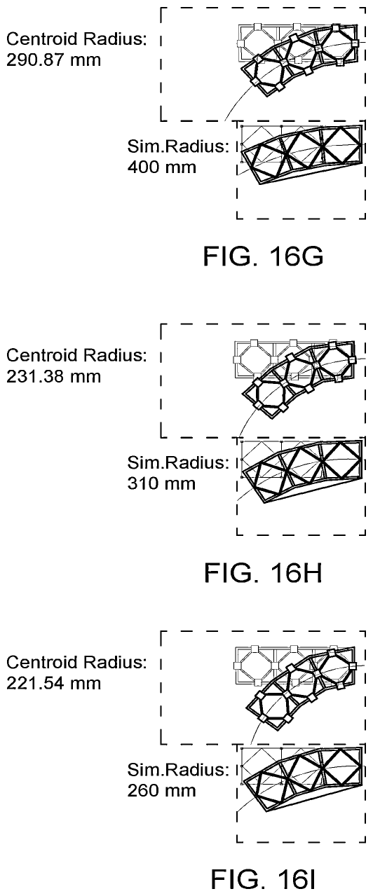

With the developed tooling and the virtual tool, the same experiment was performed and the results verified. As it can be seen in FIGS. 16A-16I, there is an accurate matching of strain-tension at lower values of strain. Inside the Instron test it was appreciated how the first cantilevered voxel do axially compress much more than their adjacent and that impacts on the deformed visualization. On the other hand, simulations perform constant radius experiments. The deviation in radii is much higher than the deviation in Axial stress of the tendon. It must be considered that the rotations of the nodes in the voxels was not taken into account.

### 2. Skin Interfaces

In this section, solutions are studied that would enable filling the gap between the structure and a continuum curvature outer mould line. Most of the solutions studied thus far that are applicable to industrial applications have a high dependency on shape. Voxel-based structures don't fill the gaps unless paying the high price of hierarchy or decreasing the unit cell. To keep the simplicity of working with one size of voxel, a Kirigami structure was developed that will distribute loads while providing any one curvature outer mold line.

First, the problem is introduced. Next, the Kirigami modification of the Miura Ori developed is described, introducing the concept of materiality. Then, from a more generic perspective, the mathematical approach to automating the volume filling given two target surfaces is shown. Later, cuboctahedral voxels for structural filling and DOF compatibility is specified on. The section is finished by showing some manufacturing methods used. Ultimately, the difference is illustrated between continuum origami and what is described here as “discrete origami.”

2.1 Introduction

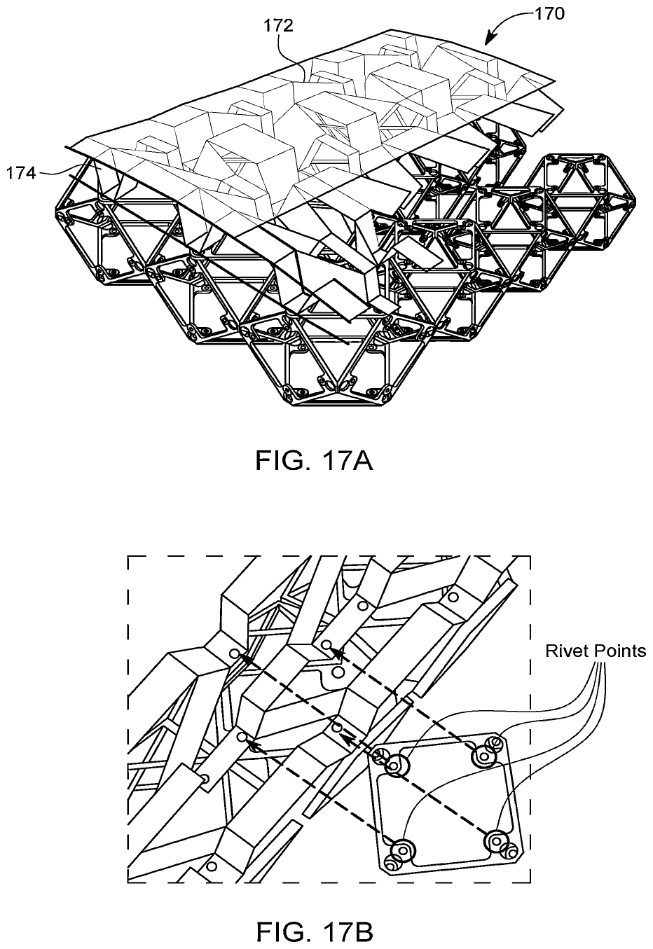

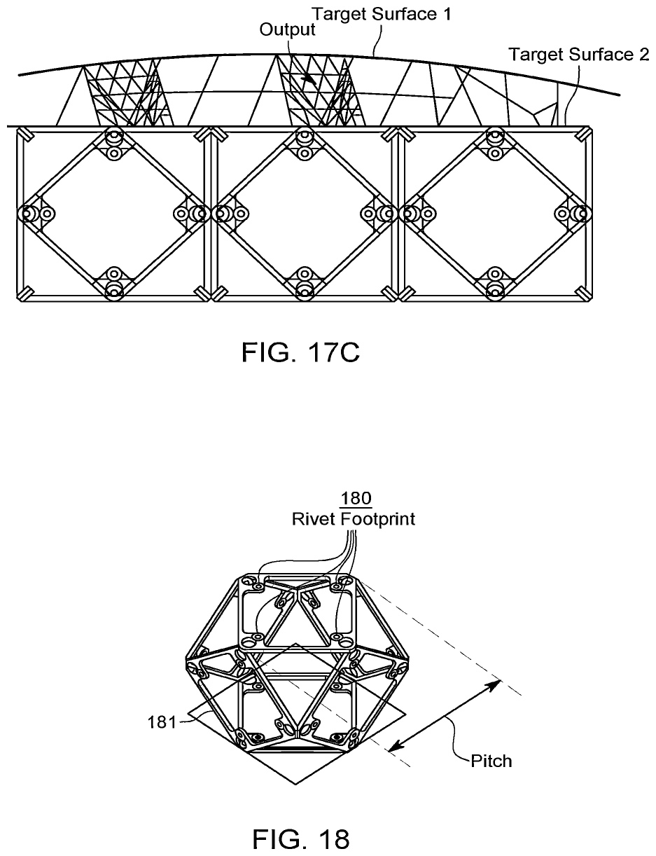

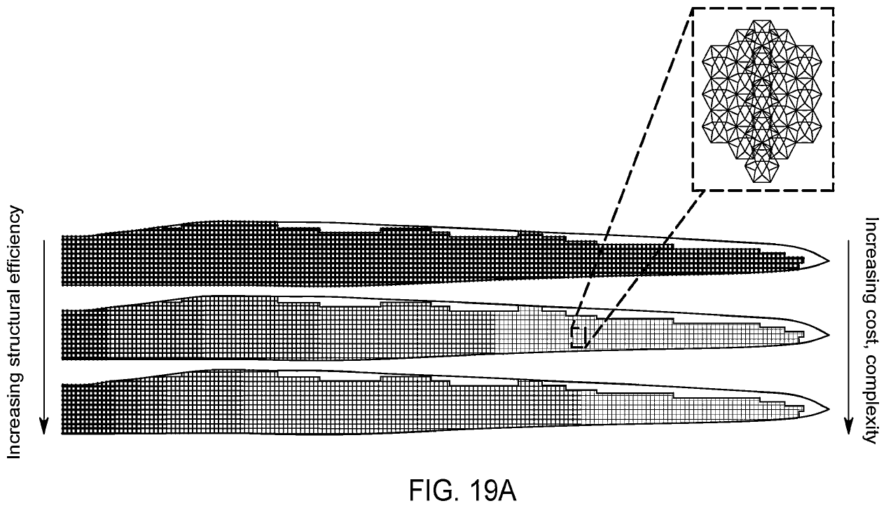

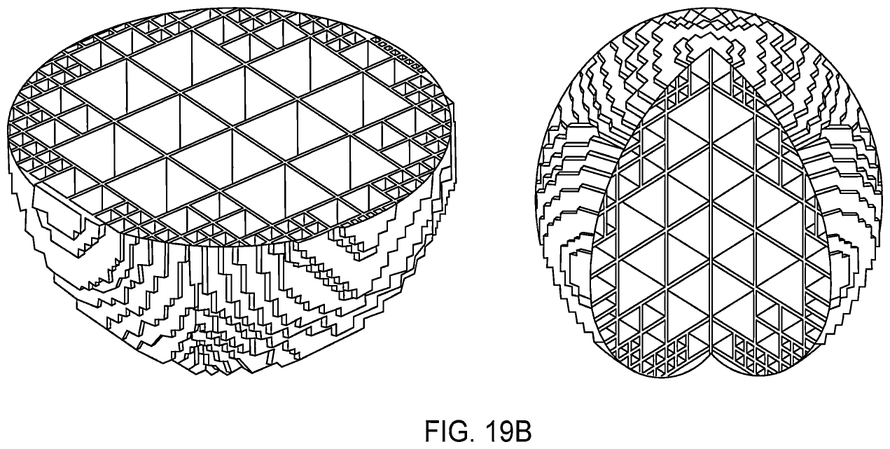

Most of the studies developed using voxels have a high dependency on their shape. Just focusing on this research problem, voxels oppose the ideal solution to replicate a determined shape as accurately as a monolithic structure. A building block's resolution is in the order of its size; currently a cell size of 75 mm is used, while monolithic manufacturing solutions are in the order of microns. FIG. 17A depicts a Kirigami core 170 in accordance with the present invention.

Solving that challenge using only discrete cellular solids would introduce a solution that uses:
1. A smaller pitch value. Reducing the size of the cell will directly imply a higher resolution.
2. Hierarchical assembly. Using a finer cell as we approach the outer mold line will also yield a higher resolution.

There are reasons for not using these approaches. Both will impact the complexity of the solution, increasing the overall relative density, automation, and cost. Hierarchy, especially, would force the project to redesign faces and include more family members in order to assemble smaller cells.

State-of-the-art volume-filling folding solutions [39] do not offer a comfortable type of folding that could be assembled into the voxel and, later, attached to the outer skin. This difficulty in assembly shows a lack of materiality. The present disclosure calls materiality to the ability of a folded structure to be assembled in the three spatial directions. Folded structures are composed of two different topologies: folds and facets. When making an array of that unit cell, it is always desirable in terms of assemblability to have a facet-facet join as they can be riveted, co-cured, glued, etc. An edge-edge join, on the other hand, will increase the difficulty of ensuring structural bonding. Most of the rigid origami adaptative folds will lie on an edge rather than a facet [8]. Ron Resch type patterns do offer facets which join on their target surfaces—but are extremely complex to fold and don't allow for mechanically attaching the lower boundary when folded, due to overlaps.

Up to this point, filling the described gap between voxel structure and skin has been done by freezing the voxel geometry, designing and manufacturing custom made monolithic solutions to adapt to slopes.

In accordance with the present invention, a novel approach is proposed that will respect the scalability purposes and the relative movement generated by heterogeneous assemblies by utilizing a global algorithmic approach and an easy manufacturing process. The solution proposed is a Kirigami structure 170, see FIG. 17A, that, when folded, will adapt to any outer shape as its target curve but will also respect the riveting footprint 180 of the voxel 181 in an accessible way as shown in FIG. 18.

2.2 Tesselation. Search, Modification and Redesign.

Previous solutions shown by Calisch and Pellegrino are Kirigami [8] [39] folded cores able to adapt to any volume generated by two arbitrary surfaces if they don't intersect between themselves or the other.

But those solutions provide folded structures with one dimensional creases lying in the target surface. From a manufacturing point of view this solution is far from ideal, as it doesn't enable the physical attaching or co-curing of the core with a tangible outer skin. A solution was looked for that, instead of creases, uses folded structures 174 (see FIG. 17A) which generate a surface 172 that will live in the target area when folded. A modification in a pattern must be done to transform vertex and hinges into those facets.

Firstly, patterns were looked for that already offered this materiality feature. The most interesting candidates were members of the Ron Resch family. Some of them could offer the effect looked for, but they weren't respecting the footprint of the voxels 181 (see FIG. 18). Also, the folding process of a single unit cell was a challenge as it needed a high number of folds. As folding is a parallel process, adding a hinge directly affects the simplicity of the automated solution as it adds a new independent DOF.

This is the main reason it was decided to take and modify a pattern composed by few hinges and one DOF as the Miura-Ori. To achieve the target geometry, a jump from Origami to Kirigami was made to gain some degrees of freedom from the rigid origami version.

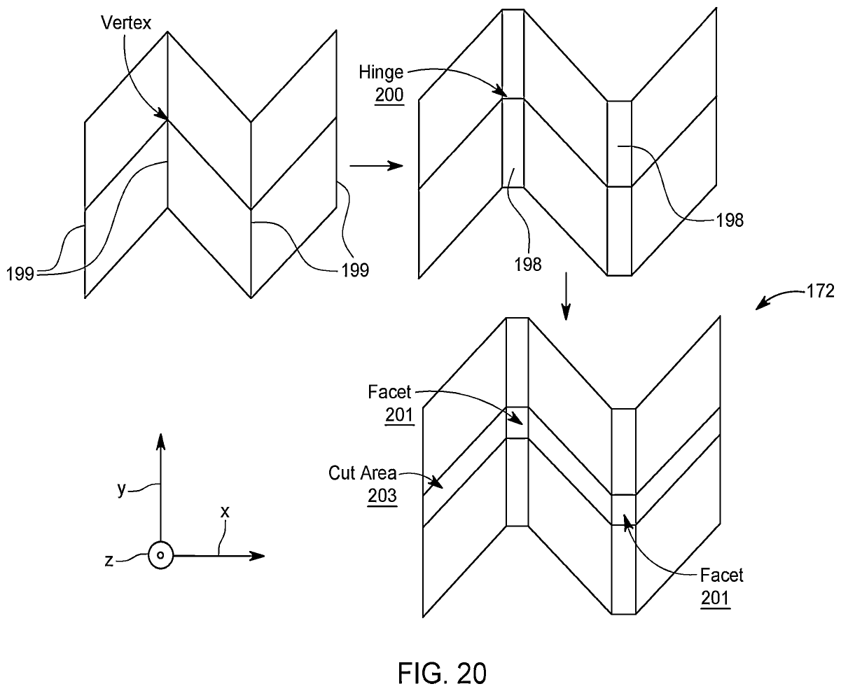

To achieve that materiality points needed to be converted into surfaces, the first movement is clear. As seen in FIG. 20, an offset 198 was made for each of the vertical hinges 199 (upper left image in FIG. 20); this point was then extruded into a line (hinge 200) in the X axis. This tessellation is still Rigid Origami but it has lost its capacity of being flat foldable. The next step should be to extrude the new line 201 created in the Y axis, creating a facet 202. This situation leads to this tessellation not being foldable anymore; here is where Kirigami became necessary. Cutting the shaded area 203 shown in FIG. 20 would make this 2D pattern foldable again. As can be seen, for a regular unit cell, the hinges that limit the polygon that was cut will live in the same plane, called the osculating plane, with new facets that have been created. This same effect happens in the Miura-Ori pattern in which alternative zig-zag creases will belong to the same osculating plane during the folding. But in the present case, the new fold forces the shape of it to be different in every stage and rigid Kirigami is allowing it.

2.3 Pattern Construction

Several methods to analytically determine the unfolded solution of the Miura-Ori given a folded state have been published [15] [41] [46]. For the sake of simplicity in the present disclosure, the equations are developed for this novel fold building on top of the work shown in Geometry of Miura-Folded Metamaterials developed by Mark Schenk and Simon D. Guest [41].

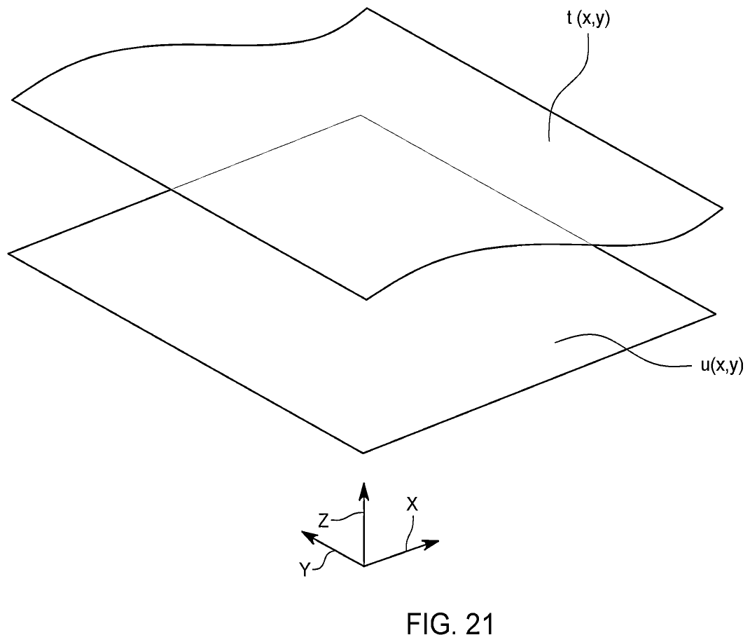

The space to fill is the 3 dimensional volume generated between two surfaces u(x, y) t(x, y) as shown in FIG. 21. This method works when both surfaces have a single curvature.

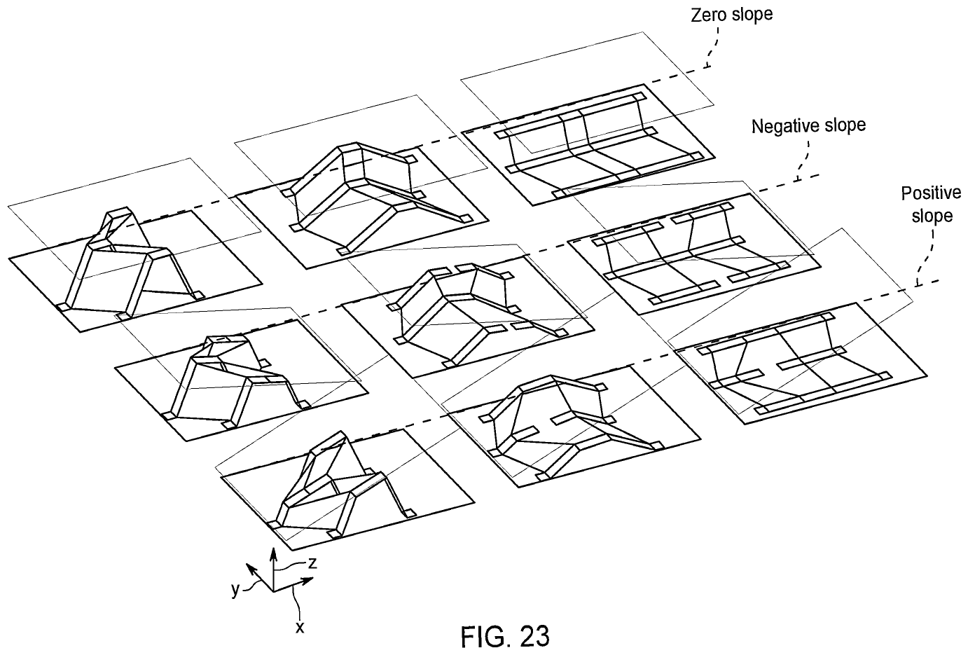

The process the present disclosure is describing generates a folded architected tessellation with the described novel modified Miura-Ori cell for any of the three possible scenarios: a positive slope, a negative slope or a zero value slope as FIG. 23 shows. Next, the process algorithm is described that was generated to compute the volume filling.

2.3.1 Algorithm Steps

This approach fills first a folded structure 174 as the one shown in FIGS. 17A-17C. Previously in this section, its ability to unfold to a flat state was shown. The method described next can be applied to generate monolithic tessellations or what the present disclosure calls discrete Origami cells. For the sake of simplicity, the method to solve a single cell will first be described and later on the steps to follow to generate either of the both shown alternatives will be explained.

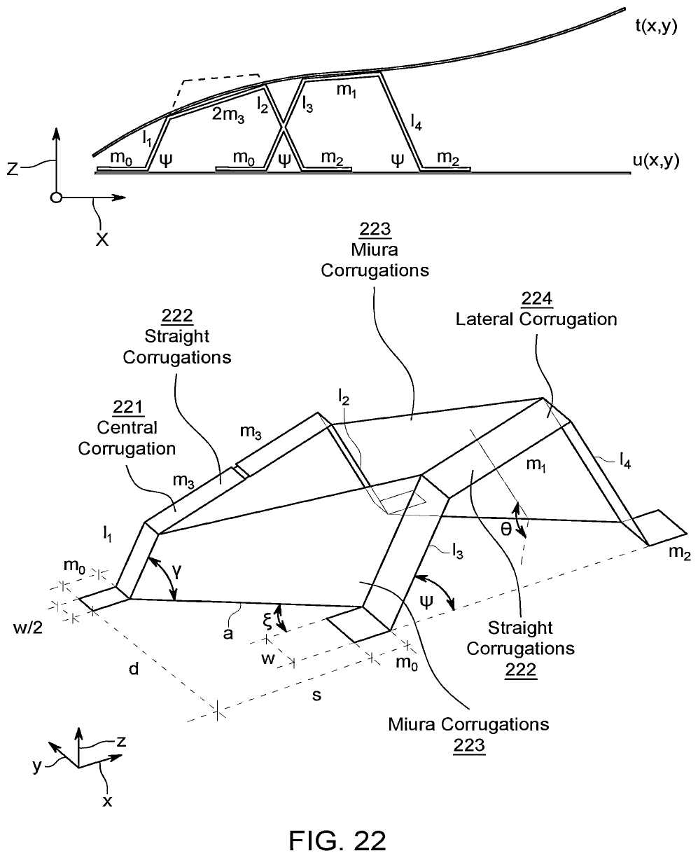

This novel fold has two main characteristic parts. One is the straight corrugations 222 and the other is the Miura corrugation 223. As it can be seen in FIG. 22, the fold minimal expression can be designed as two straight corrugations 222 with a vertical and horizontal offset in which flat surfaces are lofted on their adjacent segments. The feature that the central straight corrugation 221, 222 and the lateral one 224 shares morphology is key to ensure that it is unfoldable.

There are some degrees of freedom that need to be decided to compute the folded structure. This part of the design process makes this fold interesting to fill custom footprints and makes it flexible to adapt to custom aspect-ratio unit cells.

First, taking a lateral view as in FIG. 22, a corrugation needs to be traced that when moved with an offset of s, still intersects with the upper domain t(x, y). Second, once the offset s is applied, the part of the straight corrugation 222 that exceed the boundaries is trimmed, resulting in obtaining the final shapes of the straight corrugations 222 and their inherent lengths l₁, l₂, l₃, l₄, m₀ and m₂. The lengths of the line segments of each corrugation are now measured. If the central corrugation 221 is greater than the lateral corrugation 224, the cell is locally a positive slope. If it is smaller, the cell is locally under a negative slope. If the values are identical, it is in a zero-slope area. For the cases of positive and negative slopes, the smaller corrugation will have a cut, dividing the top segment (the one that relies on t(x, y) into two segments called m₃. The top segment of the uncut section will be called m₁. When working with zero-slope, the relations are simplified as there is no need to make any cut and also l₁=l₂=l₃=l₄.

Now the central corrugation is moved further in y a value of d. Also, now the value w is decided, corresponding to the extrusion in the y axis of the corrugation.

Next, l₁ is lofted with l₃ and l₂ with l₄ obtaining the so-called Miura corrugations 223. The base segment of this facet that belongs to u(x, y) is called a and will be widely used in the next steps.

Geometrically now, equations can be written to calculate ξ, ψ, θ and .γ. Deriving equations from [41], we get this new relationship that sets the values for all angles as a function of ψ and ξ.

$$ξ = \frac{π}{2} - a tan \frac{s}{d} \\ θ = a tan \frac{tan ψ}{tan ξ} \\ γ = a cos ( cos ξ cos ψ )$$

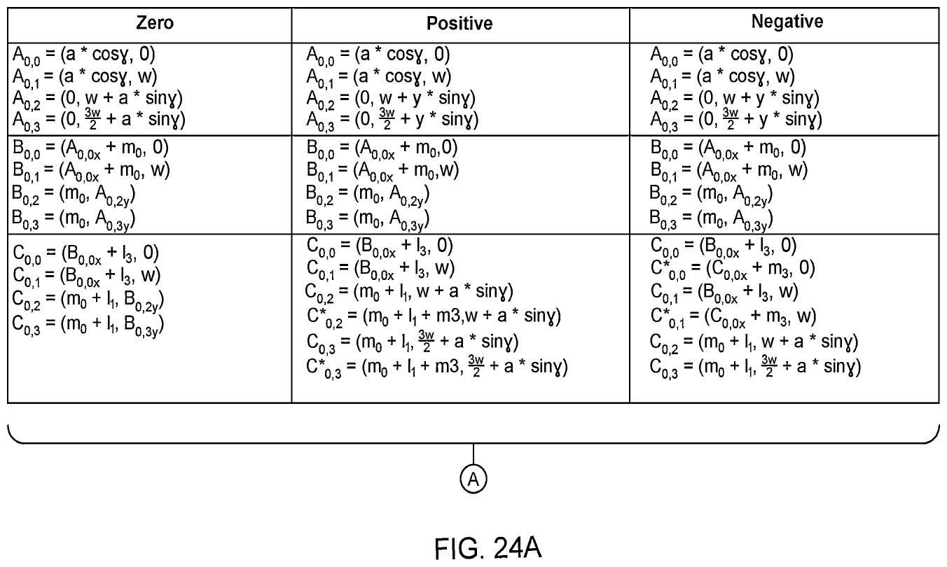

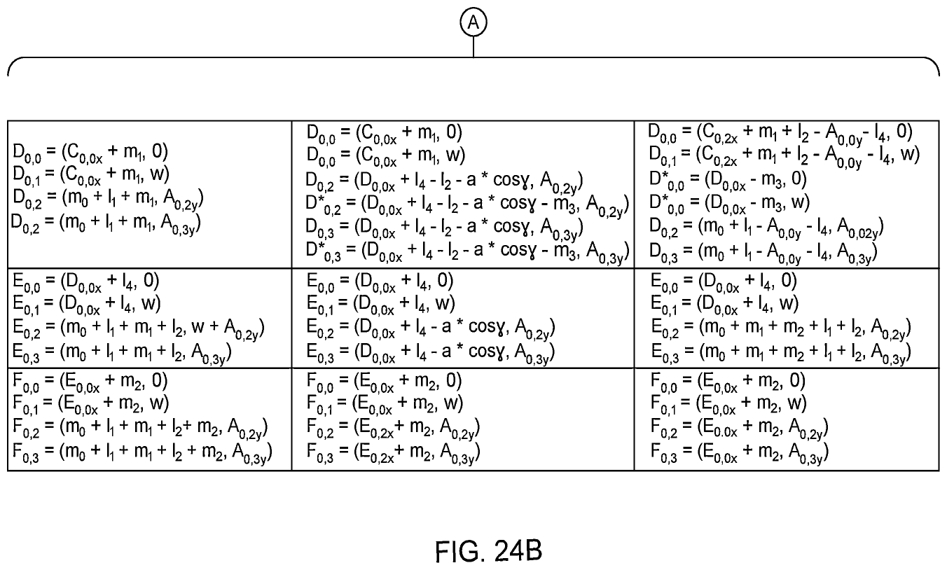

For the three different scenarios, the equations were developed to find all the possible vertices on their unfolded state. Being x_{i,j}ϵR² an arbitrary vertex of the unfolded state and writing x_{i,j}=(x_{i,jx}, x_{i,jy}) equations are derived in FIGS. 24A-24B to compute all geometric locations. The following sub-sections of this section will show detailed diagrams of the three possible different scenarios, each one with its singularity.

This method can be used to fill a volume discretely filling a grid and computing and unfolding as it goes. Is it because of the nature of the sub indexes i,j for each vertex. When computing and unfolding a large number of cells, it is key to maintain the same s, d and w value in all rows of cells. That guarantees that the whole row, at its unfolded state, has the same width.

2.3.2 Neutral Slope

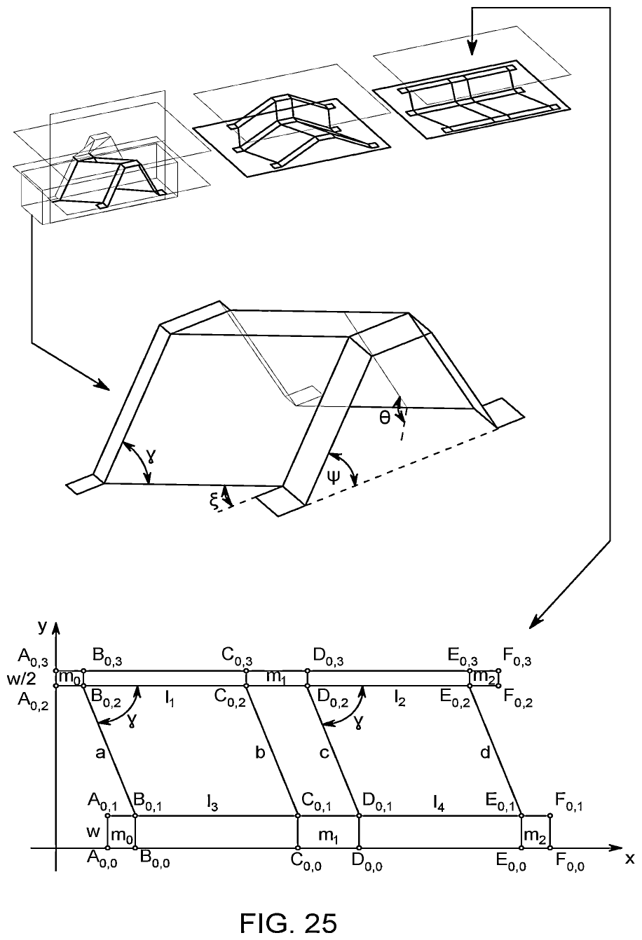

See FIG. 25, which depicts zero slope unit cell nomenclature, angle definitions, and vertex names.

2.3.3 Positive Slope

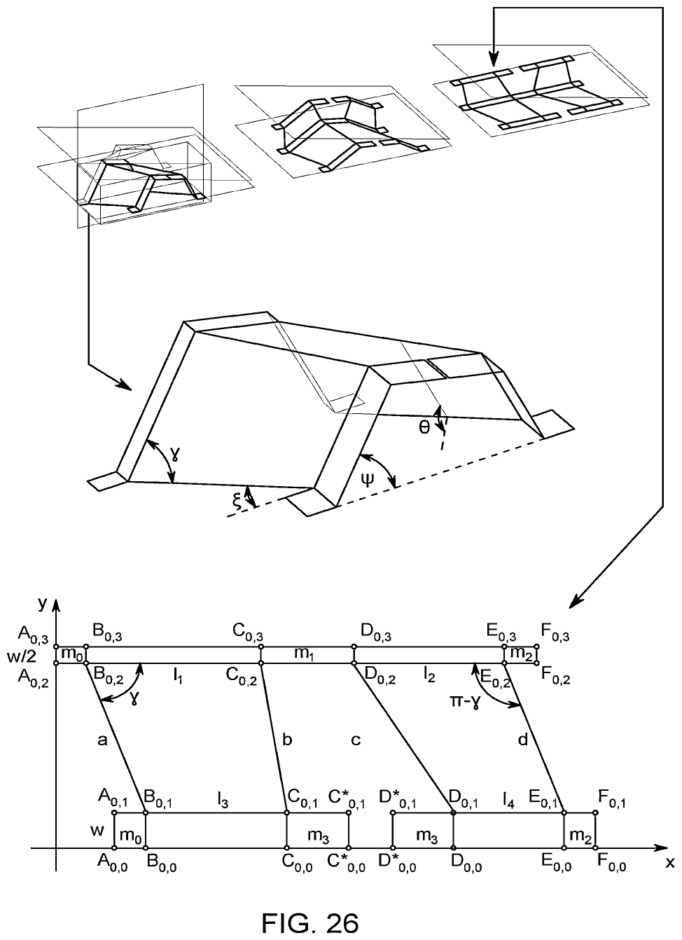

See FIG. 26, which depicts positive slope unit cell nomenclature, angle definitions, and vertex names.

2.3.4 Negative Slope

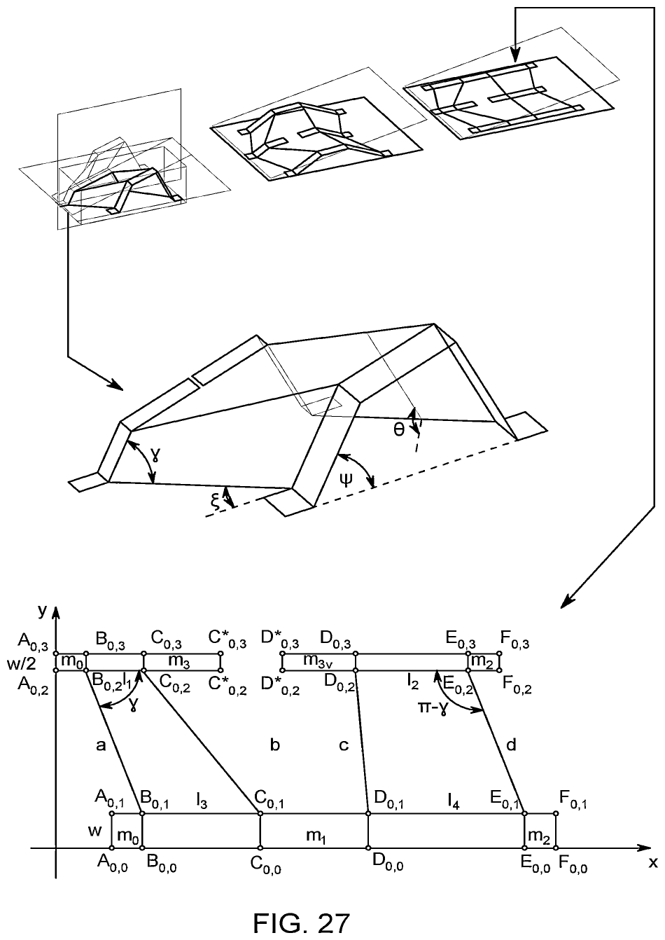

See FIG. 27, which depicts negative slope unit cell nomenclature, angle definitions, and vertex names.

2.4 Kirigami—Voxel Structural Compatibility

This method offers a big design space when deciding the shape of the footprint of its folded state. This feature is highly interesting for cases in which there are determined geometrical constraints to assemble the folded core with a base. As an example, in FIG. 18 it can be seen how voxels have on each face 4 rivets points. It can be decided that the folded structure will generate facets over all them, imposing the right values for ψ, m₀ and w.

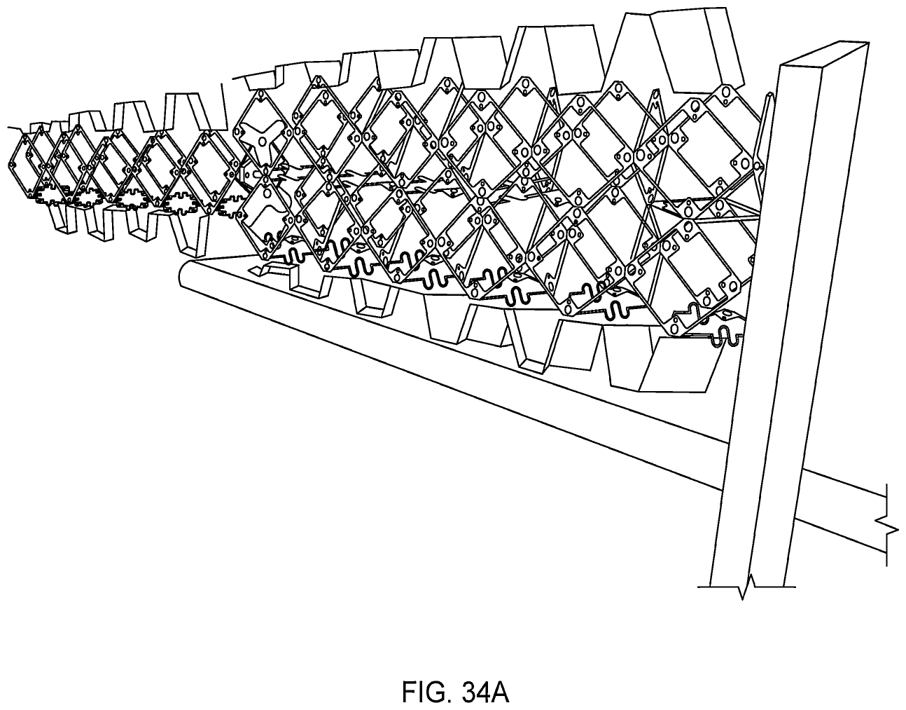

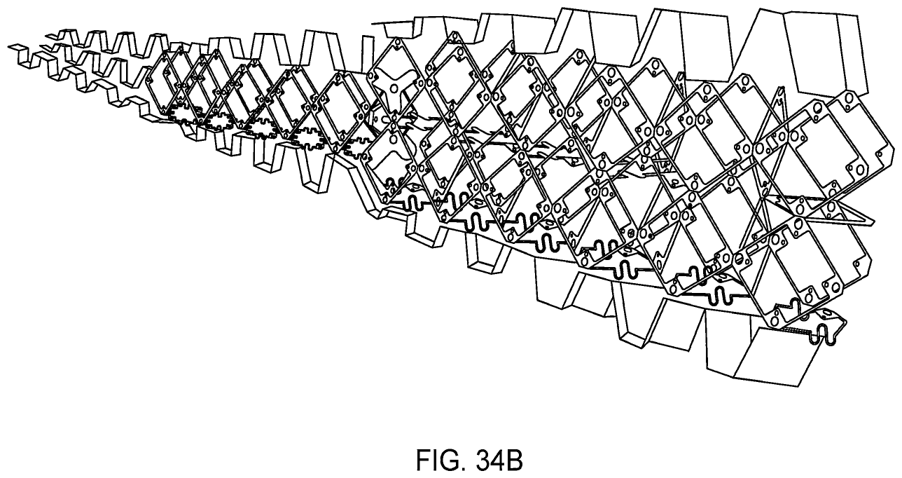

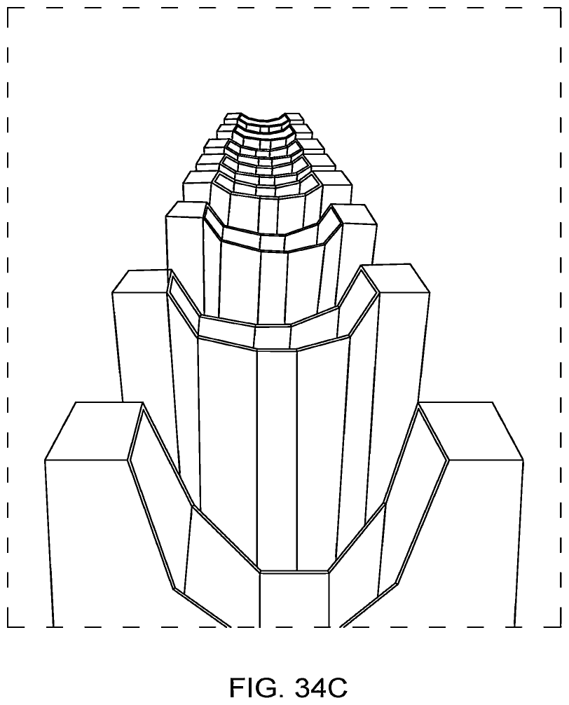

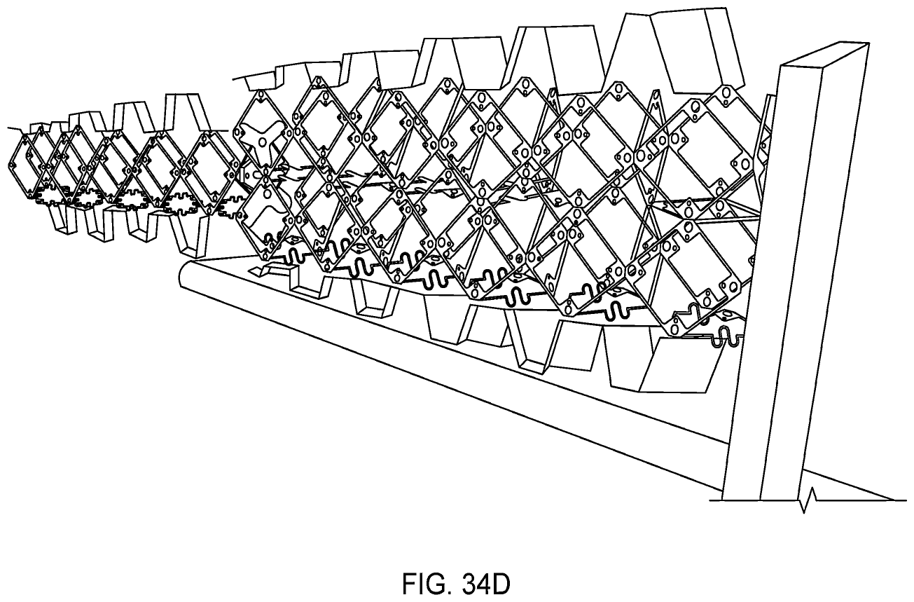

As an example, in FIGS. 34A-34D here the gap of a torsion box is filled with its outer mold line using the algorithm. A detailed picture of the strategy to match the footprint can be seen in FIGS. 17A-17C.

2.5 Matching Adjacent Anisotropies

If these structures could fill the gaps between the digital material structure and the target outer mold line, the degrees of freedom of the base structure need to be respected. In section one, the present disclosure explained how structures can be created with global and local hinges. If a classic modified Miura cell is placed above and assembled, we will affect the intrinsic bending stiffness of the base structure. To do so, two strategies are proposed to provide different types of unit cells able to be completely stiff, partially bendable, and fully compliant.

The cells explained above in section 2.3 are fully isostatic structures when assembled in their target surfaces. This feature is needed when shape to digital materials meant to behave stiff are provided. But on the other hand, that means heterogeneous lattices are prevented to bend because of the increase in the global bending stiffness of the full assembled component. To prevent this, two approaches can be followed.

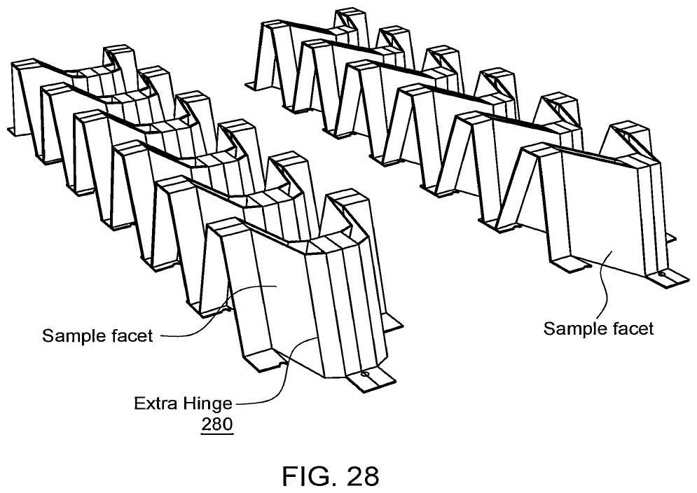

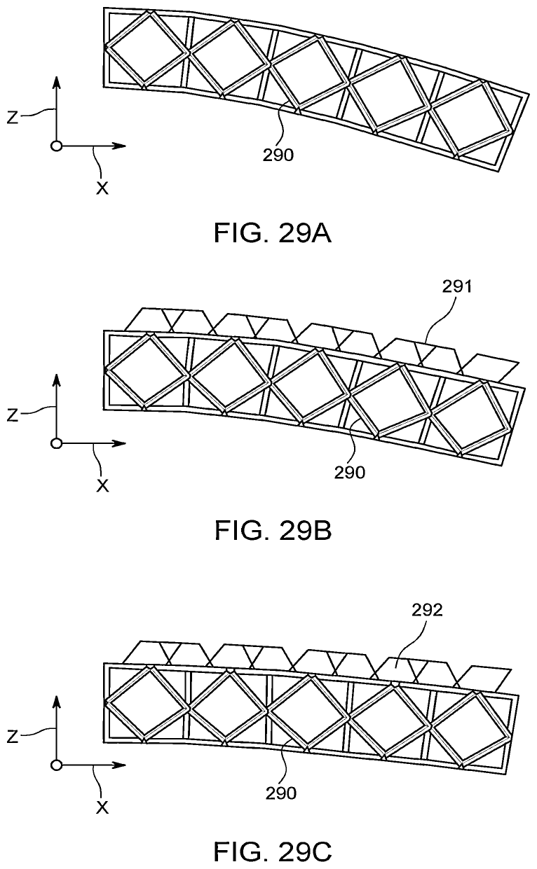

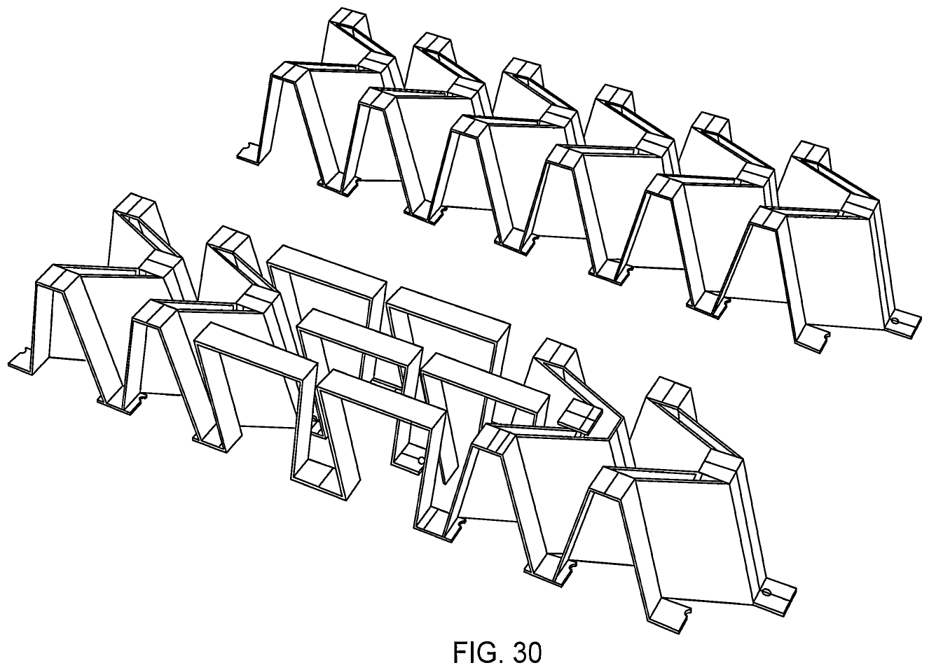

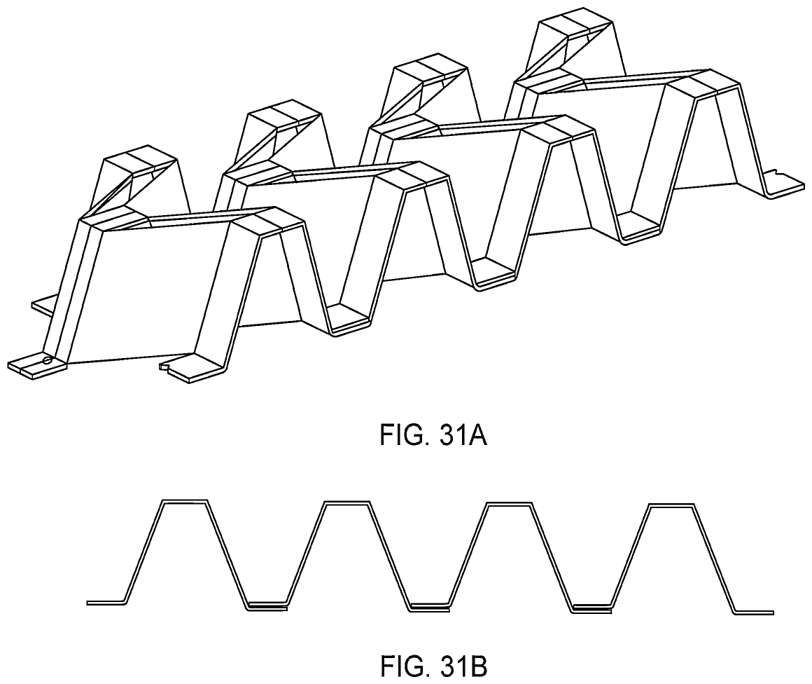

The first one, as FIG. 28 shows, is to add a longitudinal hinge 280 in the Miura facet, parallel to the corrugation. This provides the pattern with an extra strain capacity along the fold. FIGS. 29A-29C show deflections for the same beam 290 with the two different modified Miura patterns 291, 292. It can be seen how the extra hinge decreases the bending stiffness of the pattern.

For more extreme cases in which full freedom of rotation is wanted while maintaining shape, the Miura corrugations 223 can be fully removed. In section 3, it can be seen that this approach was used to build the morphing wing. FIG. 30 shows how seems a design with stiff (upper image) and bend (lower image) facets.

2.6 From Continuum to Discretely Assembled Origami

As it was described previously, folding origami tends to be a parallel process. This effect has been very predominant when milling large folding cores with this new material. In order to solve that, it was decided to experiment with a concept using discretely assembled origami. Taking the same premise cellular structures started to be discretized, what is proposed in the present disclosure is a method to construct discretely assembled cellular origami structures as it could solve industrialization issues of large continuum folds.

Taking the simplest repetitive molecule that creates the fold, an algorithm has been designed that generates instead of continuum rows of cells, individual cells.

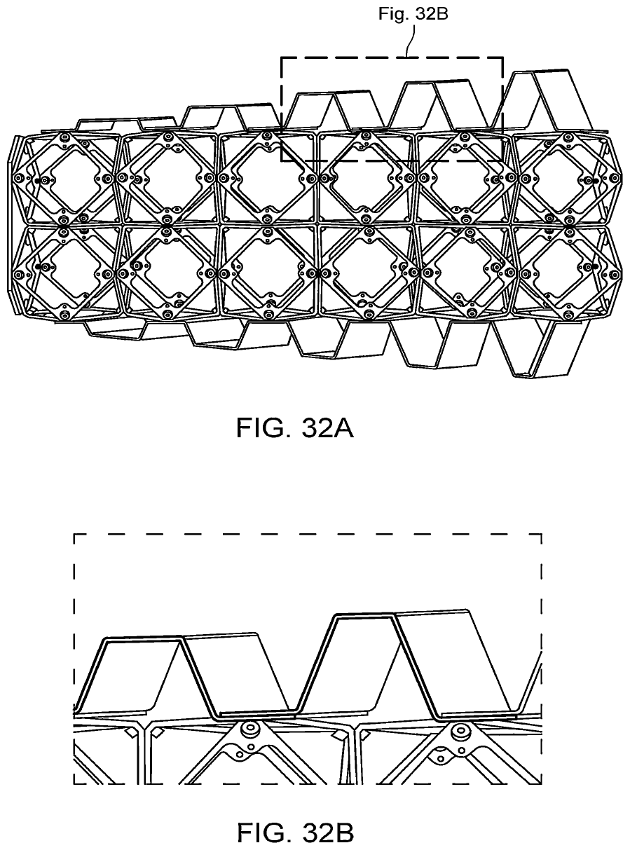

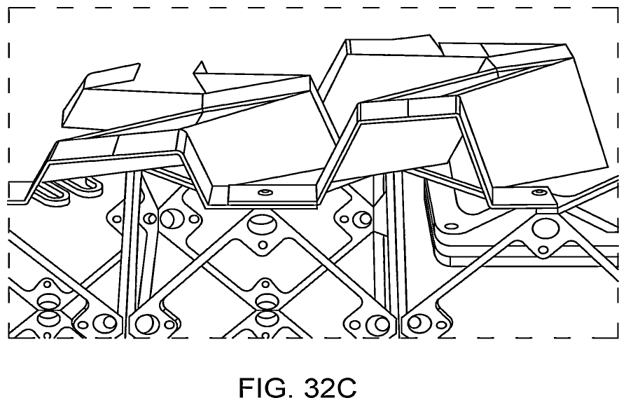

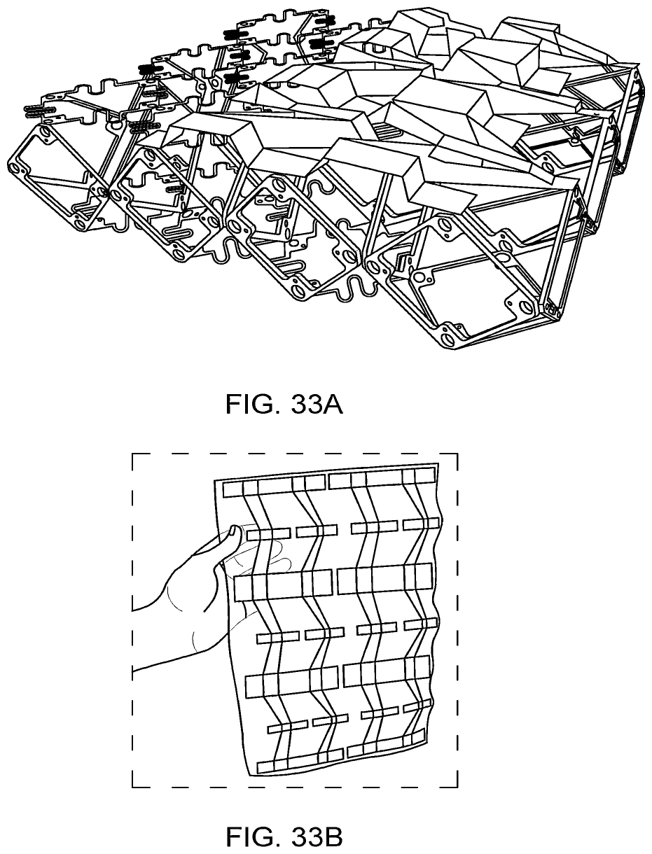

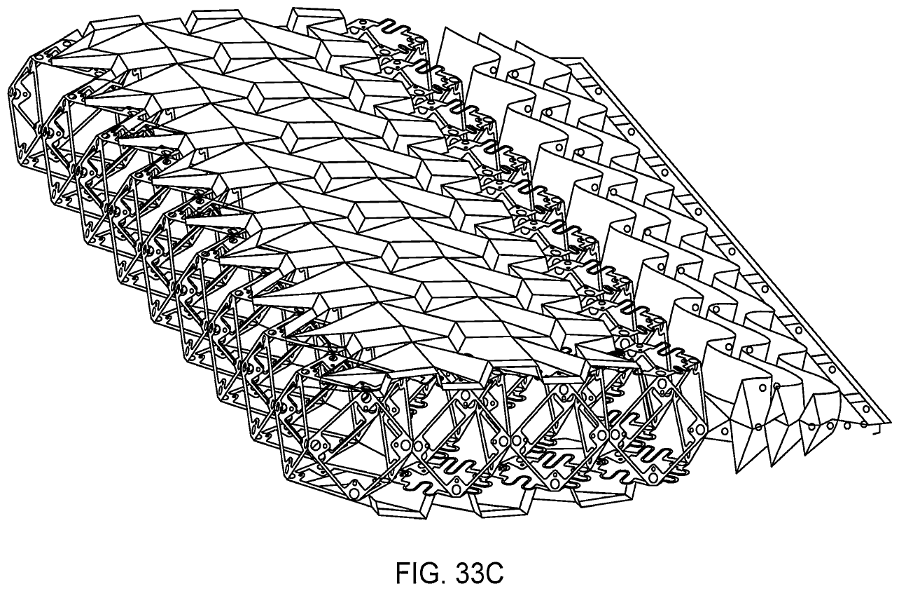

As an example of this method, a new version of the wing shown in FIGS. 34A-34D was developed using this discretized strategy as shown FIGS. 32A-32C.

2.7 Manufacturing

First, this project chose to work with encapsulated carbon fiber in Kapton tape. This method was selected because it allows to cut prepreg sheets, encapsulate them in Kapton tape, cure it and fold it. But the complex geometries and all the needed holes made the process tedious and hard for industrialization.

Second, this project used metal folding (e.g., see FIGS. 34A-34D). Aluminum sheets of 0.5 mm cut in a metal laser cutter was a much faster method than the previously shown. It is needed to post-process some of the rhino workflow to generate desirable dash lines to prevent them from cracking when folding.

Folding sheets of metal by laser-cutting tiny dash lines, especially aluminum, can be a problematic process as we can easily overstrain locally in the hinge line cross-section. Laser-cut dashed lines generate such a small radius of bending that causes a local big relative strain of the material in the hinge line. The metal can enter the plastic zone regime at the hinges and that can be problematic as its properties to resist fatigue decrease. It was needed a hack for this issue.

To do so, the inventor of the present invention found an aluminum composite called Hylite® by the manufacturer 3A. It is a sandwich material composed of a polypropylene core of 0.8 mm encapsulated by two layers of 0.2 mm of aluminum. This lightweight composite material preserves the elastic modulus of aluminum (70 GPa) but only weighs one-third of the same thickness out of the aluminum.

To fold this composite, a 2 faces engraving process was made milling on each side of the sheet the corresponding peaks or valleys. To manufacture a hinge on a continuum way, the engraving process removes material decreasing locally the bending stiffness and as a result, the material will always want to bend through that area. The benefits of having a thermoplastic as a core are that by milling the top aluminum layer and partially the core, increasing the temperature of the milled piece to the polypropylene glass transition temperature will let us fold it without damaging the core. Once folded, the temperature will cold down, being now at its new position. This thermoplastic core will also help to design specific radii of bending.

### 3. Applications

In this section, the described and characterized mechanical metamaterial construction kit is shown how to use to develop discrete continuum robots emphasizing their hydrodynamic behavior, simple design workflow, and manufacturing benefits. The present disclosure found great interest in aero/hydrodynamics usage of this type of robotic structures as their controlled continuum deformation mimics how nature provides more efficient solutions to generate propulsion or lift. A 1-dimensional robot (morphing beam) and a 2-dimensional robot (morphing surface) serve as examples. For each example, this section will describe the design, manufacturing, control, simulations, and water tank testing.

The first showcase is a Hydrosnake robot, a large aspect ratio (1500 mm length and 75 by 75 mm cross-section) discrete beam composed of 4 individual sections serially actuated. This bio-inspired swimming device serves as a platform to show an economical large-scale soft continuum robot with minimal DOF and unique parts.

The second showcase is a camber morphing wing. Alternative methods to maximize the lift-to-drag ratio (L/D) on wings are a high-interest topic in academia. New materials enable alternative bio-inspired strategies to control active lifting surfaces. This second example proposes a non-monolithic solution to generate camber morphing over a 675 mm span wing discretely assembled. Its L/D results are compared with a classic configuration wing to quantify its hydrodynamic benefits.

3.1 Hydrosnake

3.1.1 Motivation

Unlike traditional engineering solutions for underwater transportation, organism means of locomotion heavily relies on compliant mechanical structures to elegantly overcome environmental constraints very efficiently. As an example, vortical wakes resulting from flow separation affect any submerged body with a certain velocity. For human-engineered creations, this impacts its pressure drag causing a loss of efficiency. On the other hand, fish resonate their flexible body with it and extract energy from those vortices to generate thrust from their own drag.

Replicating this nature-like using a rigid body engineering perspective would generate a hyper redundant complex design. As an example, one of the biggest successes in this premise, RoboTuna, able to replicate swimming physics helping to solve Gray's paradox, was composed of over 3000 unique pieces that collectively interact. Another type of approach to solve this challenge as continuum robotics or soft robotics can be very size/scale-dependent and generate a 1500 mm length robot is a state-of-the-art challenge. Soft robots primarily use elastomeric materials and suffer from scale because the high density of the used rubbers would difficult to hold their own weight [28] [42]. On the other hand, continuum robotics scale problems reside on the complexity of the structures.[7].

This first application shows a novel approach to easily scale up continuum soft robots by combining two unique injection molded parts. The system is able to easily attach discrete serial actuation generating a one-dimensional beam snake-like robot capable to replicate bio-inspired swimming motion. The design, manufacturing process, control, experiments, and results of the tow tank campaign test are shown.

3.1.2 Design

As shown in section 1 of the present disclosure, it was taken as a repeatable segment a beam composed of 5 voxels. A stiff cell followed by four bending heterogeneous voxels.

The voxel pitch is 75 mm, its cross-section is 2.1 mm by 2.1 mm. We attached 4 segments in serial resulting in a robot of 1500 mm in length. The mechanical characteristics of this construction can be seen in section 1.

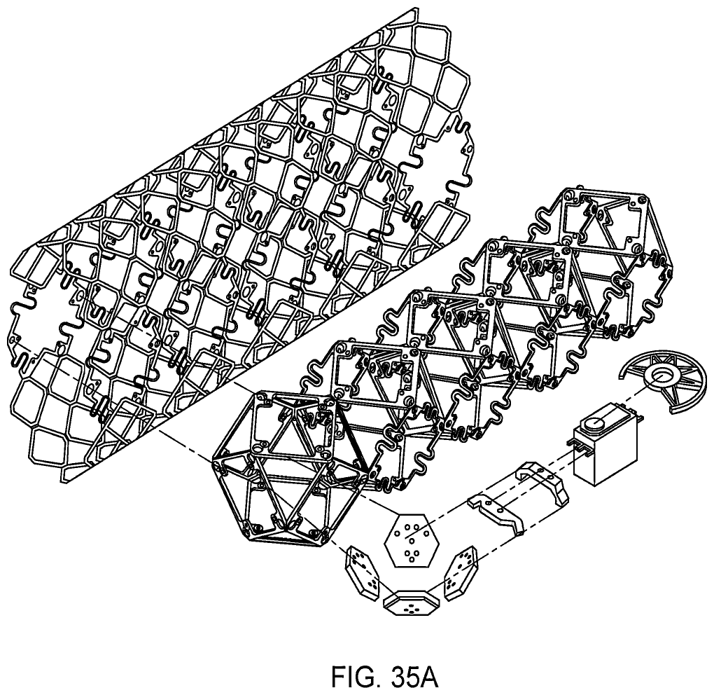

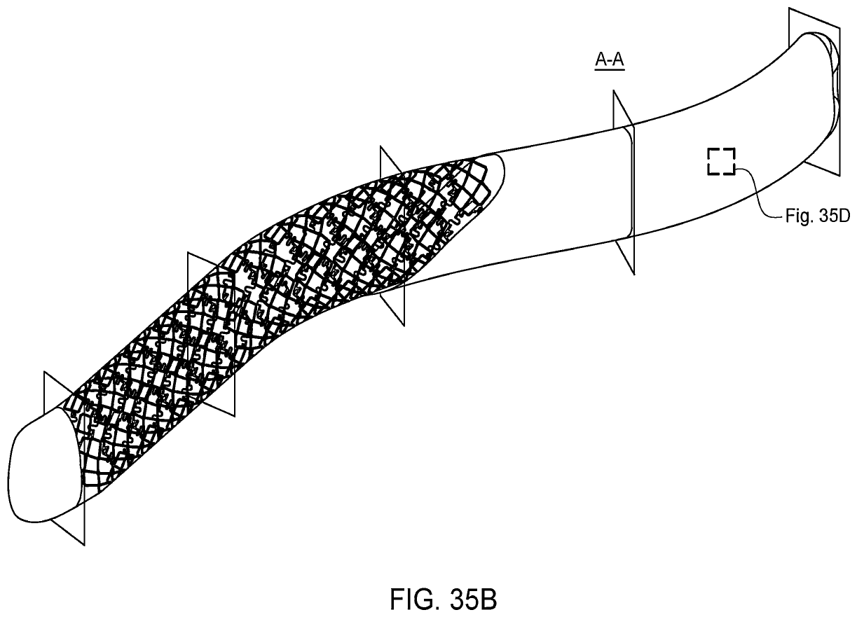

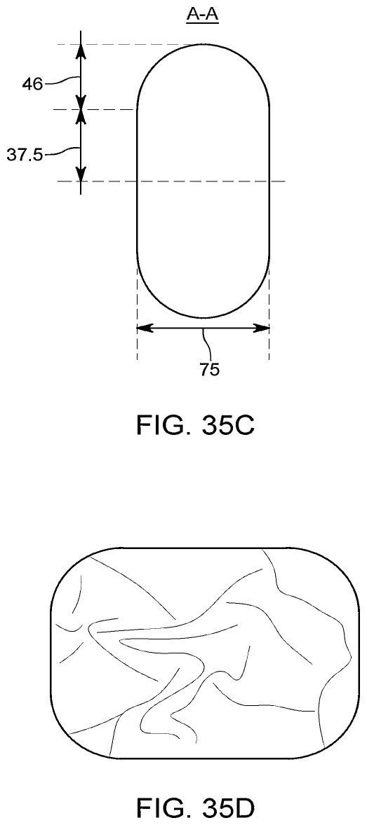

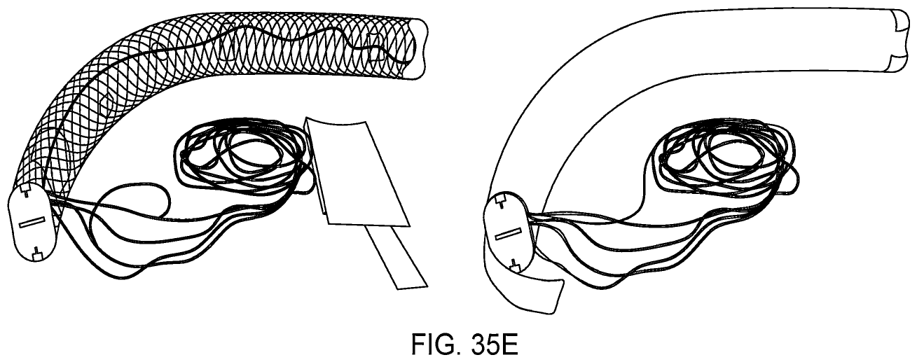

Subsystems were needed to make a snake-like cross-section capable of generating thrust while swimming. Skinning the snake is a key point of the project as having a smooth tangent surface without fabric wrinkles is key to drop down from drag. It was achieved by making a hierarchical overlapping rib system using 1/32″ thickness laser cut Delrin® sheets and riveted to the morphing beam module as it can be seen in FIGS. 35A-35E.

The fabric used for the outer skin is composed 94% of polyester and 6% spandex. The system is built by assembling the voxels, implementing servos and tendons, riveting the skin and sliding the built skeleton inside the elastic skin.

3.1.3 Control

The target was to replicate the swimming shapes that a fish body generates as a continuous system. There is research work on describing mathematically the kinematics and dynamics of traveling-wave-like propulsion systems of anguilliform swim strategies [26].

$$y ( x , t ) = \frac{{A}_{t}}{1 - {e}^{α L}} ( 1 - {e}^{- α x} ) sin ( \frac{2 π}{λ} x - 2 π ft )$$

Where y(x, t) is the y coordinate position as a function of x and the current time. L corresponds to the length of the robot (1.5 m), Aₜ is the amplitude of the tail motion. We choose it to be a relation of the length, iterating from 0.15 L to 0.35 L. At the tow tank, we decided to test from 0.15 Hz to 0.25 Hz. Finally, α controls the conical shape in which the amplitude grows from the leading edge to the trailing edge of the robot. The tested value corresponds with α=1.5.

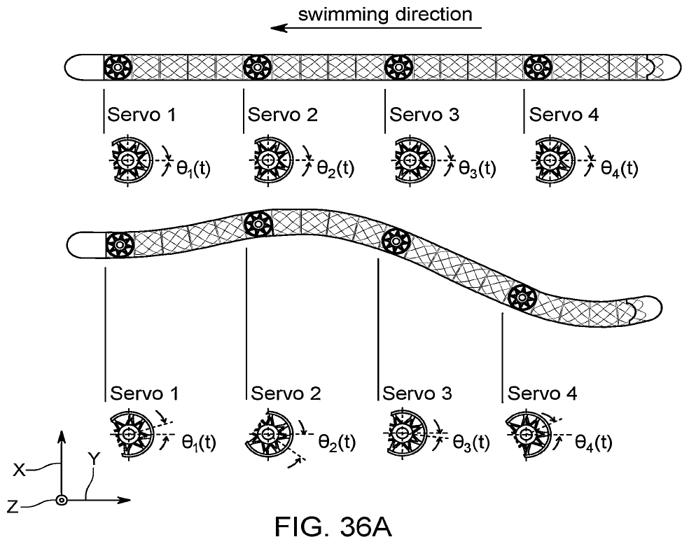

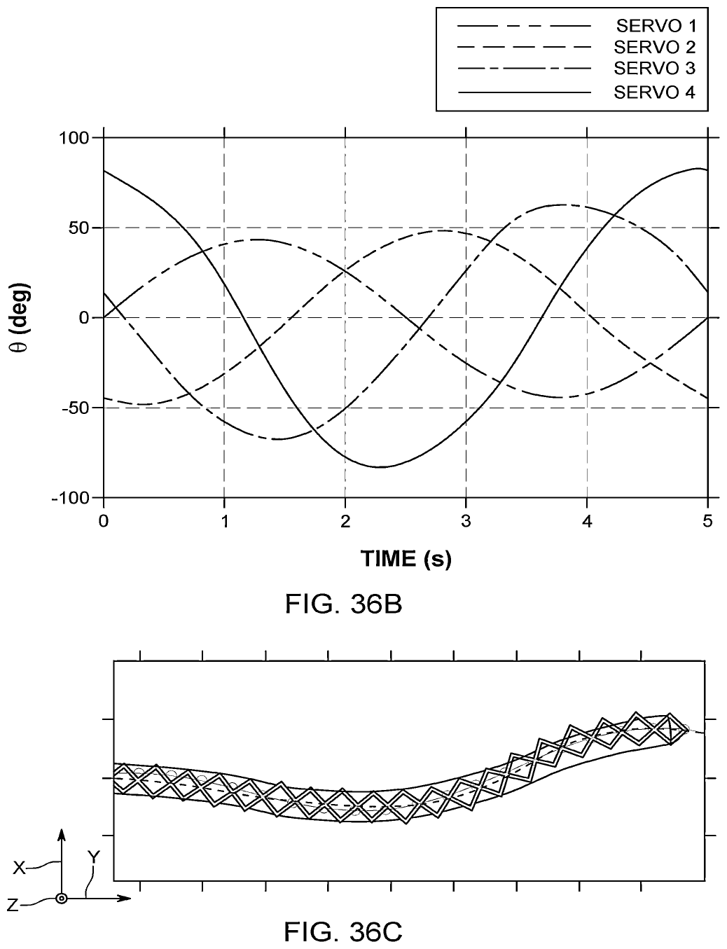

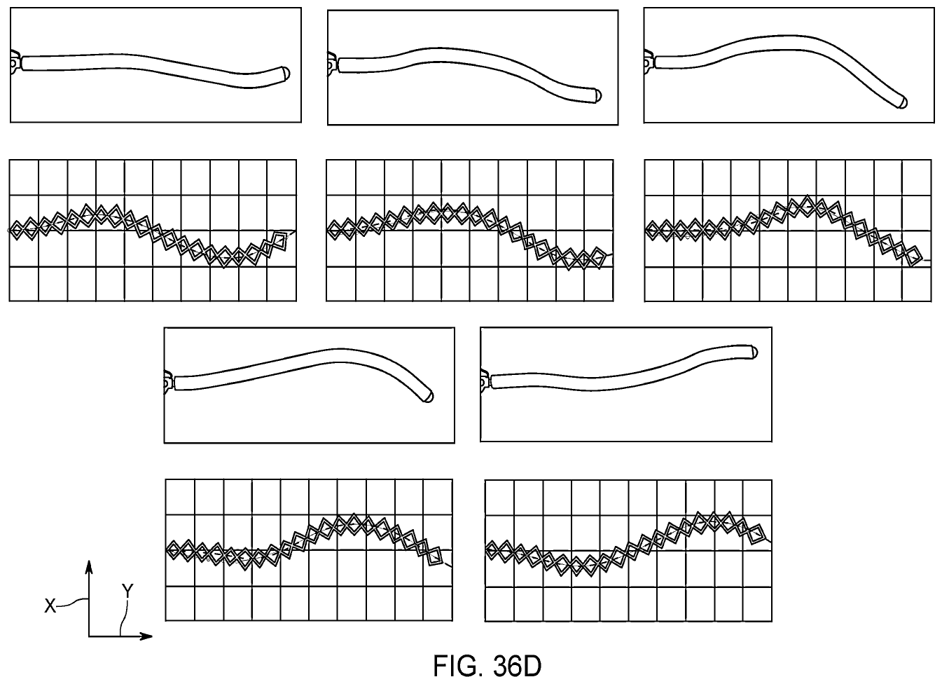

With 4 continuum radius sections, an acceptable accuracy on the ideal traveling-wave spline was able to be matched, as it can be seen in FIGS. 36A-36D.

3.1.4 Results

Tow Tank Setup

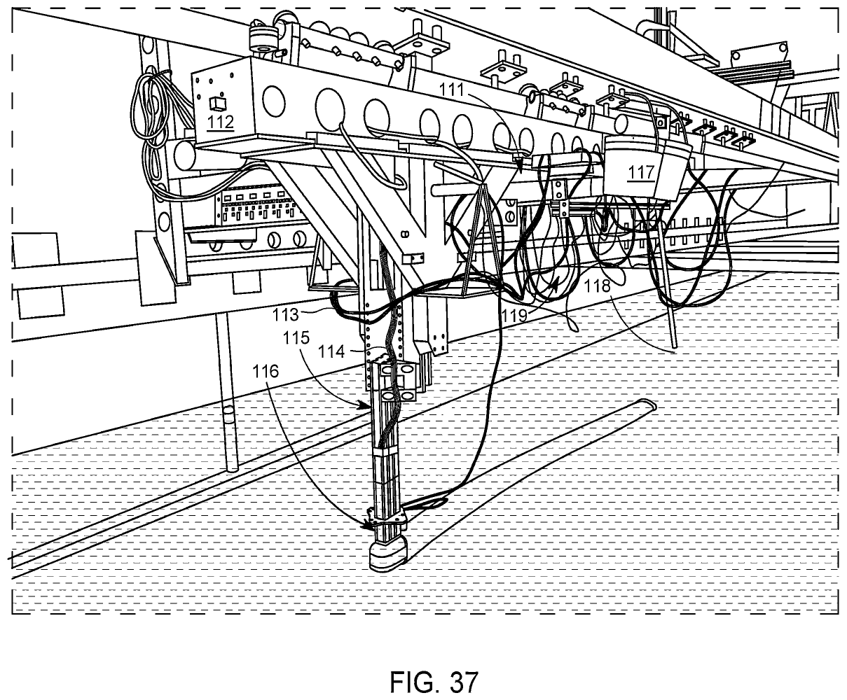

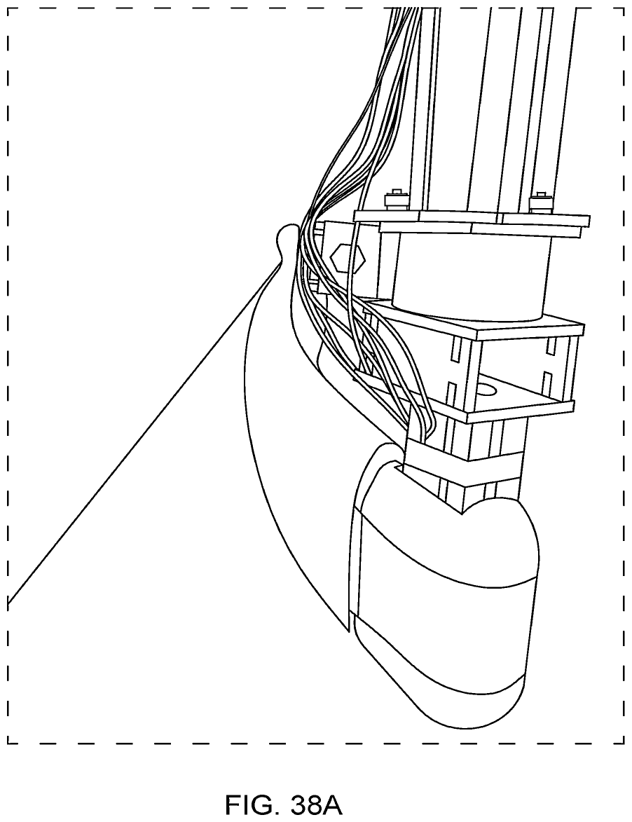

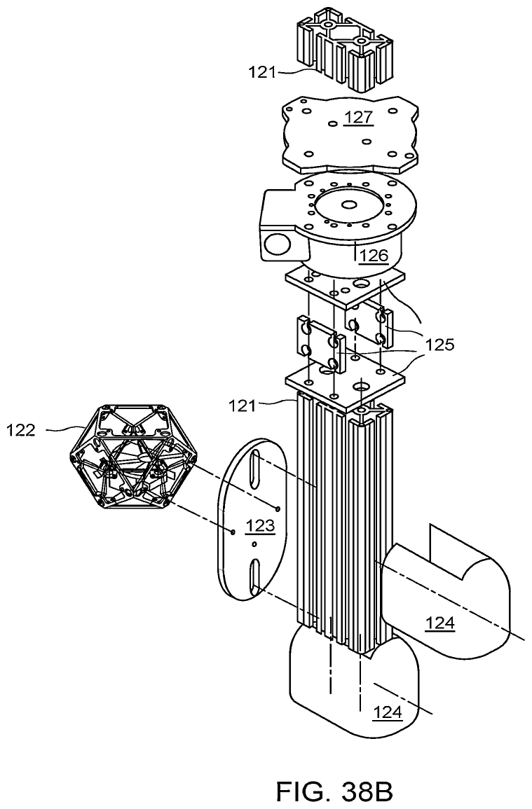

The hydrodynamics of the bio-inspired discrete cellular soft robot were tested at the MIT Towing Tank facility, which features a 33.3 m×2.67 m×1.33 m testing tank section and a belt-driven carriage able to achieve steady linear motion at speeds from U=0.05 m/s to 2.3 m/s. The robot is connected to an ATI underwater gamma load cell (Item 116 in FIG. 37) that is linked to an 8020 aluminum strut (Item 115 in FIG. 38B, and the size of its cross-section is 7.62 cm×3.81 cm) and then is mounted at the front of the carriage (Item 112 in FIG. 37) as shown in FIG. 37. The power, control, and data acquisition system (Item 111 in FIG. 37) includes an Arduino® Mega microcontroller for robot motion control, an ATI gamma load cell amplifier and NI USB-6218 data acquisition (DAQ) system for force measurement, a power supply and a Dell® computer for data logging via LabVIEW®, mounted on top of the towing carriage and remotely accessed during the experiment. In addition, three 1500 lumen underwater lights (Item 118 in FIG. 37) are placed in the 1.5 m back from the tail of the model, providing sufficiently strong background lighting for the camera (Item 119 in FIG. 37) to capture the robot motion in the water as well as the wake pattern visualized by the dye injection system (Item 117 in FIG. 37). Note that to avoid model sagging and excessive torque on the load cell due to the robot weight, distributed buoyancy modules are inserted inside the voxel, making the robot neutrally buoyant. Thanks to the small size and location of the buoyancy modules, their existence has minimal effects on the dynamics or hydrodynamics of the robot during the experiment. Other items include: Power lines from fuses to servos (Item 113 in FIG. 37), signal lines from microcontroller to servos (Item 114 in FIG. 37) and a snake-carrier fitting (Item 115 in FIG. 37).

Tank Results

The model was towed at a constant speed U of 0.1 m/s but iterating over λ and α values. The ATI gamma load cell measured the force at a sampling rate of 1000 Hz. The end goal was to prove thrust generation and to do so, we measured non-dimensional thrust coefficient Cₜ defined as:

$${C}_{t} = \frac{{F}_{x}}{0.5 ρ {U}^{2} {S}_{w}}$$

Where Fₓ is the average force in the towed direction from tail to head, ρ is the water density, and S_{w} is the wet surface of the robot with a value of 0.6138 m².

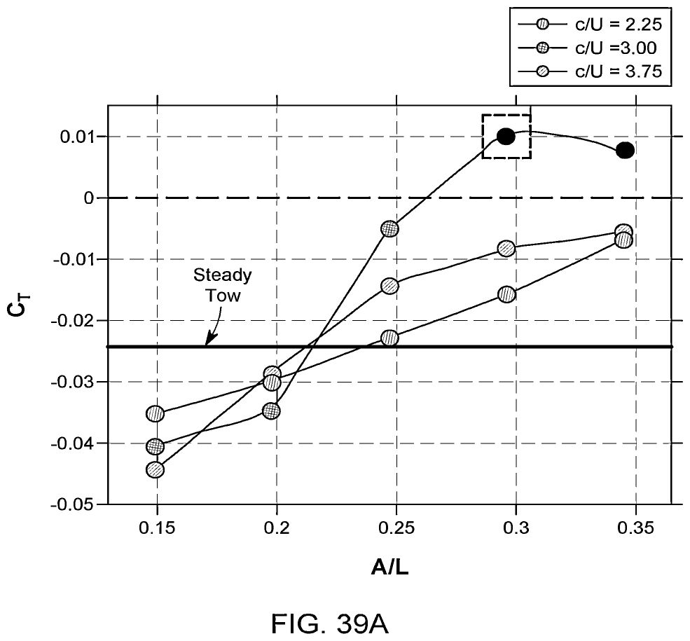

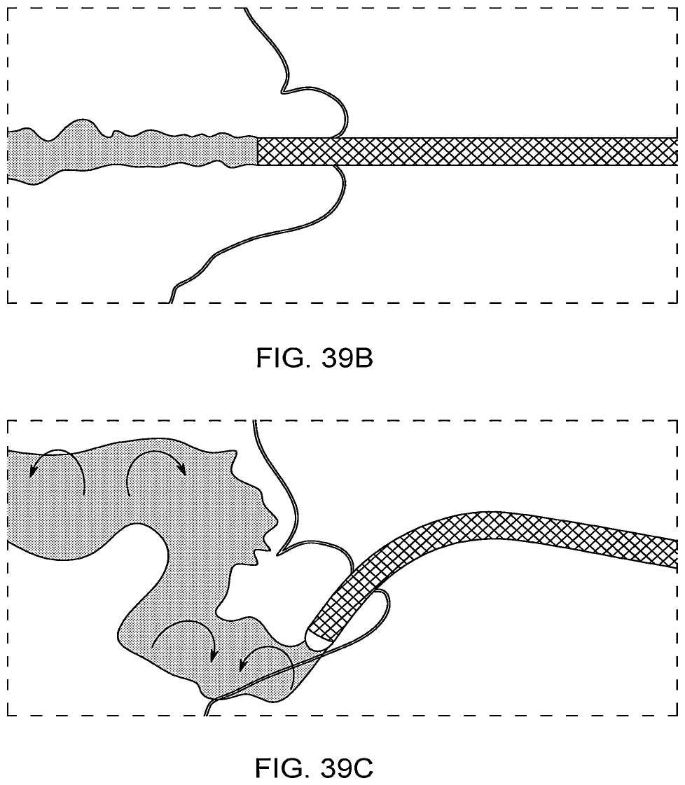

The thrust coefficient C_{T} of the robot being towed at U=0.1 m/s (Reynolds number Re=(UL/v)=150, 000 where v is the kinematic viscosity of the water) is plotted in FIG. 39A. The thrust coefficient of the unactuated robot is C_{T}=−0.0248 (highlighted as the solid horizontal line in FIG. 39A). At a fixed λ=L, C_{T} increase with tail amplitude.

As it can be seen in FIG. 39A, with values of NL higher than 0.25 the dynamic traveling wave decreases the overall drag of the robot, being able to generate thrust for values of NL higher than 0.3.

FIG. 39A shows the thrust coefficient Cₜ versus commanded NL for various c/U (λ=L=1.5 m). FIG. 39B shows the wake pattern of the unactuated robot, represented by the in black solid line in FIG. 39A. FIG. 39C illustrates the wake pattern of the actuated robot with c/U=3, Aₜ=0.3 L=0.45 m and λ=L=1.5 m, highlighted by the in dotted box in FIG. 39A. Negative Cₜ (all dots besides two upper right corner dots in FIG. 39A) are the average drag force on the robot, while positive Cₜ (two upper right corner dots in FIG. 39A) indicates the average thrust force produced by the robot.

3.2 Camber Morphing Wing

3.2.1 Motivation

The need for control surfaces with a smooth and continuum deformation was known since the Wright Brothers took inspiration from birds to build the first heavier-than-air powered aircraft. They implemented a warping morphing wing (continuum change of the angle of attack along the span) to achieve lateral stability the same way birds do. The Flyer 1 was mainly built of wood and dry fabrics actuated by steel tendons [37].

As aviation advanced, engineers and designers realized that increasing the power of the engine would help to maximize the trade-off between payload, endurance, and range. That resulted in the need of using very stiff and, where possible, light materials as loads become inaccessible for wood and dry fabrics [45].

The tendency keeps until nowadays where almost any aeronautical structure is a redundant rigid body design comprising links and rotations. The present disclosure studies as a base technology in which bio-inspired wing designs could overcome the technical difficulties that monolithic rigid configurations are currently facing. This second application shows a wing design build upon an ultra-light discrete lattice with controlled mechanical anisotropies in which a camber morphing is used with two purposes:
1.—became a different member of the airfoil family in different flight regime. That is break its intrinsic symmetry.
2.—use the morphing as an elevator/aileron for flight stability/control.

Optimizing the performance of flight control surfaces is a crowded research question and morphing is an attractive solution. Flight conditions change constantly and ideally, wing shapes should do the same, adapting to behave optimally for those different regimes. Cruise conditions, maneuvering, slow-speed approach conditions require drastically different morphologies. Offering a system able to morph accordingly while holding loads could help to improve aviation's environmental performance, saving billions of fuel gallons yearly and reducing millions of CO₂ tons [30].

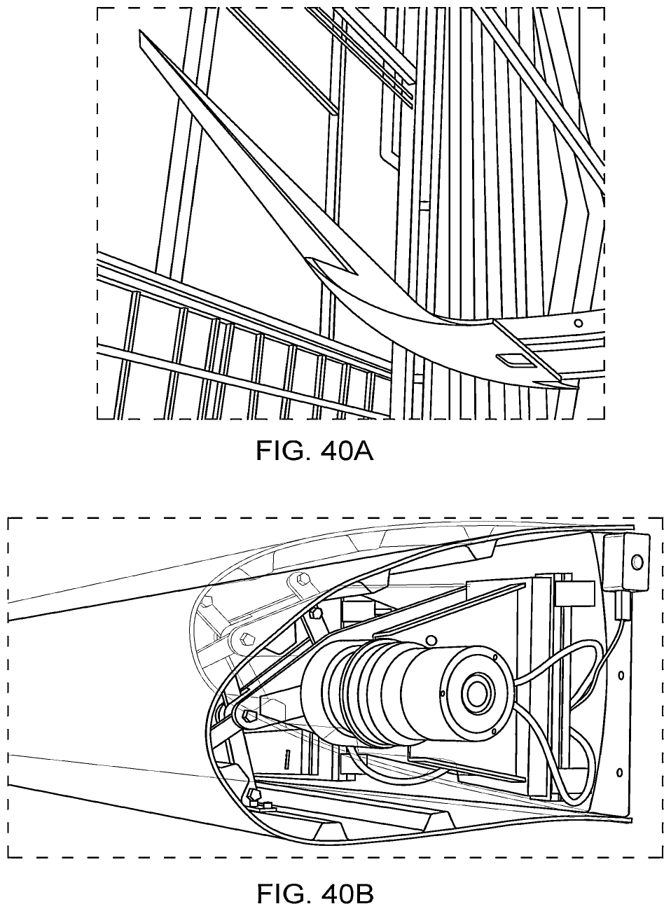

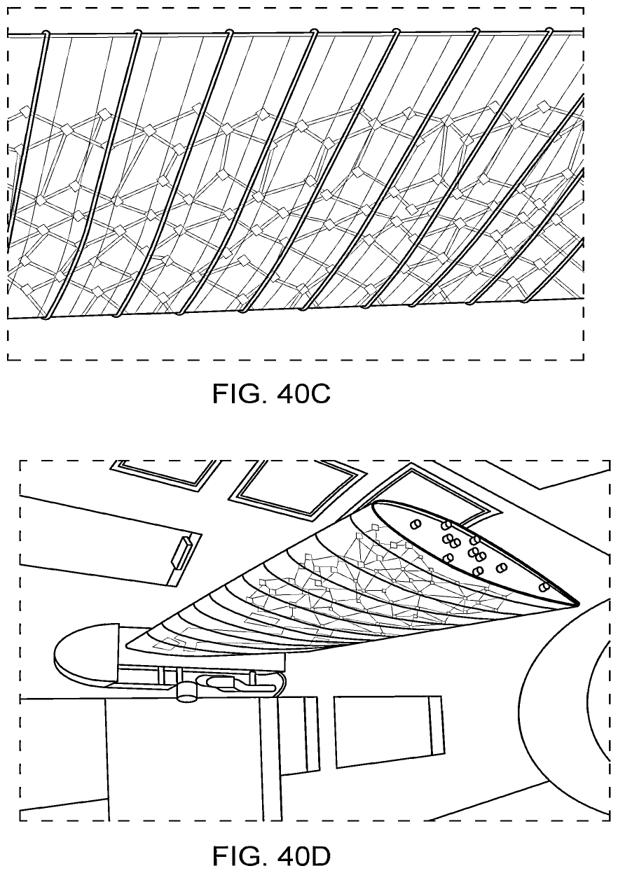

As exemplified in FIGS. 40A-40D, different morphing strategies for flight control surfaces have been offered as the Morphing Winglet by the European consortium Clean Sky [44] [12]. But their approach only focused on morphing with classic mechanical assemblies the wingtip for end-vortex reduction.

The German aerospace center DLR offered a full research roadmap on adaptive wing technologies. Their more interesting proposal was an actively actuated leading edge, being able to find drag reductions for angles of attack between 5 and −5 degrees [43]. There still be a challenge for this technology to propose control surfaces.

A digital wing by the CBA was researched offering a lattice-based structure able to perform spanwise twist deformations. They used an inspired Kelvin lattice shape to generate a torsion box compliant on its twist along the span, controlled by a single DOF. This approach maintains the same airfoil cross-section and has a high interest for stability purposes but not for control or flight optimization.

In this subsection of section 3, a different approach to build and provide an out-of-plane morphing of a torsion box is revisited. Instead of proposing a light design with maximum bending stiffness at its cross-section along the span, a heterogeneous lattice surface is used to build a camber morphing wing. The lift-to-drag ratio that is achieved by actuating the camber line of an airfoil is simulated and tested and compared with a classical rotation along its aerodynamic center. To show its performance compared to a classic wing configuration, a semi-monocoque rigid wing is built out of a custom modified Eppler profile and tested at the Sea Grant MIT Tow Tank at different angles of attack to measure aerodynamic performance. Then a twin is built out of heterogeneous digital materials able to morph and do performance tests at different angles of attack and tail deflections. L/D performances are compared, meaning, at which cost of drag a unit of lift is achieved.

This technology opens the possibility to generate wings that locally their cross-sections could become unique members of the foil family as desired in different flight regimes. Also, it can be used as a flight control surface, potentially reducing movable systems as tip-ailerons.

3.2.2 Design

While the first example shown in this section is a one-dimensional robot, similar to continuum robotics models, this second concept wants to demonstrate the dimensional addition we can easily create with this building block kit. Here we are proposing a morphable surface. We are using a heterogeneous surface by adding 9 heterogeneous beams along the span of the wing. The resultant surface will be a torsion box with a very low value of bending stiffness along the cord. That gives us the possibility of generating a camber morphing foil.

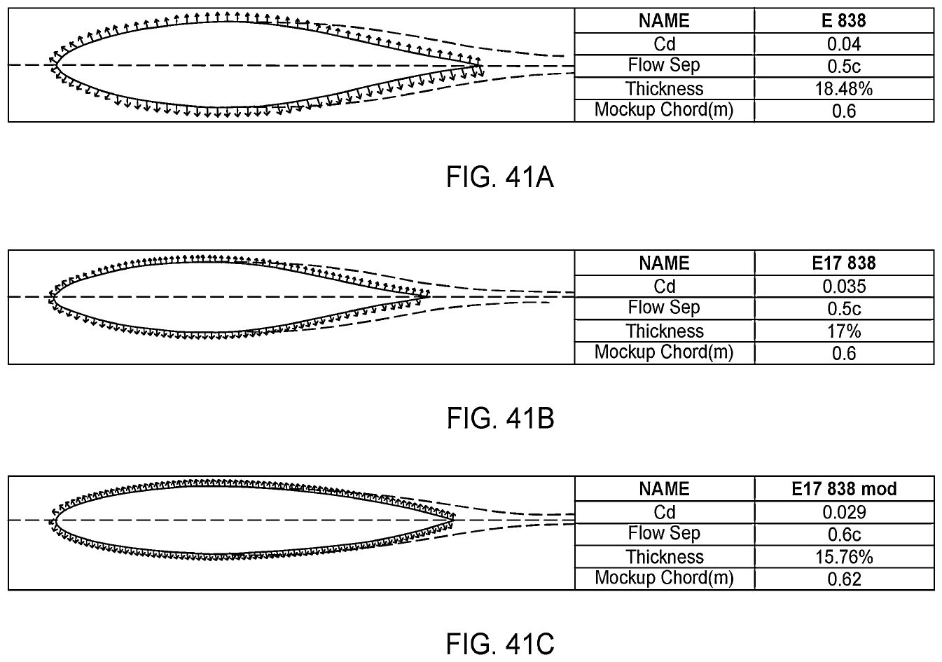

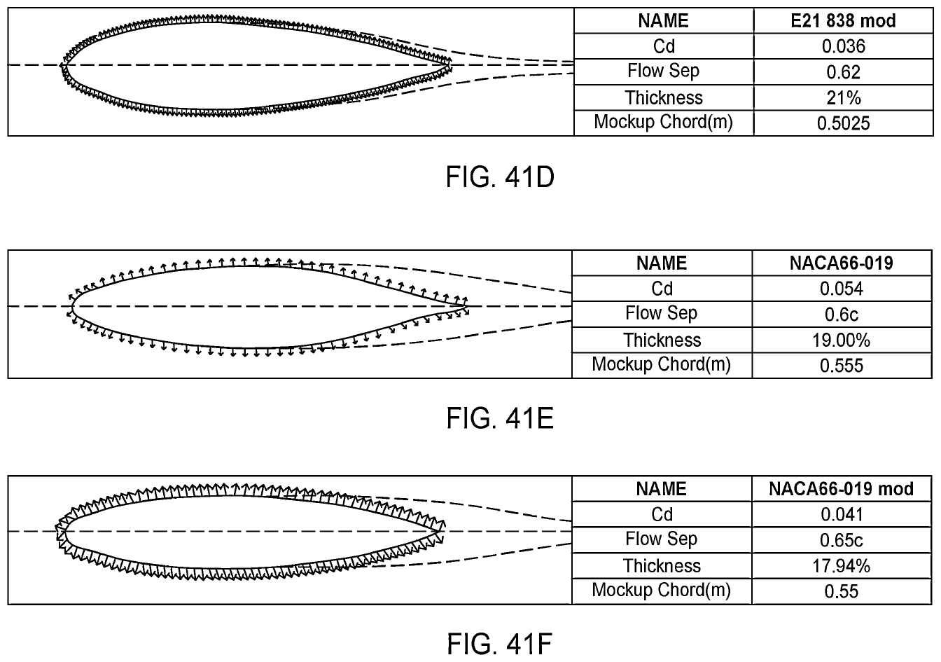

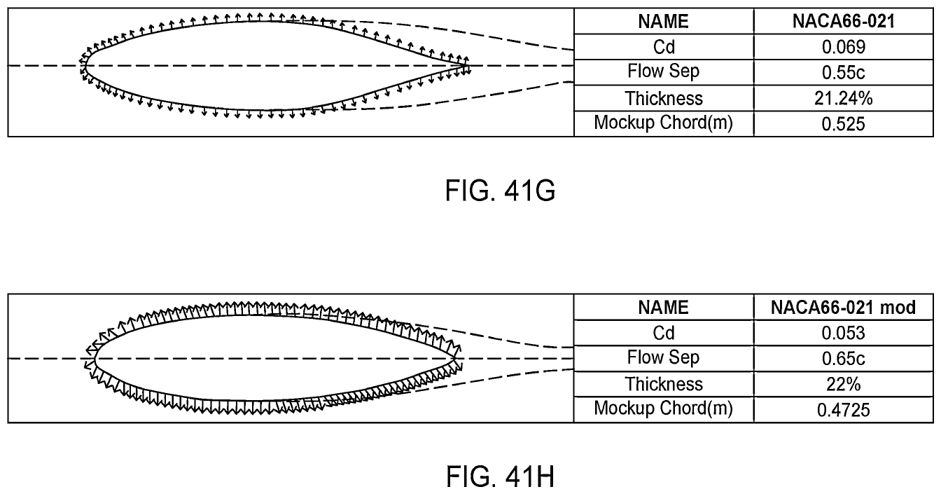

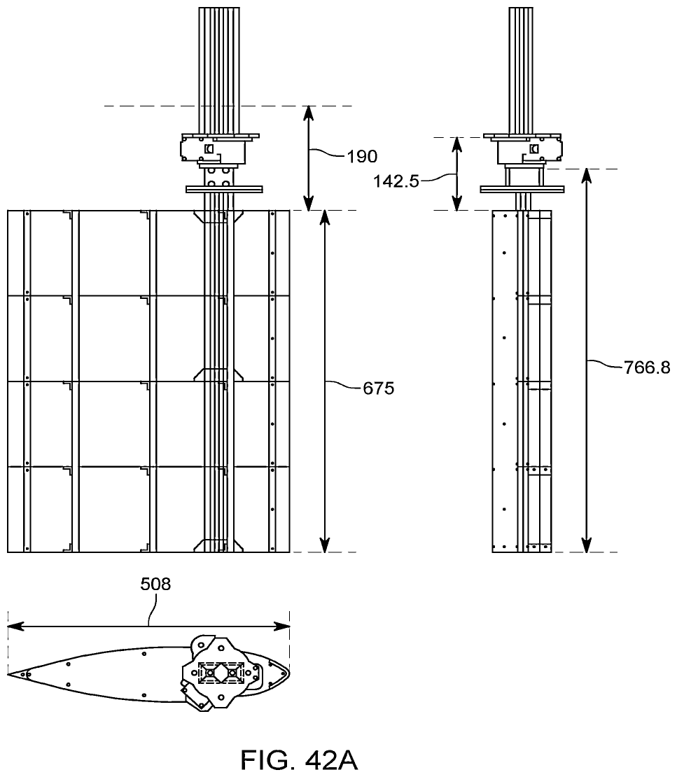

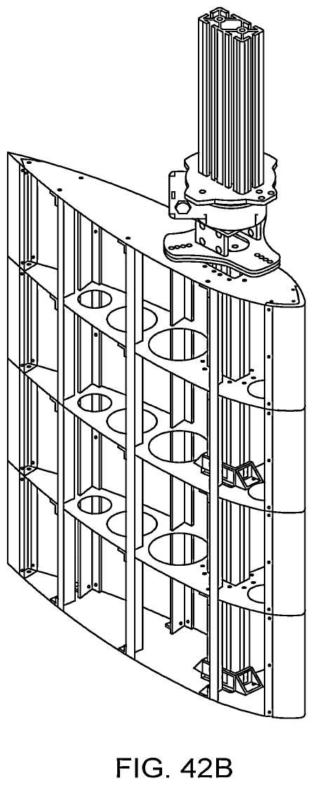

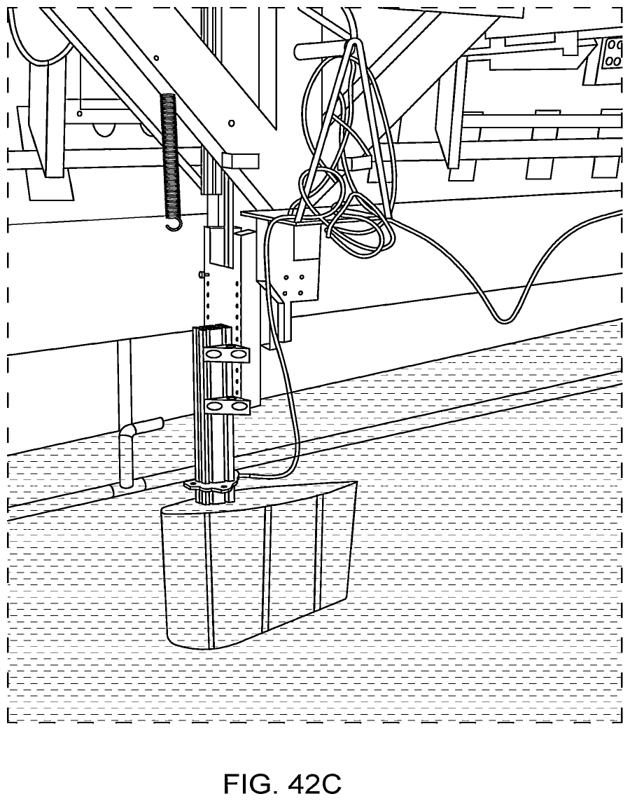

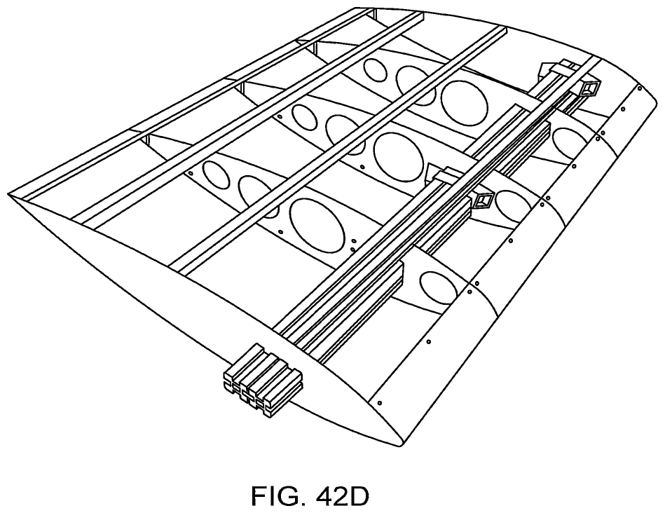

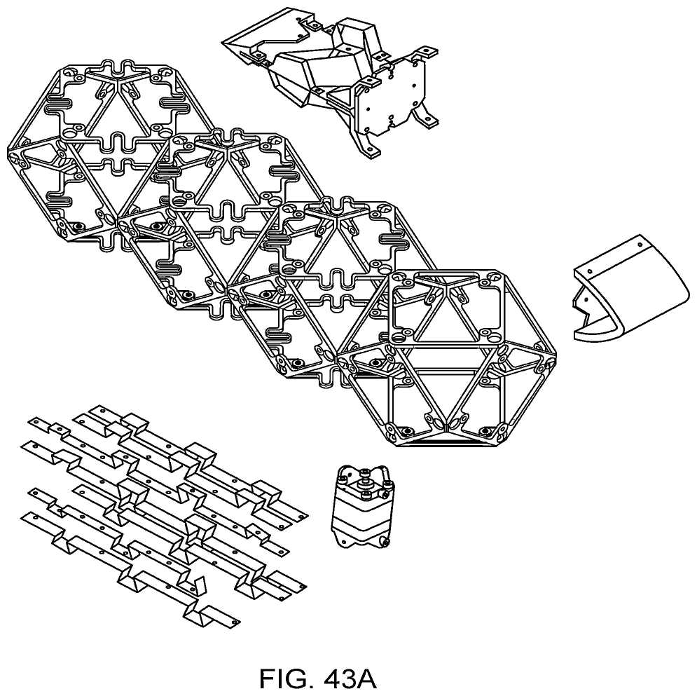

First a modification of an Eppler 838 using XFLR5 is designed, as can be seen in FIGS. 41A-41H. The thickness close to the trailing edge is increased to delay the boundary layer separation at a high angle of attack but also to make fit an array of 4 voxels inside the wing without becoming too large to test at the tow tank.

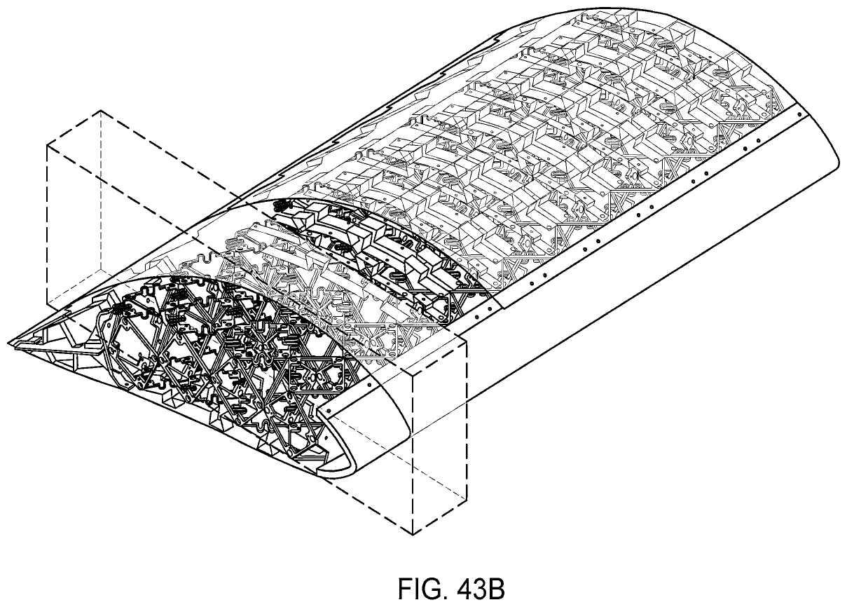

A rigid classic semi-monocoque wing started to be built using that profile. The span of it will be the corresponding with 9 layers of voxels for future comparison. Drawings for this design are shown in FIGS. 43A and 43B.

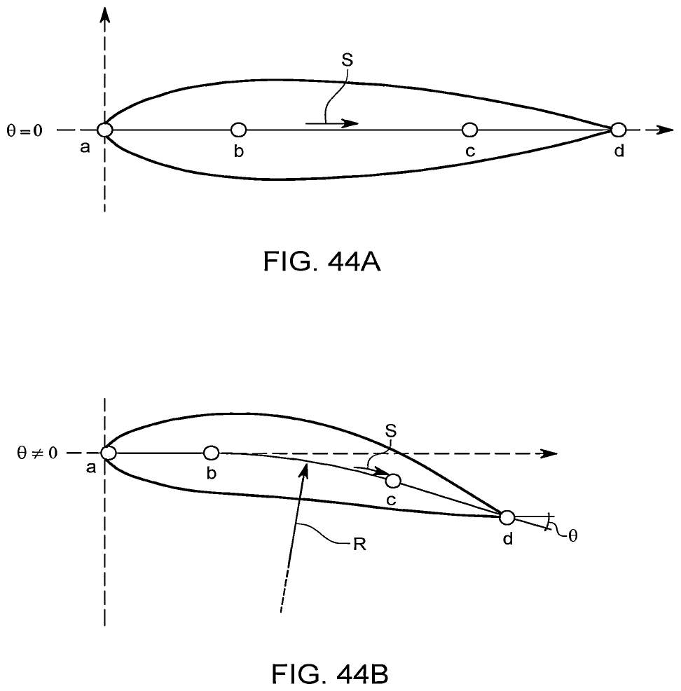

Second, the camber morphing wing started to be designed. A compliant cross-section composed of 3 main parts is proposed, as can be seen in FIGS. 44A-44B. The first section, the segment from A to B will be a rigid leading edge, where the cantilever beam is located to hold the wing to the load cell and the stepper motor embedded in a stiff voxel. A second segment from B to C in which the morph will occur. This segment is the heterogeneous lattice section. Finally, a third rigid trailing edge, from C to D, in which the dynamic pressure will reach maximum values.

The characteristic angles of this approach need to specified. On the one hand, the angle of attack α is called to the angle of rotation of the full-body around the axis of its aerodynamic center. On the other hand, tail angle θ at the one generated by morphing the wing as it can be seen in FIG. 44A-44B.

For control and simulation purposes, the equations of this centroid-based morphing were determined based on the conclusions extracted from section 1, in which constant curvature deflections for tendon actuated foams could be assumed. Given a point of the centroid pϵR² its x and y coordinates are obtained given an evaluated length s of that spline. It can be seen that those x and y coordinates will be a function of the evaluated length and the tail angle, p(s, θ). To calculate the position in any evaluated length, the following set of equations can be followed:

$$p ( s , θ ) = \{ \begin{matrix}x = s & \\ & for s ∈ [ a , b ) \\ y = 0 & \\ & \\ x = \frac{c - b}{θ} sin ( θ \frac{s - b}{c - b} ) + b & \\ & for s ∈ [ b , c ) \\ y = \frac{c - b}{θ} cos ( θ \frac{s - b}{c - b} ) - 1 & \\ & \\ x = - sin ( θ - \frac{π}{2} ) ( s - c ) + \frac{c - b}{θ} sin ( θ ) + b & \\ & for s ∈ [ c , d ] \\ y = - cos ( θ - \frac{π}{2} ) ( s - c ) + \frac{c - b}{θ} ( cos ( θ ) - 1 ) & \end{matrix} \qquad 3.1$$

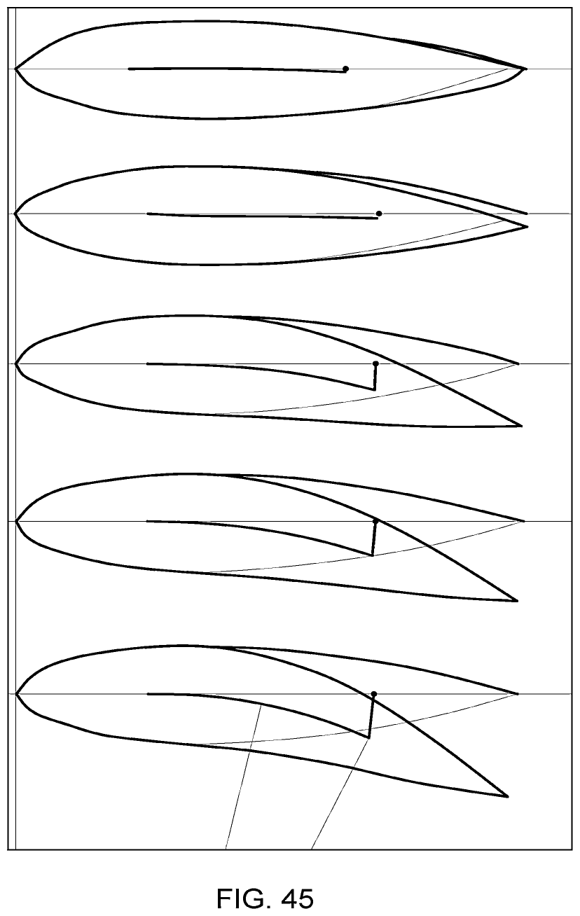

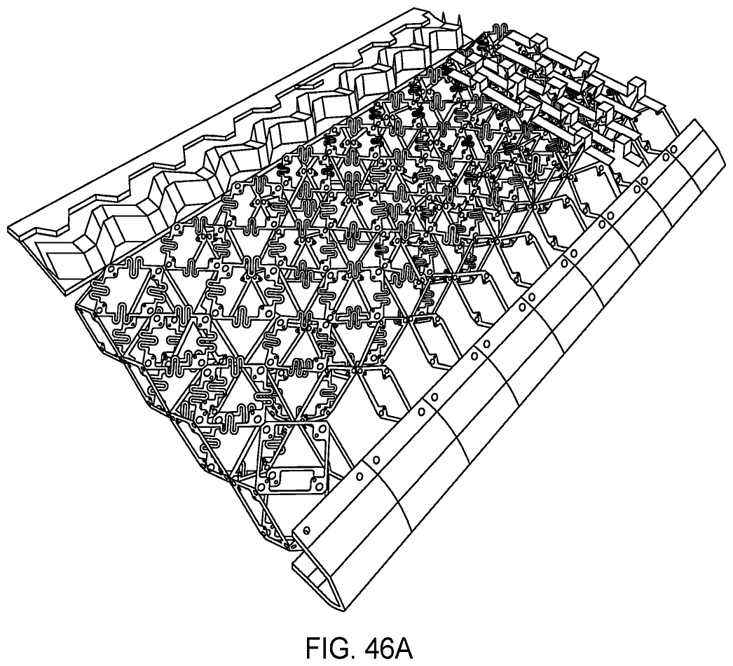

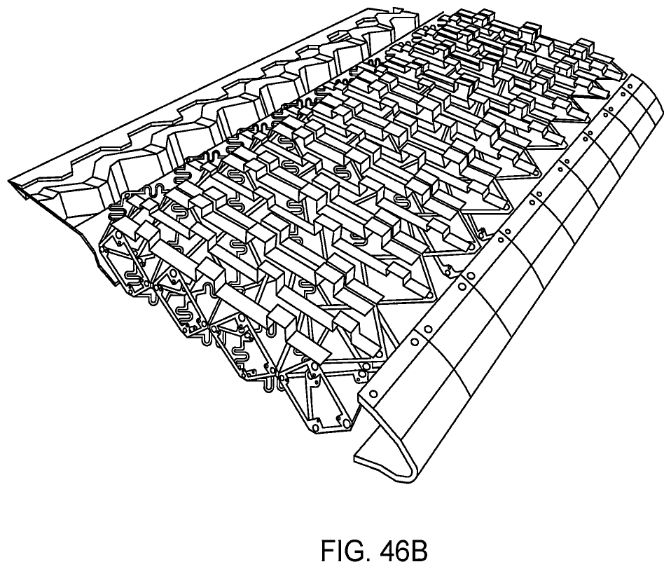

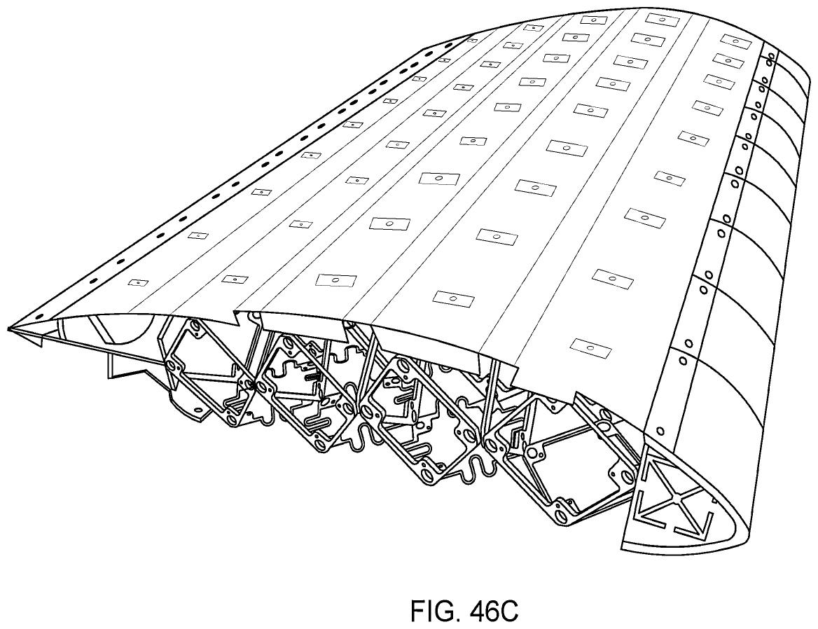

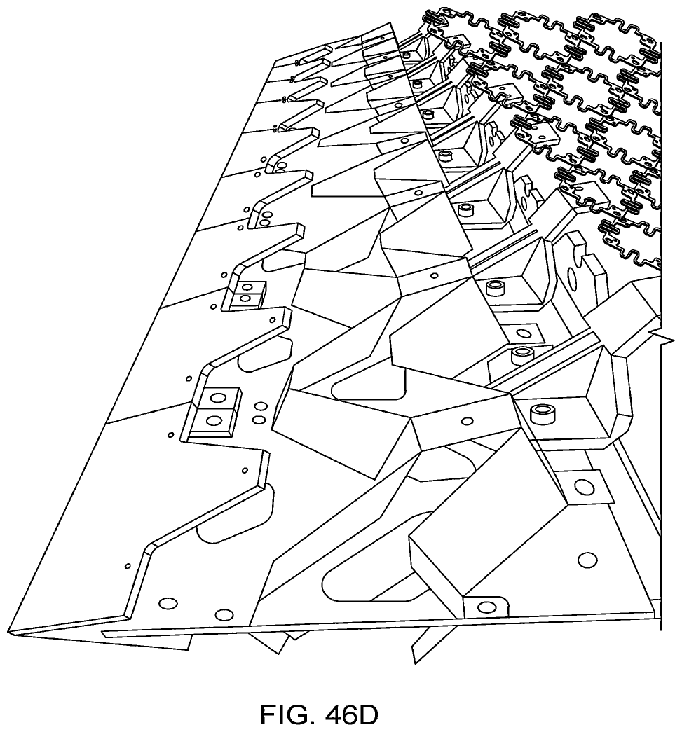

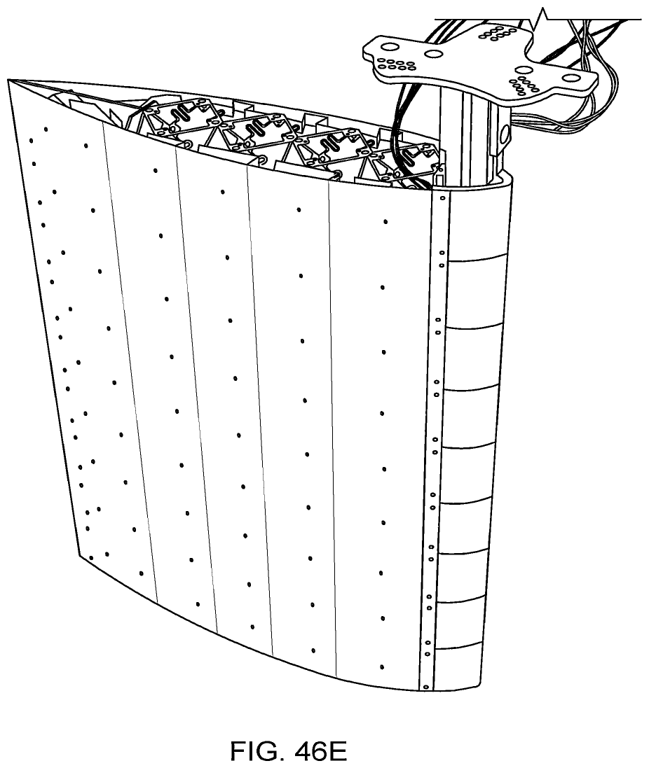

With this system any spline shape at any angle can be calculated, and tracing normals along its spline can determine the shape of the airfoil given any tail angle θ. Implementing this analytical forming in Rhino-Grasshopper we obtain the shapes shown in FIG. 45.

The adaptation to the outer mold line was done as section 2 shows. An inverted semi hexagon shape is designed for the zones in which the anisotropies need to be respected, offering structural integrity but bending compliance. For the rigid tail, a negative slope cell is used.

Pre-stressed tiles skin are designed that are able to slide between them while always working on compression on specific zones of the inverted hexagon.

3.2.3 Actuation Control

With the Hydrosnake it was learned that it is crucial to hold torque on this structure without increasing the power consumption of the actuator. Many times the servo would be stalled, resulting in burning them inside water. That is why high torque waterproof servos are changed here to stepper motors. Dual shaft Nema23 enables the possibility if placed correctly, to pull bidirectionally a heterogeneous beam. Also, they hold torque at no power consumption increase and that is ideal for this goal.

After fast XFLR5 simulations of pressure distribution at different angles of attack and tail angles, a worst-case scenario is chosen to dimensionalize the required torque for the actuation platform. The result was that with 3 stepper motors Nema23 was able to hold up to 1.3 Nm.

The stepper will be assembled inside the first layer of rigid voxels, pulling tendons to an aluminum frame that encapsulates the whole heterogeneous construction. A system to individually pre-stress the tendons was needed to guarantee that backlash won't affect the performance.

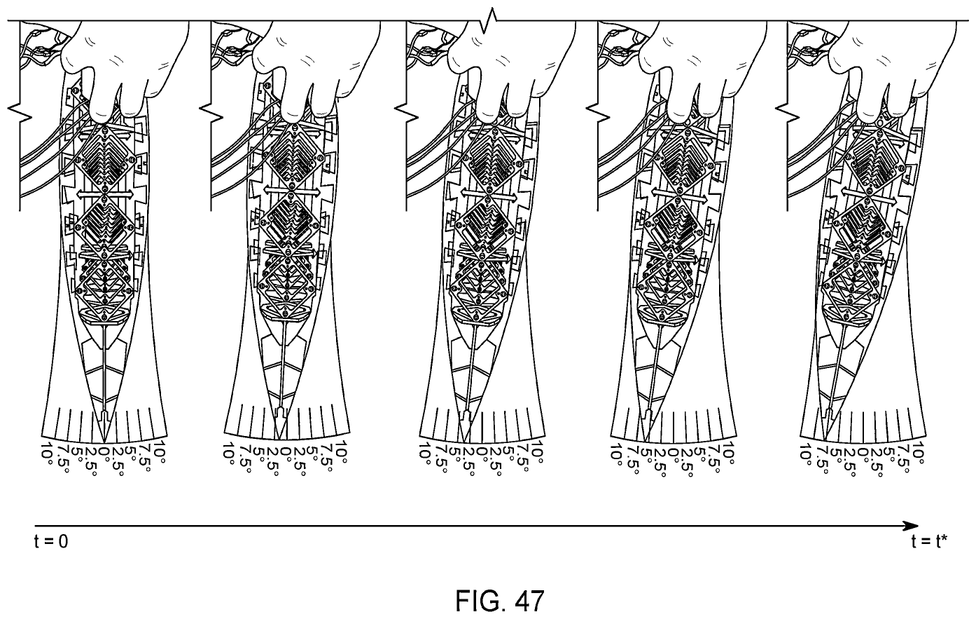

When installed, the wing is able to perform up to 12.5 angles of rotation continuously as FIG. 47 shows.

3.2.4 Simulations

First, the pressure distribution of the wing using XFLR5 is obtained for the worst-case scenario, an angle of attack α of 12.5 deg with a tail deflection θ of 12.5 deg.

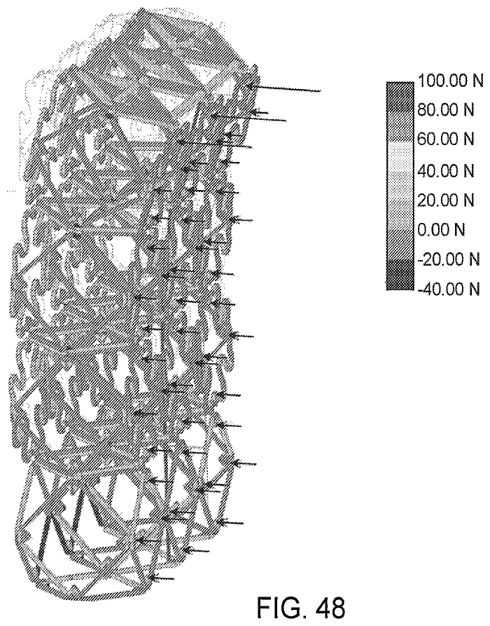

A structural simulation using Oasys GSA was done implementing the obtained pressure distribution with a strain in the opposite direction provided by the tendon actuation. FIG. 48 shows that the residual tension of the tendon reached 100N. In conclusion, the behavior of these three sections could be governed with one Nema23, thus, for the whole wing only 3 motors can be used.

3.2.5 Tow Tank Setup

Same procedure as in the Hydrosnake was followed to install the wing inside the tow tank.

3.2.6 Results

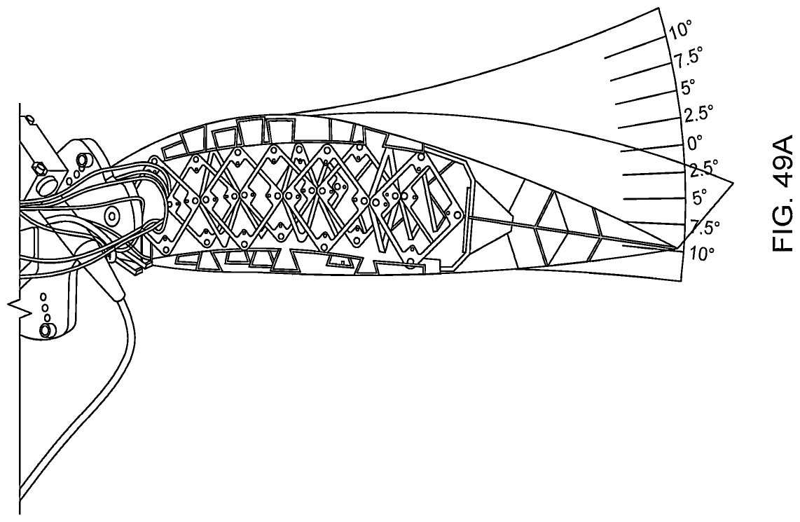

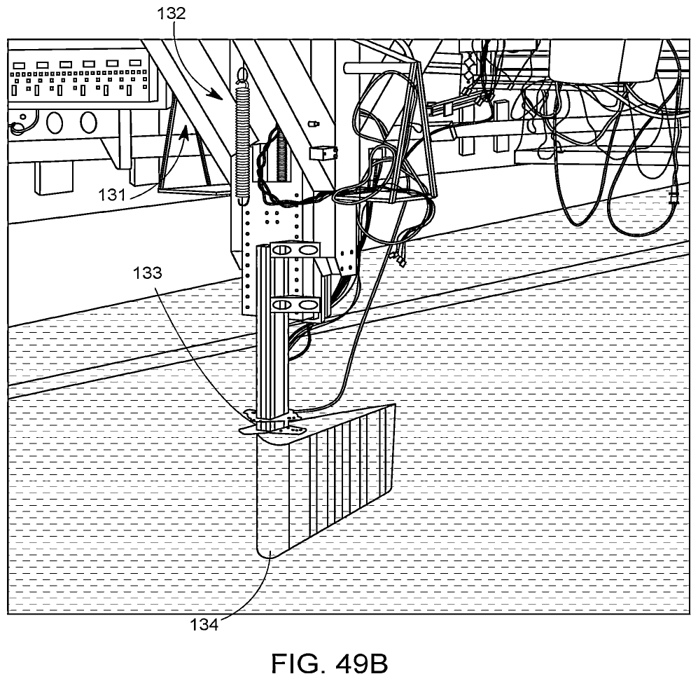

The test was performed under the same configuration as the Hydrosnake. Details of the tow tank and measurement devices are shown in section 3. As shown in FIG. 49B, the setup includes a control station (Item 131 in FIG. 49B, not visible, beneath the gantry), power supply, microcontroller, computer, stepper drivers and cooling station; towing carriage (Item 132 in FIG. 49B), 6 axis load cell (Item 133 in FIG. 49B), and the wing (Item 134 in FIG. 49B).

The water temperature is 22 degrees C., and that sets the value for Kinematic Viscosity at 9.554 m²/s. Given that the chord is 507 mm for both wings and the towing velocity is 0.2 ms, results performing at a Reynolds number Re=106134 will be compared.

The mounting bracket, that joins the wing (fix and morphing) to the load cell, allows us to generate deltas on the wing's angle of attack by 2.5 degrees. Thus, the experiment matrix for the morphing wing will be the one corresponding with Table 3.1.

TABLE 3.1
Test number with its corresponding AoA

| Sample | AoA |
|---|---|
| 1 | 0 |
| 2 | 0 |
| 3 | 2.5 |
| 4 | 2.5 |
| 5 | 5 |
| 6 | 5 |
| 7 | 7.5 |
| 8 | 7.5 |
| 9 | 10 |
| 10 | 10 |
| 11 | 15 |
| 12 | 15 |

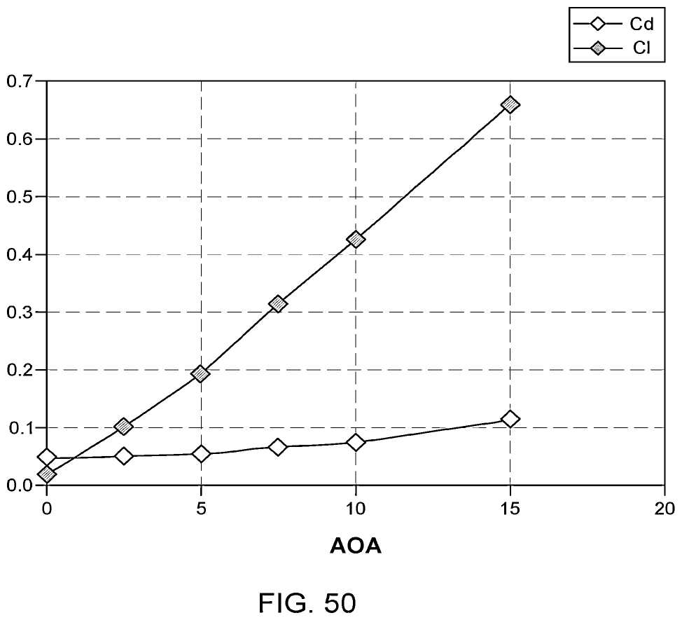

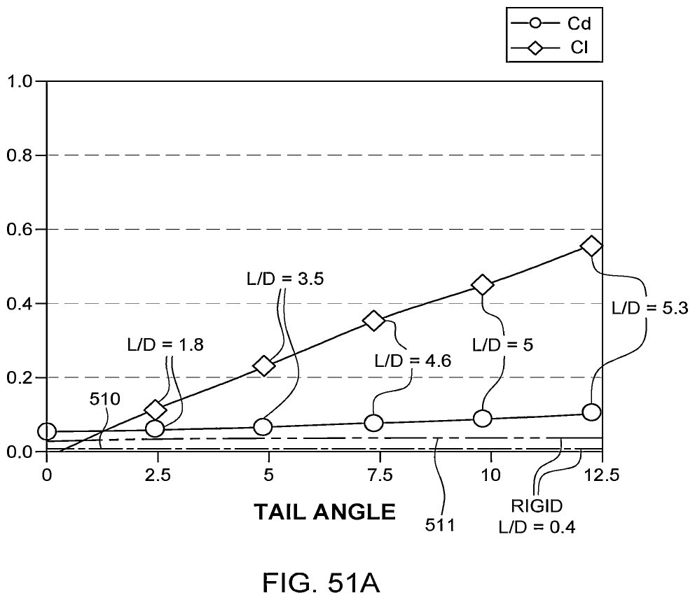

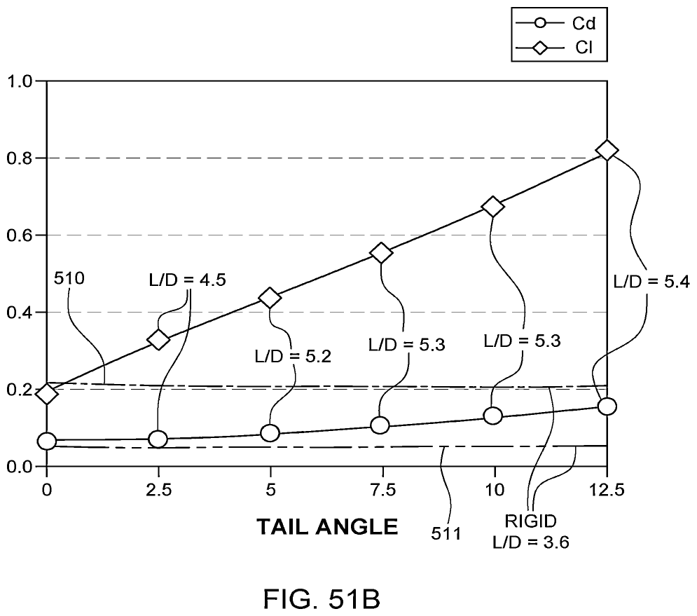

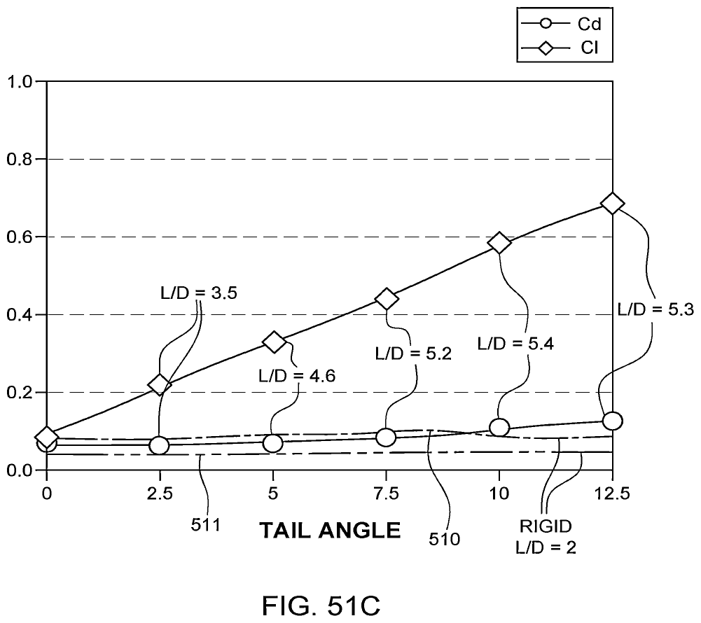

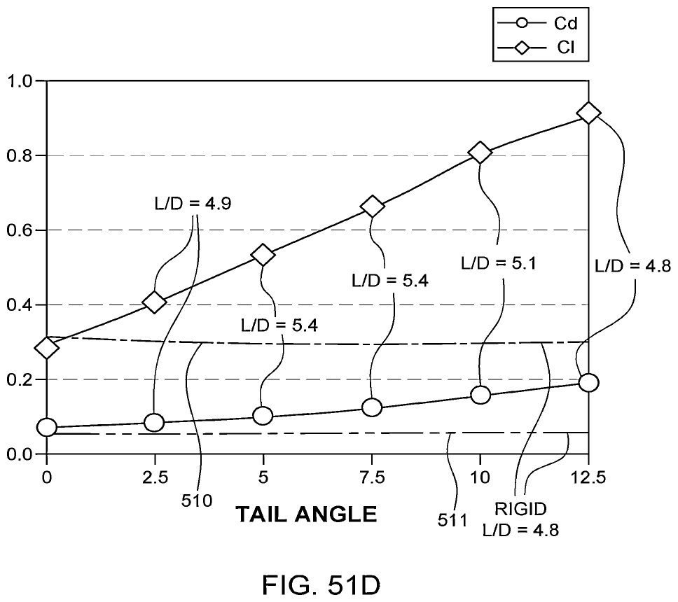

Results for the rigid wing are shown in FIG. 50.

The present disclosure characterizes the morphed shapes by the tangent angle that the tail forms with the free streamline direction. It is performed now, for every angle of attack, 6 more experiments with different tail angles, from 0 to 12.5 in steps of 2.5 degrees.

Aerodynamically, what is being done is making the original airfoil Eppler22 become a new member of the family. As the curvature of the centerline is being increased, by breaking the symmetry of the foil, different L/D coefficients can be generated.

This study doesn't consider comparisons with main control surfaces as it can be an aileron, flaps, or a spoiler. Morphing should be treated in this case as a change in the overall airfoil morphology, not a device to control a fixed foil. That is why this result compares, for every L/D value of the rigid wing at different angle of attack (AoA), how does this factor changes with different morphed shapes, characterized in this study as tail angles.

It can be seen that the L/D performance of the rigid wing is drastically increased by providing curvature to the chord. It can be seen how, speaking just in terms of maximum values, for the same angle of attack the cl coefficient can be increased by a 320% while increasing its cd a 250%. As in the graphs, a drastic decrease of L/D values isn't appreciated, that can be set, flow separation is not yet had. Further results at higher speeds will be done to characterize this behavior.

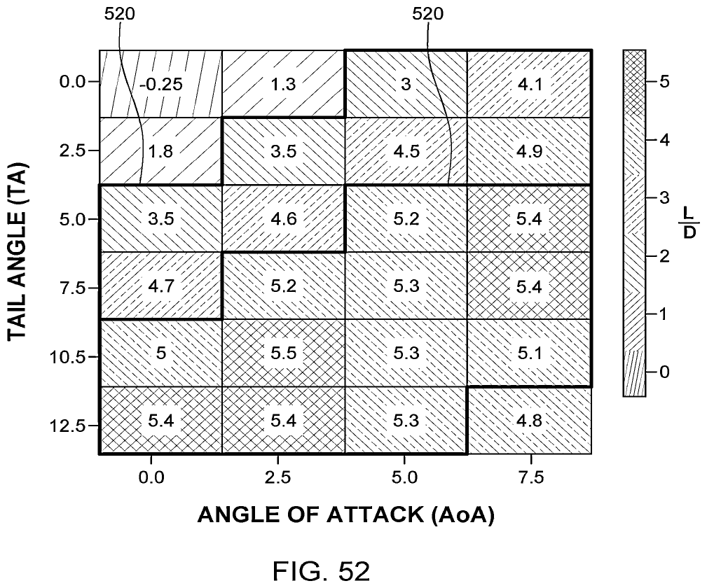

To have a sense of performance with all the variables involved, FIG. 52 shows a contour map of all the variables involved in this experiment. In the X-axis the Angles of Attack are shown, in the y axis Tail Angle values and its corresponding L/D as Z-colored information to make a heat map.

FIG. 52 shows where the point of maximum performance was found, corresponding with AoA=2.5 and TA=10. Also, the improvement of the morphing over fixed AoA can be seen, where the maximum delta can be found at AoA=0, able to vary L/D from 0 to 5.4.

### 4. Conclusions

The present disclosure started showing intentions to show an alternative to rigid joints and links mechanical assemblies by leaning towards continuum macroscopic foams with controlled heterogeneous mechanical properties. It continued by characterizing the mechanisms that can be generated, showing tension—deformation of the preferred axes. Then, an algorithmic method was shown to implement custom outer mold lines for these cellular metamaterials and the disclosure finished by showing macroscopic examples of actively actuated morphing structures. In this section, the result obtained and the path that this research has been are reflected on.

4.1 Scalability

The present disclosure shows the tools developed to rapidly build and actuate large-scale soft robotics which is a challenge the field has been founding. While keep relying on elastic deformation to generate motion, the ultra-low relative density of this material system allows scaling much higher. Also, the digital perspective of the material allows the user to design much rapidly as the building axioms remain much simpler than the classic-mechanical-monolithic world. A 1500 mm length robot with less than 200 parts and 20 different parts was able to be rapidly developed. As a comparison, RoboTuna was composed of over 3000 unique parts.

4.2 Actuation

The present disclosure detected as a challenge in the structure that the lack of centroid the same way classic continuum robots have. To have an element working effectively in pure compression would allow a much easier form-finding of the mechanisms as well as a much reliable simulation results.

At the beginning of the project, high-torque servomotors were used but it was rapidly detected that holding torque was more important than apply torque. That is why a change was made to stepper motors as, in a 75 mm pitch voxel that can fit up to a Nema 23 size of a dual shaft version. That not only provides a lot of torque but more control and hold torque without power cost.

As a work for the future, it will be very interesting to study if continuum actuation could over-perform the actual solution in terms of simplicity. It would be very interesting as the degrees of freedom would become infinite but might be challenging in terms of system integration, control and power.

4.3 Simulation

Unlike classic rigid robotic structures in which someone can determine motion geometrically and capabilities solving FEM, this method blends both onto a single FEM calculation. That is a challenge as truss lattices forces to use non-linear solvers. Calculating the tension of tendon elements increases the difficulty to determine which is the desirable actuation platform. To virtually actuate the structure, pre-stressed elements ought to be launched as load conditions and that is not as accurate as would have been liked.

Tip displacements are neither a solution, as the displacement is the unknown wanted to be solved, not to be imposed.

Friction effects are also neglected in this method but their effect might be non-negligible for certain usages or tension values.

4.4 Design

It is an interesting exercise to design using this platform. As it offers basic axioms to generate specified motion, the design process gets very simplified, showing big potential for educational platforms or design perspectives in the forms of building blocks as many gaming platforms use, but for real robotic structures.

A challenge in the design itself of these structures is the lack of centroid. Future steps will involve providing a facet that reinforces the desired centroid to avoid overall compressibility issues that have been found when using pulling actuators as tendons or rods.

While one or more preferred embodiments are disclosed, many other implementations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims that follow.

### CITATIONS

In the foregoing description, reference has been made to items listed below.
[1] Boston dynamics, https://www.bostondynamics.com/aboutq1.
[2] L. Ai and X.-L. Gao. Metamaterials with negative poisson's ratio and non-positive thermal expansion. Composite Structures, 162:70-84, 2017.
[3] D. N. BEAL, F. S. HOVER, M. S. TRIANTAFYLLOU, J. C. LIAO, and G. V. LAUDER. Passive propulsion in vortex wakes. Journal of Fluid Mechanics, 549:385-402, 2006.
[4] J. Benyus. Biomimicry: Innovation inspired by nature. 1997.
[5] G. Bledt, Matthew J. Powell, B. Katz, J. Carlo, P. Wensing, and Sangbae Kim. Mit cheetah 3: Design and control of a robust, dynamic quadruped robot. 2018 IEEE/RSJ International Conference on Intelligent Robots and Systems (IROS), pages 2245-2252, 2018.
[6] Elisa Boatti, Nikolaos Vasios, and Katia Bertoldi. Origami metamaterials for tunable thermal expansion. Advanced Materials, 29(26), 2017.
[7] Jessica Burgner-Kahrs, D. Caleb Rucker, and Howie Choset. Continuum robots for medical applications: A survey. IEEE Transactions on Robotics, 31(6):1261-1280, 2015.
[8] Sam Calisch. Folded functional foams. MIT, 2019.
[9] David B. Camarillo, Christopher F. Milne, Christopher R. Carlson, Michael R. Zinn, and J. Kenneth Salisbury. Mechanics modeling of tendon-driven continuum manipulators. IEEE Transactions on Robotics, 24(6):1262-1273, 2008.
[10] Da Chen and Xiaoyu Zheng. Multi-material Additive Manufacturing of Meta-materials with Giant, Tailorable Negative Poisson's Ratios. Scientific Reports, 8(1):9139, December 2018.
[11] Kenneth C. Cheung and Neil Gershenfeld. Reversibly Assembled Cel-lular Composite Materials. Science, 341(6151):1219-1221, 2013. Pub-lisher: American Association for the Advancement of Science_eprint: https://science.sciencemag.org/content/341/6151/1219.full.pdf.
[12] Ignazio Dimino, Giovanni Andreutti, Frederic Moens, Federico Fonte, Rosario Pecora, and Antonio Concilio. Integrated design of a morphing winglet for active load control and alleviation of turboprop regional aircraft. Applied Sciences, 11(5), 2021.
[13] Kevin C. Galloway, Kaitlyn P. Becker, Brennan Phillips, Jordan Kirby, Stephen Licht, Dan Tchernov, Robert J. Wood, and David F. Gruber. Soft robotic grip-pers for biological sampling on deep reefs. Soft Robotics, 3(1):23-33, 2016. PMID:
[14] Lorna J. Gibson and Michael F. Ashby. Cellular Solids: Structure and Properties. Cambridge Solid State Science Series. Cambridge University Press, 2 edition, 1997.
[15] J. Ginepro and Thomas C. Hull. Counting miura-ori foldings. J. Integer Seq., 17:14.10.8, 2014.
[16] James Groves Glen Bull. The democratization of production. (International Society for Technology in Education, pages 36-38, 2009.
[17] I. A. Gravagne, C. D. Rahn, and I. D. Walker. Large deflection dynamics and control for planar continuum robots. IEEE/ASME Transactions on Mechatronics, 8(2):299-307, 2003.
[18] I. A. Gravagne and I. D. Walker. On the kinematics of remotely-actuated continuum robots. In Proceedings 2000 ICRA. Millennium Conference. IEEE Inter—national Conference on Robotics and Automation. Symposia Proceedings (Cat. No. 00CH37065), volume 3, pages 2544-2550 vol. 3, 2000.
[19] Christine E. Gregg, Joseph H. Kim, and Kenneth C. Cheung. Ultra-light and scalable composite lattice materials. Advanced Engineering Materials, 20(9):1800213, 2018.
[20] Elliot W. Hawkes, Laura H. Blumenschein, Joseph D. Greer, and Alli-son M. Okamura. A soft robot that navigates its environment through growth. Science Robotics, 2(8), 2017. Publisher: Science Robotics_eprint: https://robotics.sciencemag.org/content/2/8/eaan3028.full.pdf.
[21] Benjamin Jenett, Christopher Cameron, Filippos Tourlomousis, Alfonso Parra Rubio, Megan Ochalek, and Neil Gershenfeld. Discretely assembled mechanical metamaterials. Science Advances, 6(47), 2020.
[22] Liqiao Jing, Zuojia Wang, Bin Zheng, Huaping Wang, Yihao Yang, Lian Shen, Wenyan Yin, Erping Li, and Hongsheng Chen. Kirigami metamaterials for re-configurable toroidal circular dichroism. NPG Asia Materials, 10(9):888-898, September 2018.
[23] B. A. Jones and I. D. Walker. Kinematics for multisection continuum robots. IEEE Transactions on Robotics, 22(1):43-55, 2006.
[24] Song Sang-Eun Hata N Kato T, Okumura Ichiro. Tendon-driven continuum robot for endoscopic surgery: Preclinical development and validation of a tension propagation model. 2015.
[25] Praveen Kumar, Tanweer Ali, and M. M. Manohara Pai. Electromagnetic meta-materials: A new paradigm of antenna design. IEEE Access, 9:18722-18751, 2021.
[26] George V. Lauder and Eric D. Tytell. Hydrodynamics of Undulatory Propulsion. In Fish Physiology, volume 23, pages 425-468. Elsevier, 2005.
[27] Hongshuai Lei, Chuanlei Li, Xiaoyu Zhang, Panding Wang, Hao Zhou, Zeang Zhao, and Daining Fang. Deformation behavior of heterogeneous multi-morphology lattice core hybrid structures. Additive Manufacturing, 37:101674, 2021.
[28] Shuguang Li, Samer A. Awale, Katharine E. Bacher, Thomas J. Buchner, Cosimo Della Santina, Robert J. Wood, and Daniela Rus. Scaling up soft robotics: A meter-scale, modular, and reconfigurable soft robotic system. Soft Robotics, 0(0):null, 0. PMID: 33769081.
[29] Huai-Ti Lin, Gary G Leisk, and Barry Trimmer. GoQBot: a caterpillar-inspired soft-bodied rolling robot. Bioinspiration & Biomimetics, 6(2):026007, June 2011.
[30] Jonathan A Lovegren and R John Hansman. Quantification of Fuel Burn Reduction in Cruise Via Speed and Altitude Optimization Strategies. page 97.
[31] McNeel. “grasshopper—generative modeling for rhino. http://grasshopper.rhino3d.com/.
[32] Sang Soon Oh and Ortwin Hess. Chiral metamaterials: enhancement and control of optical activity and circular dichroism. Nano Convergence, 2(1):24, November 2015.
[33] Cagdas D. Onal and Daniela Rus. A modular approach to soft robots. pages 1038-1045, 2012.
[34] C. Preisinger. “karamba, linking structure and parametric geometry”. Archit Design, 2013.
[35] Priyanka Rao, Quentin Peyron, Sven Lilge, and Jessica Burgner-Kahrs. How to model tendon-driven continuum robots and benchmark modelling performance. Frontiers in Robotics and AI, 7:223, 2021.
[36] Priyanka Rao, Quentin Peyron, Sven Lilge, and Jessica Burgner-Kahrs. How to model tendon-driven continuum robots and benchmark modelling performance. Frontiers in Robotics and AI, 7, 02 2021.
[37] Edwar J. Roach. The wright company, from invention to industry. https://www.jstor.org/stable/j.ctt5vjsh9.
[38] Matthias Rolf and Jochen J. Steil. Constant curvature continuum kinematics as fast approximate model for the bionic handling assistant. In 2012 IEEE/RSJ International Conference on Intelligent Robots and Systems, pages 3440-3446, 2012.
[39] Kazuya Saito, Sergio Pellegrino, and Taketoshi Nojima. Manufacture of arbitrary cross-section composite honeycomb cores based on origami techniques. volume 136, 08 2013.
[40] Tobias A. Schaedler and William B. Carter. Architected cellular materials. Annual Review of Materials Research, 46(1):187-210, 2016.
[41] Mark Schenk and Simon D. Guest. Geometry of miura-folded metamaterials. Proceedings of the National Academy of Sciences, 110(9):3276-3281, 2013.
[42] R. F. Shepherd, F. Ilievski, W. Choi, S. A. Morin, A. A. Stokes, A. D. Mazzeo, X. Chen, M. Wang, and G. M. Whitesides. Multigait soft robot. Proceedings of the National Academy of Sciences, 108(51):20400-20403, December 2011.
[43] Michael Sinapius, Hans Peter Monner, Markus Kintscher, and Johannes Riemen-schneider. Dlr's morphing wing activities within the european network. Procedia IUTAM, 10:416-426, 2014. Mechanics for the World: Proceedings of the 23rd International Congress of Theoretical and Applied Mechanics, ICTAM2012.
[44] Clean Sky. The rationale behind clean sky's' morphing wing for regional aircraft. 1997.
[45] E. A. Starke and J. T. Staley. Application of modern aluminum alloys to aircraft. Progress in Aerospace Sciences, 32(2):131-172, 1996.
[46] Tomohiro Tachi. Freeform rigid-foldable structure using bidirectionally flat-foldable planar quadrilateral mesh. In Cristiano Ceccato, Lars Hesselgren, Mark Pauly, Helmut Pottmann, and Johannes Wallner, editors, Advances in Architectural Geometry 2010, pages 87-102, Vienna, 2010. Springer Vienna.
[47] M. S. Triantafyllou, A. H. Techet, Q. Zhu, D. N. Beal, F. S. Hover, and D. K. P. Yue. Vorticity Control in Fish-like Propulsion and Maneuver-ing1. Integrative and Comparative Biology, 42(5):1026-1031, November 2002.
[48] Michael S. Triantafyllou and George S. Triantafyllou. An Efficient Swimming Machine. Scientific American, 272(3):64-70, March 1995.
[49] Michael Wehner, Ryan L. Truby, Daniel J. Fitzgerald, Bobak Mosadegh, George M. Whitesides, Jennifer A. Lewis, and Robert J. Wood. An integrated design and fabrication strategy for entirely soft, autonomous robots. Nature, 536(7617):451-455, 2016.

What is claimed is:

1. An outer skin of a metamaterial, the outer skin comprising a monolithic tessellation of folded structures.

2. The outer skin of a metamaterial of claim 1, wherein the tessellation of folded structures comprises an offset arrangement of a plurality of corrugations.

3. The outer skin of a metamaterial of claim 2, wherein the plurality of corrugations comprises at least one straight corrugation and at least one Miura corrugation.

4. The outer skin of a metamaterial of claim 3, wherein the metamaterial comprises a portion of a continuum robotic structure.

5. The outer skin of a metamaterial of claim 2, wherein the plurality of corrugations comprises a central corrugation and a lateral corrugation.

6. The outer skin of a metamaterial of claim 5, wherein a length of the central corrugation is greater than a length of the lateral corrugation.

7. The outer skin of a metamaterial of claim 5, wherein a length of the central corrugation is smaller than a length of the lateral corrugation.

8. The outer skin of a metamaterial of claim 5, wherein a length of the central corrugation is equal to a length of the lateral corrugation.

9. The outer skin of a metamaterial of claim 5, wherein the plurality of corrugations comprises a first Miura corrugation connecting the central corrugation and the lateral corrugation.

10. The outer skin of a metamaterial of claim 9, wherein the plurality of corrugations comprises a second Miura corrugation connecting the central corrugation and the lateral corrugation.

11. The outer skin of a metamaterial of claim 1, wherein the metamaterial comprises a portion of a continuum robotic structure.

12. The outer skin of a metamaterial of claim 11, wherein the metamaterial comprises a plurality of voxels assembled together.

13. The outer skin of a metamaterial of claim 1, wherein the tessellation of folded structures comprises a plurality of folds and a plurality of facets.

14. The outer skin of a metamaterial of claim 13, wherein the metamaterial comprises at least one voxel comprising a voxel facet, with one facet of the plurality of facets being joined to the voxel facet.

15. The outer skin of a metamaterial of claim 14, wherein the one facet and the voxel facet are riveted together.

16. The outer skin of a metamaterial of claim 1, wherein the tessellation of folded structures are discretely assembled.

17. A method of manufacturing outer skin of a continuum robotic structure, the method comprising discretely assembling a tessellation of folded structures, wherein the tessellation of folded structures comprises an offset arrangement of a plurality of corrugations.

18. The method of claim 17, wherein the plurality of corrugations comprises at least one straight corrugation and at least one Miura corrugation.

19. The method of claim 18, wherein the plurality of corrugations comprises a central corrugation and a lateral corrugation.

20. The method of claim 19, wherein a length of the central corrugation is greater than a length of the lateral corrugation.

21. The method of claim 19, wherein a length of the central corrugation is smaller than a length of the lateral corrugation.

22. The method of claim 19, wherein a length of the central corrugation is equal to a length of the lateral corrugation.

23. The method of claim 19, wherein the plurality of corrugations comprises a first Miura corrugation connecting the central corrugation and the lateral corrugation.

24. The method of claim 23, wherein the plurality of corrugations comprises a second Miura corrugation connecting the central corrugation and the lateral corrugation.

25. The method of claim 17, wherein the metamaterial comprises a plurality of voxels assembled together.

26. The method of claim 17, wherein the tessellation of folded structures comprises a plurality of folds and a plurality of facets.

27. The method of claim 26, wherein the metamaterial comprises at least one voxel comprising a voxel facet, with one facet of the plurality of facets being joined to the voxel facet.

28. The method of claim 27, wherein the one facet and the voxel facet are riveted together.

29. The method of claim 17, wherein the tessellation of folded structures are discretely assembled.
